(19) United States
(12) Patent Application Publication
(10) Pub. No.: US 2017/0120813 A1
(43) Pub. Date: May 4, 2017

(54) SYSTEMS AND METHODS TO SAFELY TRANSPORT PASSENGERS

(71) Applicant: Revolution Solutions, LLC, Gilroy, CA (US)

(72) Inventors: George Wilson, Gilroy, CA (US); Dinesh Amin, Gilroy, CA (US)

(21) Appl. No.: 15/338,291

(22) Filed: Oct. 28, 2016

Related U.S. Application Data
(60) Provisional application No. 62/247,691, filed on Oct. 28, 2015.
(60) Provisional application No. 62/255,683, filed on Nov. 16, 2015.

(51) Int. Cl. B60Q 9/00; B60N 2/26; B60N 2/00; G08B 21/02

(52) U.S. Cl. CPC B60Q 9/00; G08B 21/0205; B60N 2/26; B60N 2/002

(57) ABSTRACT

Systems and methods to safely transport passengers are described. The system broadcasts over a network, to at least one forward operating base, (FOB) a request for linkage. The system is located in a vehicle that travels on land and is utilized for bidirectional communication with a first system unit type for detecting the presence of a passenger in the vehicle and a second system unit type for communicating different alert types. The first system unit type includes a first child seat control unit and the second system unit type includes at least one FOB including a first FOB. The system receives and registers the first FOB as being linked and receives an occupant present message from the first child seat. The system identifies a temperature inside the vehicle as exceeding a predetermined threshold and communicates a temperature alert message to the first FOB.

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever. The following notice applies to the software and data as described below and in the drawings that form a part of this document: Copyright Revolution Solutions, LLC 2015, All Rights Reserved.

### FIELD

This disclosure relates to transportation systems, and more particularly to systems and methods to transport passengers.

### RELATED APPLICATIONS

This application claims the benefit of U.S. Provisional Patent Application Ser. No. 62/247,691, filed on Oct. 28, 2015 and U.S. Provisional Patent Application Ser. No. 62/255,683, filed on Nov. 16, 2015 which are both incorporated by reference herein in their entirety.

### BACKGROUND

Each year in the United States, numerous deaths are caused by leaving children in vehicles. Most of these deaths are attributed to hyperthermia from exposure to high temperatures. Many of these deaths are attributed to forgetfulness and distraction.

### BRIEF DESCRIPTION OF THE DRAWINGS

FIG. 1A is a diagram illustrating a system, according to an embodiment, to safely transport passengers;

FIG. 1B is a diagram illustrating passenger transport system information, according to an embodiment;

FIG. 1C is a diagram illustrating control unit information, according to an embodiment;

FIG. 1D is a diagram illustrating user interface, according to an embodiment, to configure a system to safely transport passengers.

FIGS. 2A-1 is a diagram illustrating a system monitor control unit, according to an embodiment;

FIGS. 2A-2 is a diagram illustrating a system monitor control unit, according to an embodiment;

FIGS. 2A-3 is a diagram illustrating a system monitor information storage, according to an embodiment;

FIGS. 2A-4 is a diagram illustrating a session information, according to an embodiment;

FIGS. 2A-5 is a diagram illustrating FOB information, according to an embodiment;

FIGS. 2B-1 is a diagram illustrating a car seat, according to an embodiment;

FIGS. 2B-2 is a diagram illustrating an extender unit, according to an embodiment;

FIGS. 2B-3 is a diagram illustrating an upper latch control unit, according to an embodiment;

FIGS. 2B-4 is a diagram illustrating a lower latch control unit, according to an embodiment;

FIGS. 2C-1 is a diagram illustrating a passenger seat, according to an embodiment;

FIGS. 2C-2 is a diagram illustrating a passenger seat control unit, according to an embodiment;

FIGS. 2D-1 is a diagram illustrating a booster seat, according to an embodiment;

FIGS. 2D-2 is a diagram illustrating a booster seat control unit, according to an embodiment;

FIGS. 2E-1 is a diagram illustrating a FOB, according to an embodiment.

FIGS. 2E-2 is a diagram illustrating a FOB control unit, according to an embodiment;

FIGS. 2E-3 is a diagram illustrating FOB information storage, according to an embodiment;

FIGS. 2E-4 is a diagram illustrating local FOB information, according to an embodiment;

FIGS. 3A-1 is a diagram illustrating alerting system units, according to an embodiment.

FIGS. 3A-2 is a diagram illustrating a scrolling display unit, according to an embodiment;

FIGS. 3A-3 is a diagram illustrating a visual display unit, according to an embodiment;

FIGS. 3A-4 is a diagram illustrating a visual display control unit, according to an embodiment;

FIG. 3B is a diagram illustrating an emergency responder control unit, according to an embodiment;

FIG. 3C is a diagram illustrating car electronics control unit, according to an embodiment;

FIG. 4A is a diagram illustrating a method, according to an embodiment, to safely transport passengers;

FIG. 4B is a diagram illustrating a method, according to an embodiment, to safely transport passengers;

FIG. 5A is a diagram illustrating a method, according to an embodiment, to safely transport passengers;

FIG. 5B is a diagram illustrating a method, according to an embodiment, to process a temperature alert;

FIG. 5C is a diagram illustrating a method, according to an embodiment, to process a temperature exposure alert;

FIG. 6A is a diagram illustrating a method, according to an embodiment, to link to a FOB control unit;

FIG. 6B is a diagram illustrating a method, according to an embodiment, to handshake with a FOB control unit;

FIG. 7A is a diagram illustrating an object tracking system, according to an embodiment.

FIGS. 7B-1 is a diagram illustrating an object monitoring control unit, according to an embodiment;

FIGS. 7B-2 is a diagram illustrating an object tracking control unit, according to an embodiment;

FIGS. 7C-1 is a diagram illustrating an object tracking control unit, according to an embodiment;

FIGS. 7C-2 is a diagram illustrating an object tracking information storage, according to an embodiment;

FIGS. 7C-3 is a diagram illustrating local object tracking control unit information, according to an embodiment;

FIGS. 7C-4 is a diagram illustrating object monitoring control unit, according to an embodiment;

FIGS. 7D-1 is a diagram illustrating system monitor information storage, according to an embodiment;

FIGS. 7D-2 is a diagram illustrating object tracking control unit information, according to an embodiment;

FIGS. 7D-3 is a diagram illustrating an object tracking control unit status, according to an embodiment;

FIGS. 7E-1 is a diagram illustrating a method, according to an embodiment, to link to an object tracking control unit;

FIGS. 7E-2 is a diagram illustrating a method, according to an embodiment, to link to handshake with an object tracking control unit;

FIG. 8A is a diagram illustrating a pet collar system, according to an embodiment;

FIG. 8B is a diagram illustrating pet collar control unit, according to an embodiment;

FIG. 8C is a diagram illustrating an object tracking control unit status, according to an embodiment;

FIG. 9 is a block diagram illustrating a software architecture, according to an embodiment; and

FIG. 10 is a block diagram of a machine in an example form of a computing system within which a set of instructions for causing the machine to perform any one or more of the methodologies discussed herein may be executed.

### DETAILED DESCRIPTION

Example systems and methods to safely transport passengers are described. In the following description, for purposes of explanation, numerous specific details are set forth in order to provide a thorough understanding of example embodiments. It will be evident, however, to one skilled in the art that the systems and methods to safely transport passengers may be practiced without these specific details.

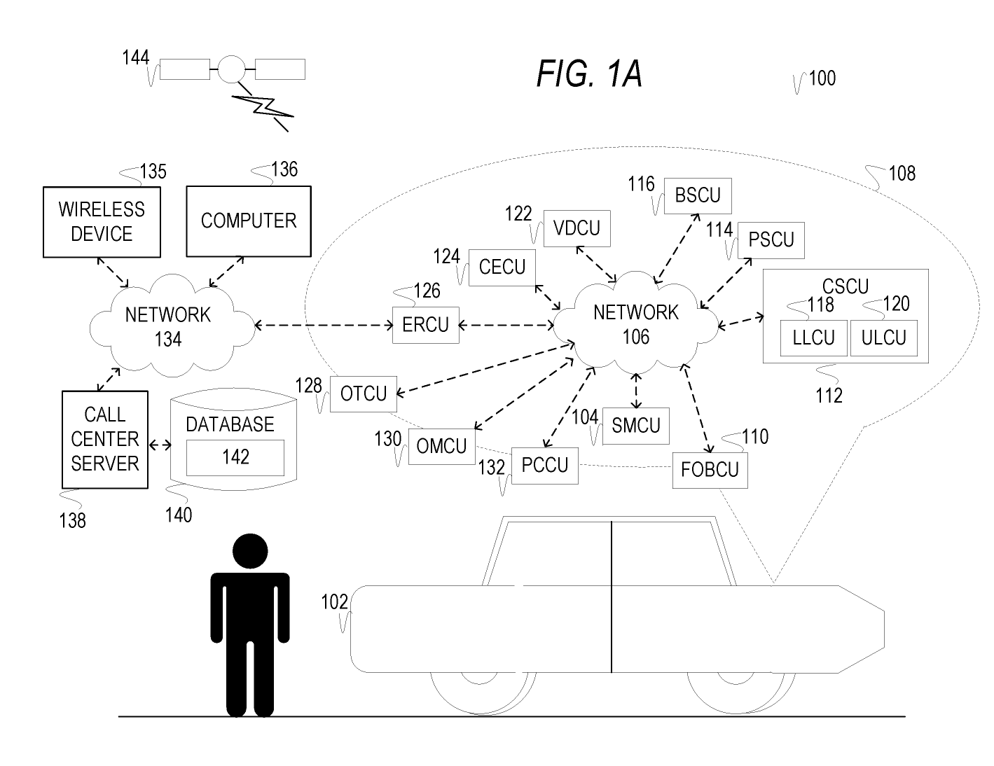

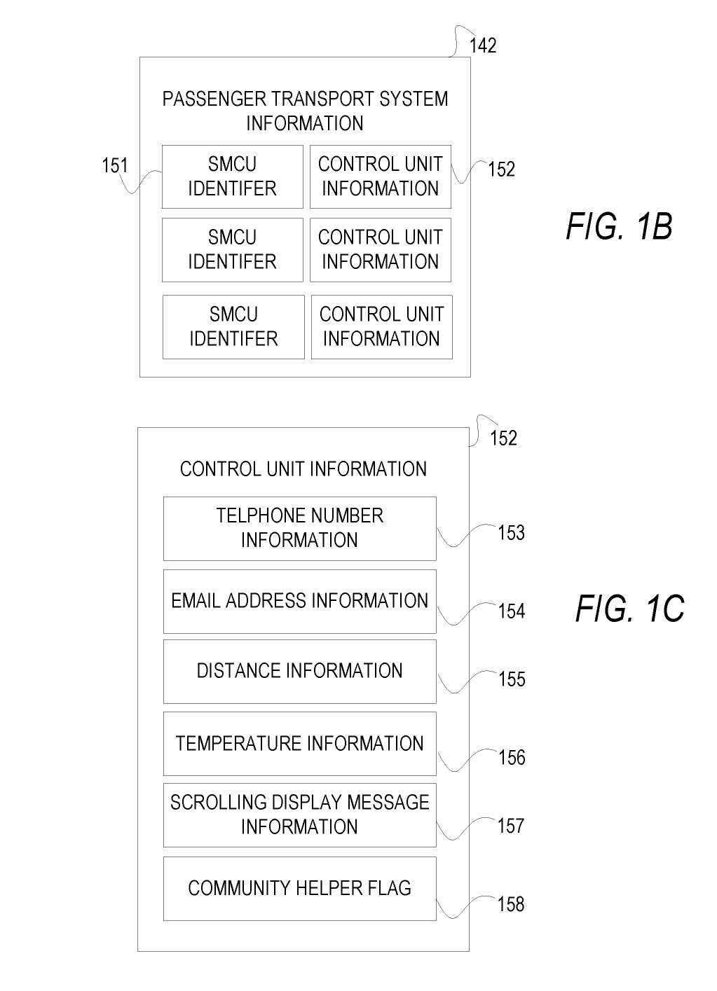

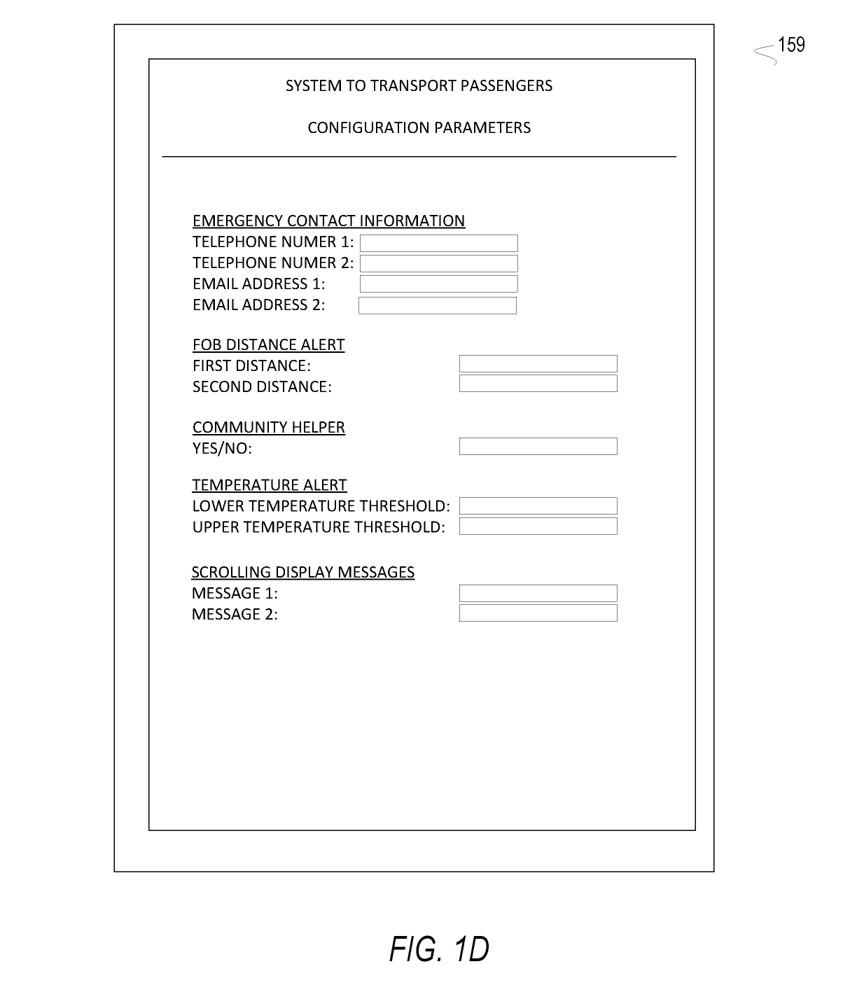

FIG. 1A is a diagram illustrating a system 100, according to an embodiment, to safely transport passengers. The system 100 includes a vehicle 102 that travels on land (e.g., automobile, truck, sports utility vehicle, all-terrain vehicle, etc.). The system 100 may also be embodied in a vehicle that travels in air (e.g., airplane, jet, balloon, etc.) on the water (e.g., boat, ship, speedboat, sailboat, etc.) or underwater (e.g., submarine, etc.). The system 100 may be embodied in a vehicle irrespective of the medium.

The vehicle 102 includes a system monitor control unit (SMCU) 104 that communicates, over a network 106 (radio frequency (RF), blue tooth, etc.), with network elements in the form of system units. The SMCU 104 may communicate with system units that are located inside a network perimeter 108. The SMCU 104 may not communicate with system units that are located outside of the network perimeter 108 as the system units are beyond the communication range of the SMCU 104. The vehicle 102 may move to cause the SMCU 104 to move making the network perimeter 108 mobile. Accordingly, the vehicle 102 and the SMCU 104 may operate synergistically to form a communication hub that is mobile and that reaches to a network perimeter 108 that is mobile. Further, the SMCU 104 supports bidirectional communication with the system units. For example, the system units may receive messages from the SMCU 104 and send messages to the SMCU 104. In addition, the SMCU 104 supports the scaling of system units. For example, the SMCU 104 supports the incremental addition or removal of system units in accordance with the requirements of the particular system 100. The system units (SU) may include standard system units (SSU) and optional system units (OSU) including alerting system units (ASU) where the OSU may be utilized by the SMCU 104 to supplement services that are provided by the SSU.

### Standard System Units

The standard system units are illustrated to the right of the SMCU 104. The standard system units may include a FOB control unit (FOBCU) 110, a car seat control unit (CSCU) 112, a passenger seat control unit (PSCU) 114 and a booster seat control (BSCU) unit 116. The CSCU 112, the FOBCU 110, the PSCU 114 and the BSCU 116 are scalable. Accordingly, the system 100 may support one or more CSCUs 112, FOBCUs 110, PSCU 114s and/or BSCUs 116. For example, a family with twins may add two CSCUs 112 to the SMCU 104 to safely transport the twins together in the vehicle 102. Each of the control units for seats (e.g., CSCUs 112, PSCUs 114, BSCUs 116) further includes one or more sensors to identify the presence/absence of an occupant and a software module for communicating a status of the sensed occupant, over the network 106, to the SMCU 104. Further, each of the control units for seats includes one or more sensors to identify whether seat belts are fastened/unfastened and further utilizes the respective software modules to communicate the status of the seat belt(s) to the SMCU 104. Further, the SMCU 104 includes a sensor that measures the ambient temperature of the vehicle 102 and the LLCU 118 may include a backup sensor to measure the ambient temperature of the vehicle 102.

The FOBCU 110 is a small security hardware device with a built-in authentication system that is used to control and secure access to network 106 services and data. The FOBCU 110 may include a physical loop-like extension enabling a driver of the vehicle 102 to thread their keys through the loop and attach they keys to the FOBCU 110. Accordingly, the FOBCU 110 and a set of keys may function as a single logical unit. The FOBCU 110, and other system units, are illustrated in FIG. 1A as resting on the network perimeter 108 to indicate operation inside or outside of the vehicle 102. For example, the FOBCU 110 may operate inside or outside of the vehicle 102. In one specific example, a FOBCU 110 in the pocket of a driver may be inside the vehicle 102 while the driver drives and outside the vehicle 102 as the driver exits the vehicle 102. The remaining standard network elements are illustrated as being inside the network perimeter 108 in FIG. 1A to signify a normal operation as being inside of the vehicle 102.

The system 100 may identify and communicate alerts responsive to an identification of an unsafe condition. For example, the SMCU 104 may produce an audible alert responsive receipt of message(s) from a CSCU 112, PSCU 114, or BSCUs 116 identifying the presence of an occupant and further identifying an unfastened seat belt. In addition, an audible alert may also be produced by the SMCU 104 responsive to receipt of a message identifying an unfastening of a seat belt after the seat belt has been detected and reported as fastened. To this end, buckle sensors in each of the seat units may be calibrated for identifying a proper placement of the buckle in a latch and retention of the buckle in the latch (e.g., “fastened seat belt”). Accordingly, the system 100 includes standard system units that continually monitor the occupying/vacating of seats in conjunction with the buckling/unbuckling of seat belts and that produce audible alerts responsive to the identification of an unsafe condition.

Alerts may be detected by one or more FOBCUs 110 (e.g., FOB) and/or communicated to one or more FOBCUs 110. The FOB may function in the system 100 as a two-way communication device for receiving and communicating alerts to the holder of the FOB who is typically the driver of the vehicle 102 but may also be a passenger in the vehicle. For example, the FOB may communicate a haptic or audible alert to its holder responsive to receiving an alert for a seat belt that is unbuckled. Further, a movement of a FOB outside of a radius that is centered in the SMCU 104 may also cause an alert to be communicated to the holder of the FOB. The holder of a FOB is typically the first responder to an unsafe condition in the vehicle 102. Accordingly, a FOB that is identified as moving towards the network perimeter 108 may be suggestive of an unsafe condition because the holder of the FOB may be unable to respond to an unsafe condition in the vehicle 102 and because the FOB may become unreachable to the SMCU 104. Accordingly, a movement towards the network perimeter 108 may be identified and alerted based on two predetermined distances (e.g., radiuses) from the SMCU 104. For example, the FOBCU 110 may detect and communicate a “first distance alert” (e.g., first stage alert) to the holder of the FOB responsive to the FOBCU 110 identifying itself as moving beyond a “first distance” from the vehicle 102. Further for example, the FOBCU 110 may communicate a “second distance alert” (e.g., second stage alert) to the holder of the FOB responsive to the FOB identifying itself as moving beyond a second (e.g., greater) distance from the vehicle 102 but before moving beyond the network perimeter 108. The holder of the FOB (e.g., driver) may initially dismiss (e.g., “snooze” button) the “first distance alert,” however, after a predetermined number of dismissals, the “first distance alert” may no longer be dismissed. As mentioned above, the FOBCU 110 is a standard system unit that is scalable. For example, the SMCU 104 may identify the addition of a second FOB, a third FOB, etc. responsive to the SMCU 104 identifying a FOB as entering the network perimeter 108. In one example, the vehicle 102 may be driven away without the second FOB being present in the vehicle 102 causing a “first distance alert” at the second FOB, a “second distance alert” at the second FOB, and finally resulting in the second FOB being outside the network perimeter 108. In this example, the second FOB communicates single alert to the holder of the second FOB. The holder of the second FOB may deactivate (e.g., manually) the alert by pressing a Standby button on the second FOB, as described further below.

The system 100 may further alert the detection of an unsafe temperature condition. For example, the SMCU 104 may detect and alert an unsafe temperature, an unsafe rate of change of temperature, or an unsafe duration of an unsafe temperature or range of temperatures. The SMCU 104 may distinguish a safe temperature condition from an unsafe temperature condition by continually sensing the temperature, computing a rate of temperature change, measuring a duration of exposure and comparing the gathered information with predetermined thresholds. For example, the SMCU 104 may include a temperature sensor that senses and communicates messages including information regarding temperature to the SMCU 104. The SMCU 104 may identify that a temperature that was measured exceeds a predetermined threshold and communicate an alert (Temperature Alert) to all FOBCUs 110 that are identified as linked to the SMCU 104. The alert for an unsafe temperature condition may override other alerts/alarms. For example, the alert for an unsafe temperature condition may cause the cancelation of all previously transmitted alarms/alerts (e.g., unbuckled seat belt), according to an embodiment. Further, the alarm for an unsafe temperature condition may not be disabled or deactivated, according to an embodiment. In addition, the alert for an unsafe temperature condition may be escalated to alert FOBCUs 110 other than FOBCUs 110 that are linked to the SMCU 104. For example, responsive to the SMCU 104 not detecting an intervention (e.g., detecting a sensor that indicates a removal of child from a seat) after the elapse of a predetermined period of time (e.g., ten minutes) or detecting no FOB s as being detected inside the network perimeter 108 (Temperature—No Fob—Alert), the SMCU 104 may escalate the temperature alert to a temperature exposure alert. The SMCU 104 broadcasts a message indicating a “temperature exposure alert” to any FOBCU 110 inside the network perimeter 108. Accordingly, any FOBCU 110 (e.g., not only FOBCUs 110 linked in a session with the SMCU 104) that are located inside the network perimeter 108 may receive temperature exposure alert. For example, a FOBCU 110 that is not linked with the first system 100 may nevertheless receive the broadcasted temperature exposure alert. Further, the SMCU 104 of the first system 100 may progressively lengthen the radius of the network perimeter 108 to communicate with FOBCUs 110 that were previously unreachable. For example, an SMCU 104 that is utilizing a radio frequency network may progressively boost the radio frequency signal to progressively lengthen the radius of the network perimeter 108 to enable communication with FOBCUs 110 that were previously unreachable.

“Table A” describes alerts that are asserted by the SMCU 104.

TABLE A

| First Condition(s) | Second Condition | Alert |
|---|---|---|
| at least one seat | seat belt not buckled | belt unbuckled alert |
| occupied | | |
| at least one seat | no FOB | no FOB alert |
| occupied with seat | | |
| belt buckled | | |
| at least one seat | temperature threshold | temperature alert |
| occupied with seat | exceeded | |
| belt buckled | | |
| at least one seat | no FOB inside network | temperature - no FOB - |
| occupied with seat | perimeter 108 | alert |
| belt buckled | | |
| temperature | | |
| threshold exceeded | | |
| at least one seat | unsafe rate of | temperature exposure |
| occupied with seat | change of | alert |
| belt buckled | temperature (OR) | |
| temperature | unsafe duration of | |
| threshold exceeded | range of | |
| | temperatures | |

The system 100 may further include an object finder. For example, the SMCU 104 may include a “Find Object” button that activates the object finding function. To this end, pressing the “Find Object” button in association with a second selection that identifies a target may cause a particular SSU to emit an audible sound, all SSUs to emit an audible sound, or an identified class of SUs to emit an audible sound (e.g., FOBCUs 110).

### Optional System Units

The system 100 further includes optional system units. The optional system units are illustrated to the left of the SMCU 104. The optional system units may include a video display control unit (VDCU) 122, a car electronics control unit (CECU) 124, an emergency responder control unit (ERCU) 126, one or more object tracking control units (OTCU) 128, one or more object monitoring control units (OMCU) 130, and one or more pet collar control units (PCCU) 132. The VDCU 122 includes a visual display unit that may be mounted on or inside the vehicle 102. The visual display unit may luminesce patterns that communicate an urgency and that are associated with alarm definitions (e.g., unsafe temperature condition). In another embodiment, the VDCU 122 may include a scrolling display unit in the form of a “Ticker Display” that scrolls a message across a display that may be read by a person passing by the vehicle 102. For example, the “Ticker Display” may be configured to display a message warning that the vehicle 102 has an endangered child. Further, the message may include instructions. For example, the instructions may describe particular actions to be performed (e.g., “please remove child,” “please telephone 911,” etc.). Accordingly, a person passing by the vehicle 102 (e.g., without a FOB), including another driver, may identify an occupant of the vehicle as being in danger.

The CECU 124 may be utilized to communicate an alert to the electronics of the vehicle 102 that may, in turn, communicate the alert via specialized devices of the vehicle 102. For example, the SMCU 104 may utilize the CECU 124 to communicate with the electronics of the vehicle 102 to control honking the horn of the vehicle 102 or the flashing the headlights of the vehicle 102.

The ERCU 126 is an emergency responder interface (ERI) for communicating over the network 106 (e.g., WiFi, radio frequency, etc.) with the SMCU 104 and for communicating over a network 134 (e.g., cellular, emergency, Internet, WAN, etc.) with external network elements. The ERCU 126 may be utilized to hale an emergency responder and/or to facilitate the provision of other emergency services. For example, the SMCU 104 may communicate a message, over the network 106, to the ERCU 126 that, in turn, communicates the message over the network 134 (e.g., cellular, satellite, plain old telephone service (POTS), Internet, etc.) to a wireless device 135 (e.g., smartphone), computer 136 or a call center server 138. Further, the ERCU 126 may include a global position receiver that receives information from one or more global position system satellites 144 and calculates its geographical location (e.g., geographic coordinates) based on the information. Accordingly, the ERCU 126 may append geographic coordinates to any message that is communicated by the SMCU 104 to or via the ERCU 126. For example, the SMCU 104 may communicate a message including an email message, a text message or a voice message for requesting emergency services and the ERCU 126 may append geographic coordinates to the message that identifies the location of the vehicle 102 as the ERCU 126 is located inside the vehicle 102. The call center server 138 may be operated by operators who receive the message and contact emergency services (e.g., 911, Fire, Police, etc.). In another embodiment, the call center server 138 may automatically forward the message to the emergency services. Further, the call center server 138 may be coupled to a database 140 that is utilized to store configurable parameters as control unit information to personalize the operation of a particular SMCU 104. The configurable parameters may be retrieved by the SMCU 104 and utilized by the SMCU 104 to configure the system 100. According to one embodiment, a user may enter the configurable parameters, via a user interface, that are received by the computer 136 that may, in turn, communicate the configurable parameters, over the network 134, to the call center server 138 that, in turn, stores the configurable parameters in the database 140. Subsequently, an SMCU 104 may retrieve the configurable parameters from the database 140 and utilize the configurable parameters to configure the SMCU 104 and other SUs.

The system 100 may further include an object tracking system for locating objects. The object tracking system may include one or more object tracking control units 128 and one or more object monitoring control units 130. The object tracking control units 128 and the object monitoring control units 130 may communicate with the SMCU 104. The object tracking control units 128 may be respectively associated with mobile objects (e.g., people) and may communicate, via the SMCU 104, to the one or more object monitoring control units 130, to enable the SMCU 104 and the object monitoring control units to identify the location of the object tracking control units, as described in further detail below.

The system 100 may further include a pet collar system. The pet collar system may be included in the object tracking system and is used for finding a pet that is lost and/or monitoring the temperature in the immediate environment of the pet. The pet collar system may include a pet collar that includes a pet collar control unit 132 and that includes a temperature sensor that measures temperature. The pet collar may be worn by the pet (e.g., small animal, dog, cat, etc.). Responsive, to detecting an unsafe temperature at the pet collar, the SMCU 104 may communicate an alert to the FOBCU(s) 110 to prompt the holder of the FOB to return to the vehicle 102. Further, the pet collar may be tracked, as described further below, to enable a vehicle 102 that is equipped with the pet collar system and the object tracking system to travel through a neighborhood and locate a pet that is lost and wearing the collar. In another embodiment, the pet collar control unit 132 may include a global tracking receiver enabling the pet collar control unit 132 to communicate global coordinates to the SMCU 104 that, in turn, may be utilized by the SMCU 104 to communicate the location of the pet.

FIG. 1B is a diagram illustrating passenger transport system information 142, according to an embodiment. The passenger transport system information 142 is stored in the database 140 that is coupled to the call center server 138. The passenger transport system information 142 may store configurable parameters and other information for multiple systems 100. Each row in the passenger transport system information 142 corresponds to a particular SMCU 104 (e.g., system 100). Each row includes a system unit identifier 150 in the form of a system module control unit (SMCU) identifier 151 that identifies an SMCU 104. Each row further includes control unit information 152 that stores configurable parameters and other information for the particular system 100.

FIG. 1C is a diagram illustrating control unit information 152, according to an embodiment. The control unit information 152 may store configurable parameters in the form of telephone number information 153 including one or more telephone numbers, email address information 154 including one or more email addresses, distance information 155 including a “first distance”, a second distance, etc., temperature information 156 including a low temperature, high temperature etc., scrolling display message information 157 including messages that may be scrolled, and a community helper flag 158. The telephone number information 154 may include telephone numbers that are used to initiate a telephone call for communicating a voice message requesting an emergency response from a private emergency responder (e.g., family members). The email address information 154 may include email addresses that are utilized to initiate the sending of an email including a text message requesting an emergency response from private emergency responders. The scrolling display message information 157 may include a text messages that request an emergency response. The text message may be displayed on a scrolling display unit that may be located inside the vehicle 102 or on the vehicle 102. The voice messages, email messages and scrolling display messages may be communicated responsive to an identification of a temperature—No FOB—alert or a temperature exposure alert. The community helper flag 158 may store whether a FOBCUs 110 that is linked with a first SMCU 104 but receives a “Temperature—No—FOB Alert” from a second SMCU 104 is to communicate an alert to the holder of the FOB. For example, configuring the community helper flag 158 to “YES” signifies that a FOBCU 110 that is linked with a first SMCU 104 and that receives a “Temperature—No—FOB Alert” from a second SMCU 104 is to communicate an alert to the holder of the FOBCU 110. Conversely, configuring “No” signifies that the FOBCU 110 does not communicate the alert.

FIG. 1D is a diagram illustrating user interface 159, according to an embodiment, to configure a system to safely transport passengers. The user interface 159 may be displayed on the wireless device 135, the computer 136, a touch sensitive screen of the SMCU 104, or the like. The user interface 159 may be utilized to receive configurable parameters that are used to configure the system 100 to safely transport passengers. The configurable parameters may include telephone number information 153 (e.g., telephone number 1, telephone number 2, etc.), email address information 154 (e.g., email address 1, email address 2, etc.), distance information 155 (e.g., “first distance” for “first distance alert” and “second distance” for “second distance alert,” etc.), temperature information 156 (e.g., lower temperature threshold, upper temperature thresholds for “temperature alert” and “temperature exposure alert,” etc.), scrolling display message information 157 and a community helper flag 158 (e.g., “YES”/“NO”), as previously described.

According to a first embodiment, the call center server 138 may communicate the user interface 159 including input boxes for configurable parameters over the network 134 to the computer 136, receive the configurable parameters, via the input boxes, from the computer 136 and store the configurable parameters in the appropriate row of the passenger transport system information 142 in the database 140. Further, the call center server 138 may communicate the configurable parameters over the network 134 to the ERCU 126 that, in turn, communicates the configurable parameters, over the network 106, to the SM module 170 at SMCU 104, that, in turn stores the configurable parameters in the system monitor information storage 174. Accordingly, the SM module 170 may retrieve and utilize the configurable parameters from the system monitor information storage 174, as needed.

According to another embodiment, the SM module 170, at the SMCU 104, may communicate the user interface 159 including input boxes for receiving configurable parameters to the touch sensitive screen on the SMCU 104, receive the configurable parameters from the touch sensitive screen, and store the configurable parameters in the system monitor information storage 174. Accordingly, the SM module 170 may retrieve and utilize the configurable parameters from the system monitor information storage 174, as needed.

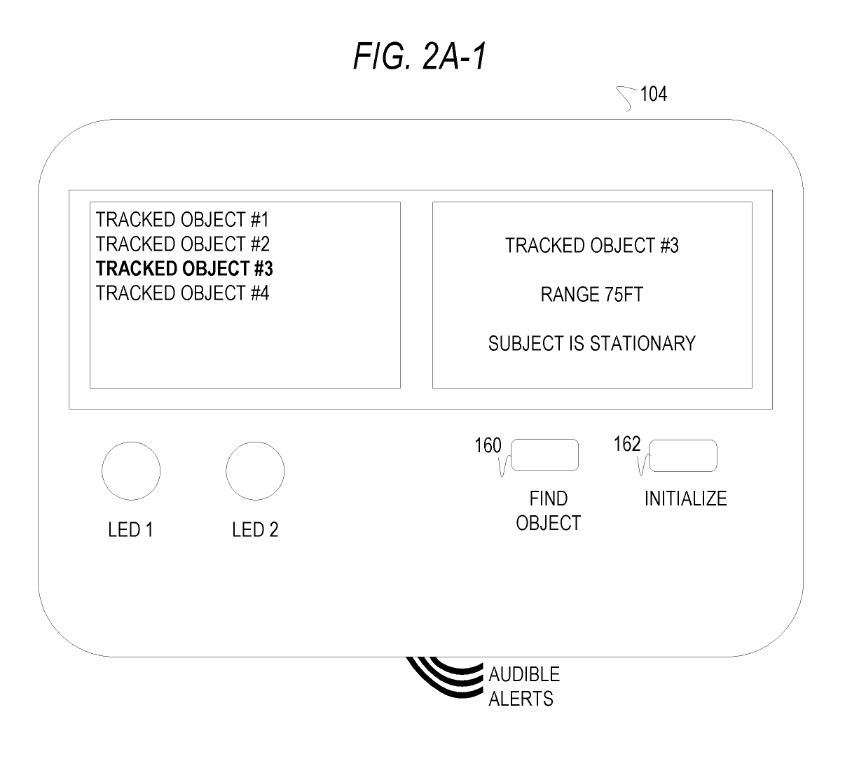

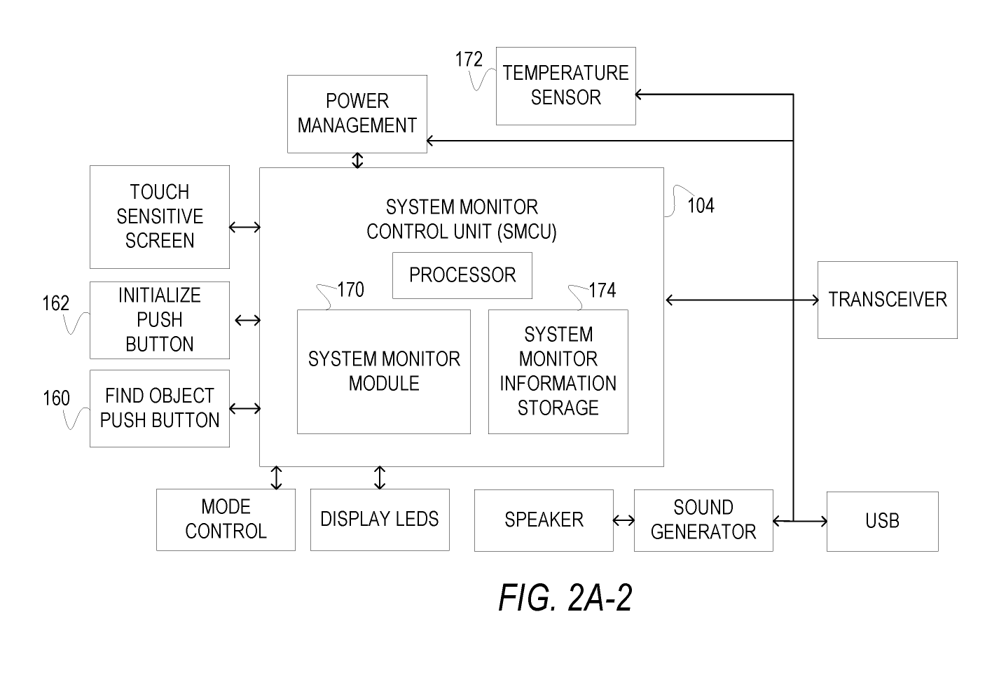

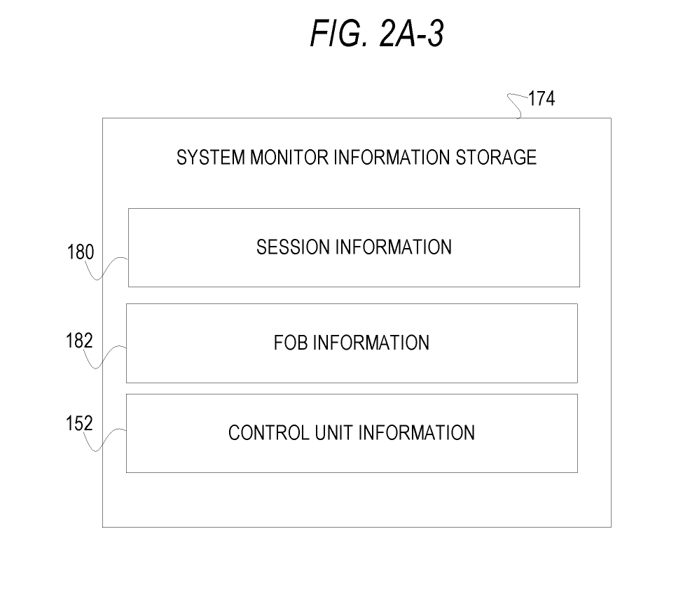

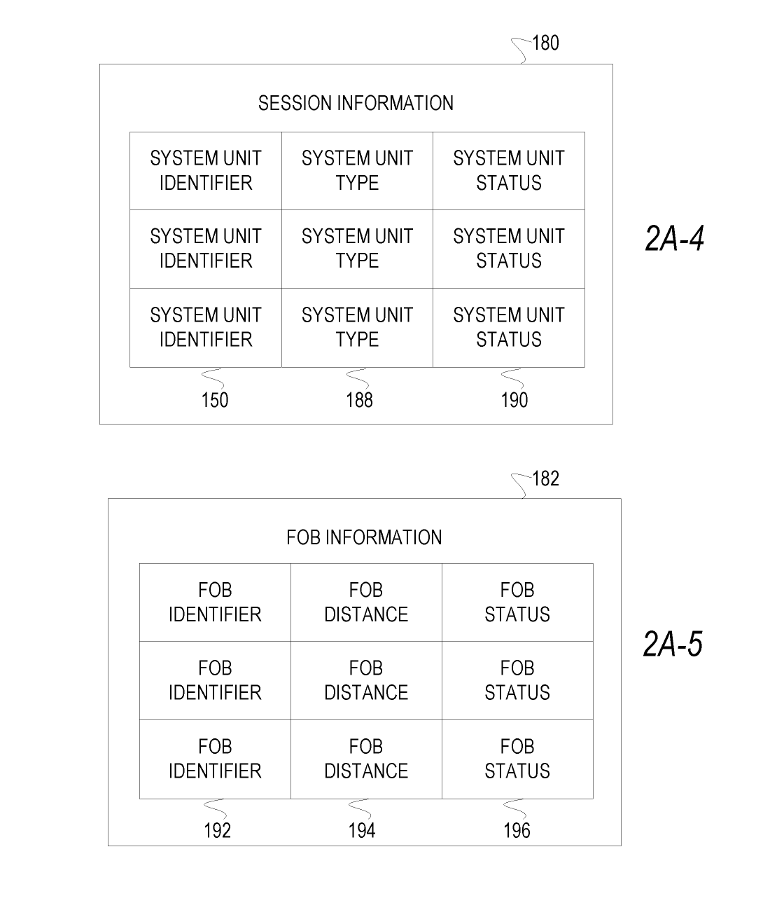

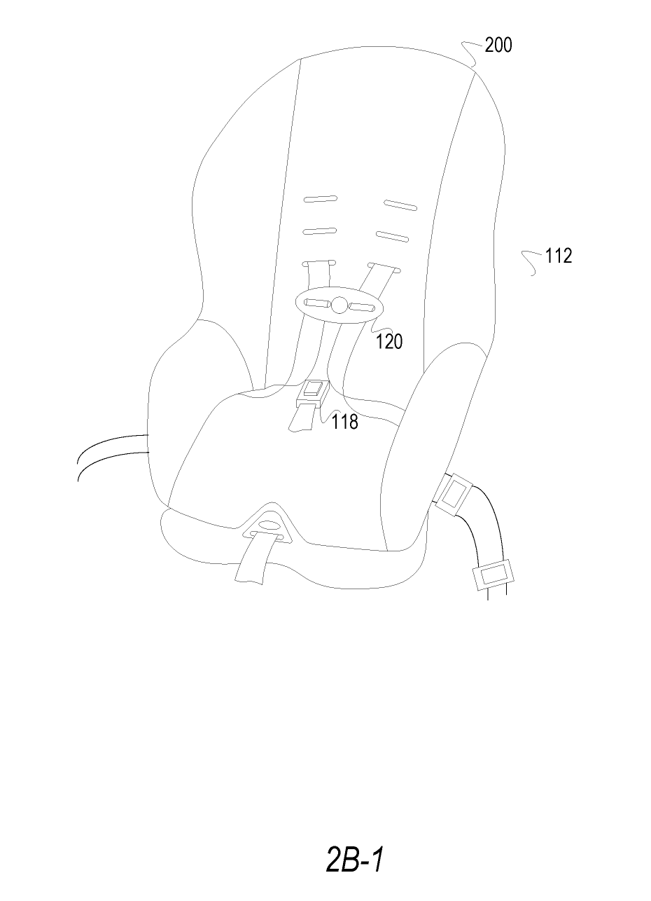

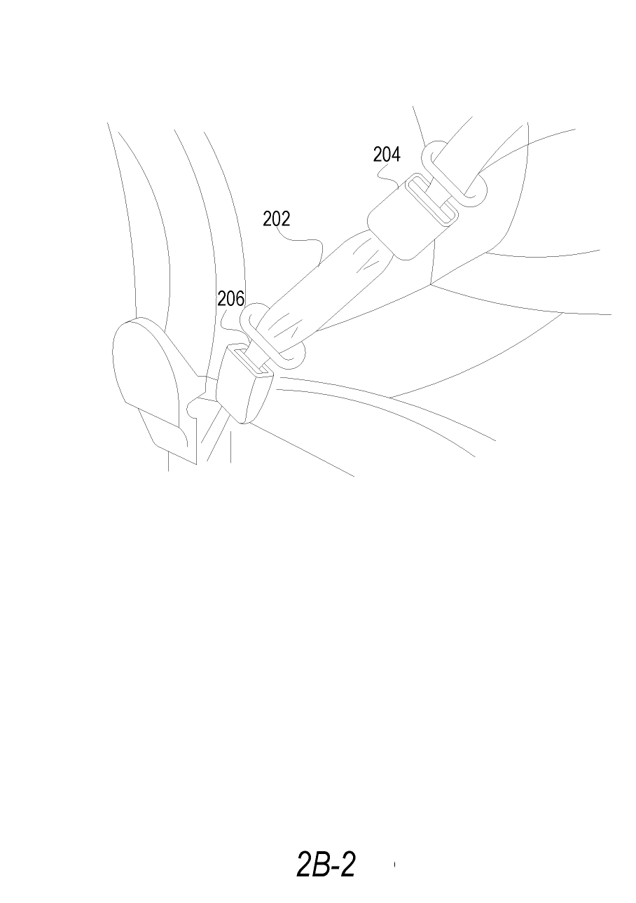

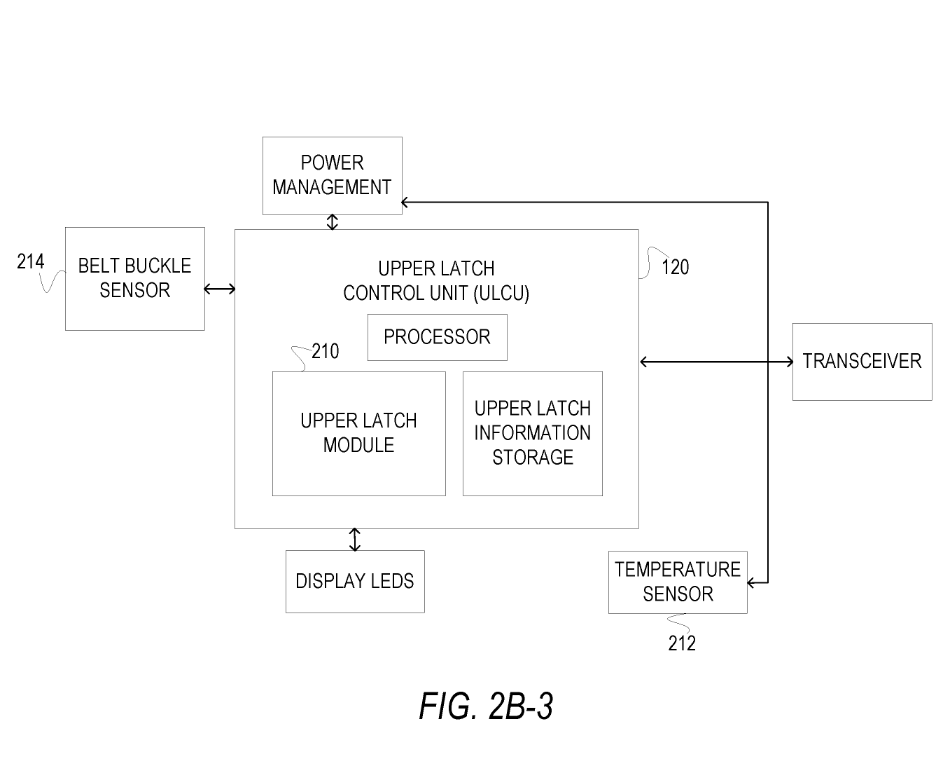

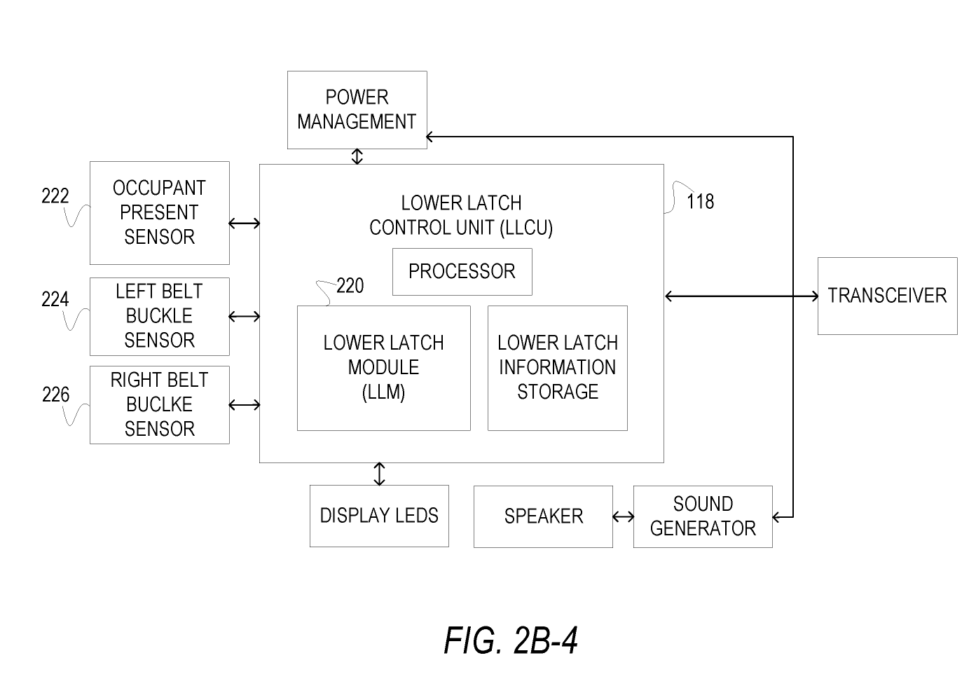

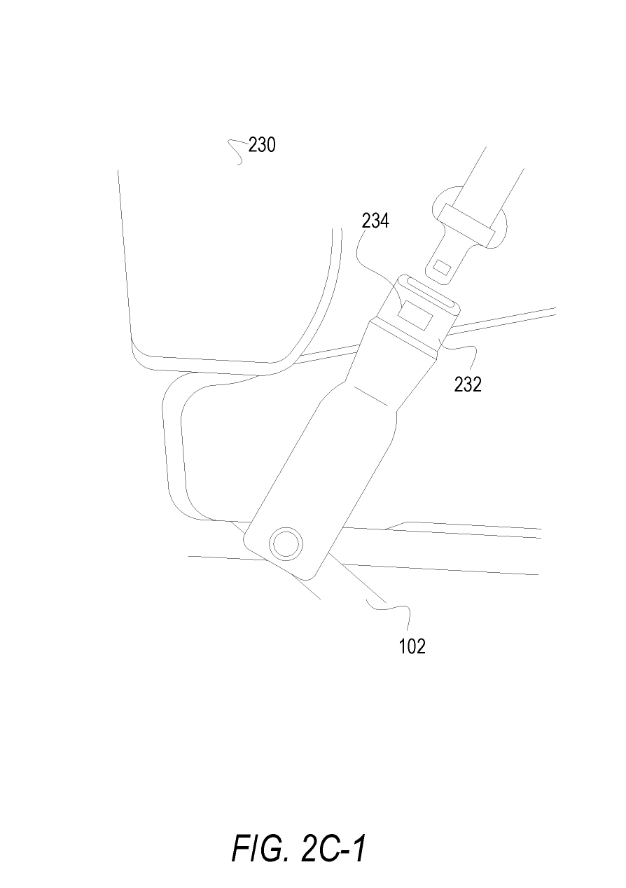

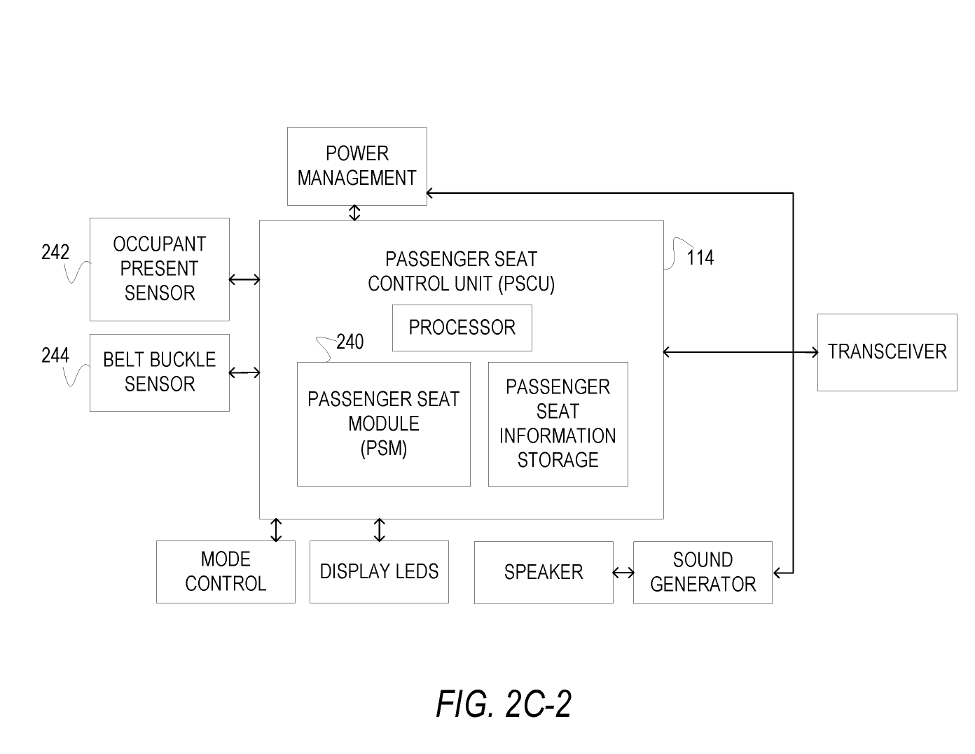

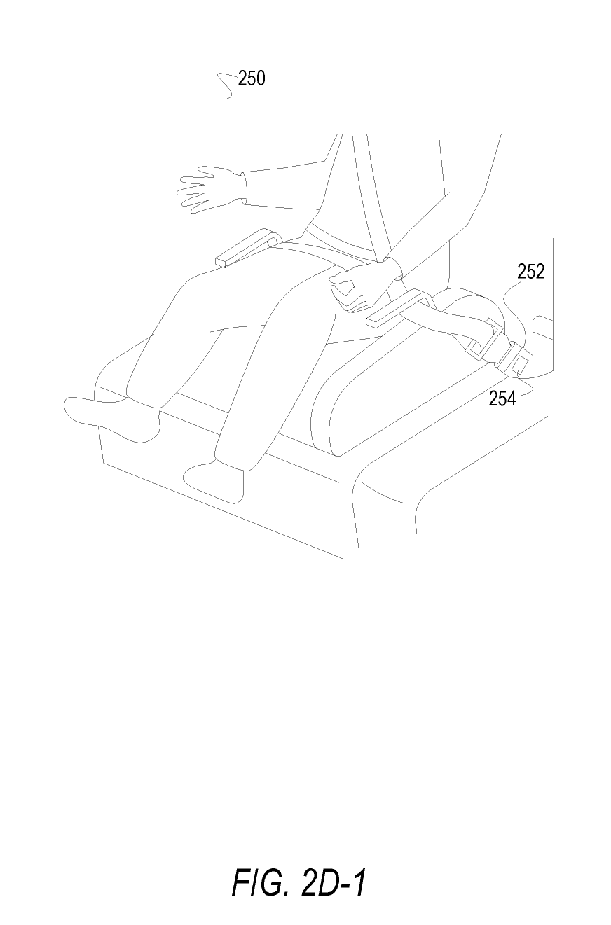

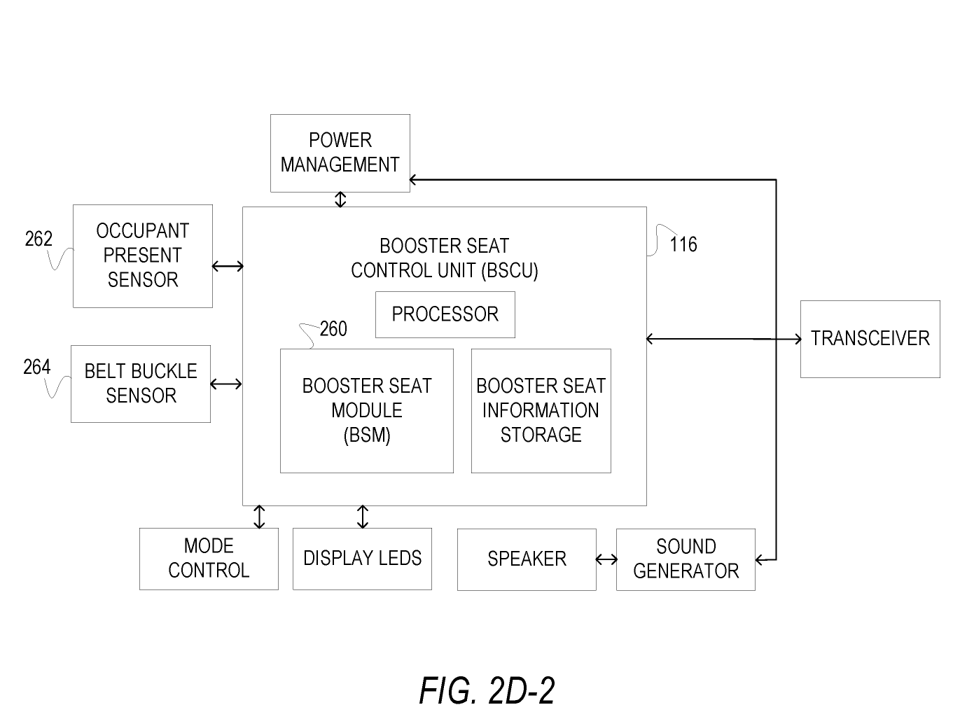

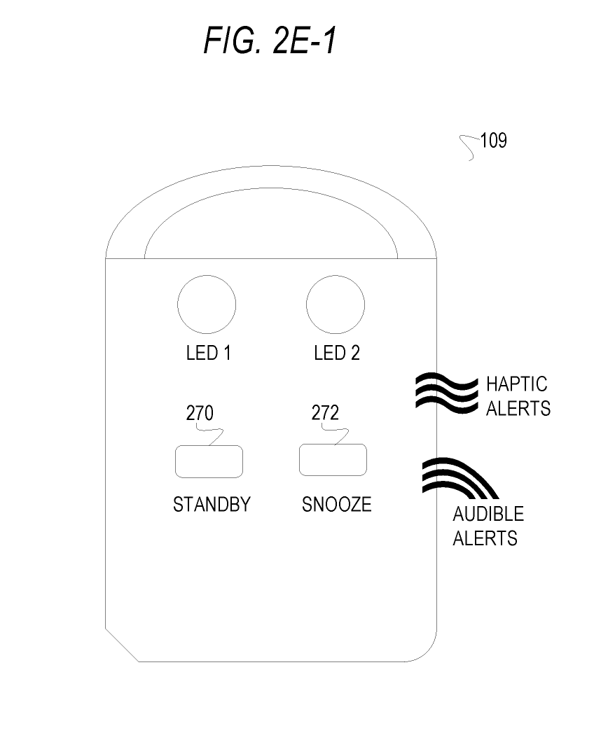

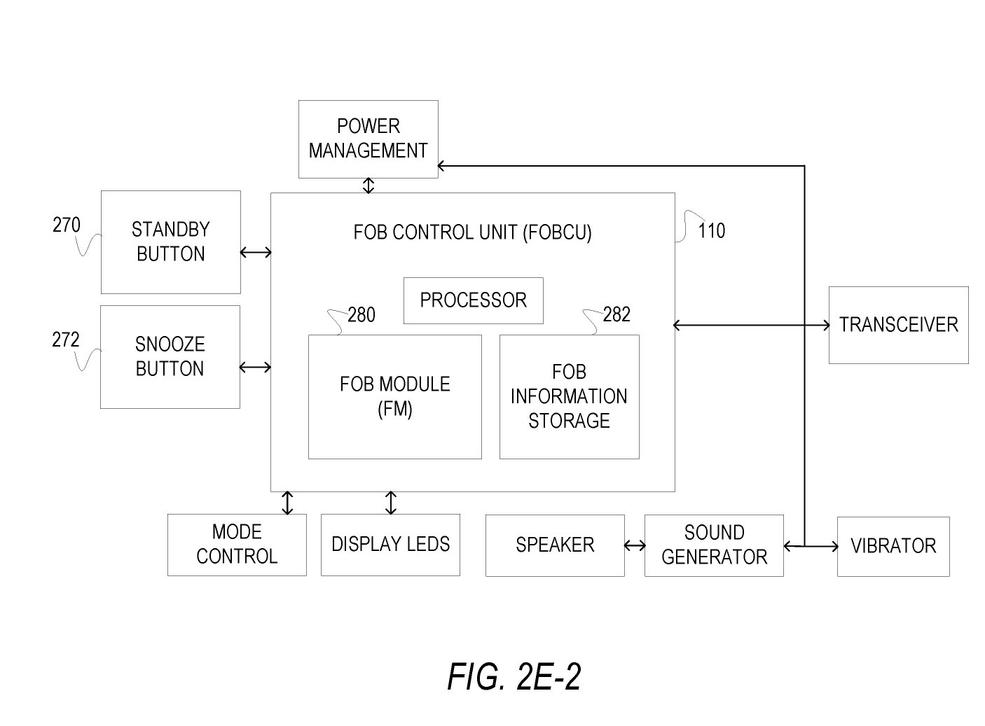

FIGS. 2A-1 is a diagram illustrating a system monitor control unit (SMCU) 104, according to an embodiment. The SMCU 104 is the central processing unit of the system 100 to safely transport passengers. The SMCU 104 may communicate with the other system units in the system 100 including standard system units and optional system units. The SMCU 104 may be affixed to a surface inside the vehicle 102 (e.g., dashboard), placed on a surface (e.g., dashboard) of the vehicle 102, clipped to a surface (e.g., shade visor) of the vehicle 102 and the like. The SMCU 104 may include light emitting diodes (LED1, LED2) for indicating statuses, a “Find Object” button 160, an “Initialize” button 162, and a touch sensitive screen for receiving and communicating (e.g., displaying) information. In another embodiment, the “Find Object” button 160 and the “Initialize” button 162 may be included as user interface elements on the touch sensitive screen.

The “Find Object” button 160 and the “Initialize” button 162 may be pressed to perform various functions. The “Find Object” button 160 may be pressed to cause a system unit that is selected on the display to produce an audible sound. For example, the touch sensitive screen displays an object tracking control unit 128 (e.g., “Tracked Object #3”) as being selected. Responsive to the “Find Object” button 160 being pressed, the object tracking control unit 128 (e.g., “Tracked Object #3”) emits an audible sound. Further, the right side of the display illuminates an object tracking control unit 128 (e.g., “TRACKED OBJECT #3”) as being seventy-five feet from the SMCU 104 and as not moving (e.g., “SUBJECT IS STATIONARY”) as determined by a signal strength. Other embodiments may display geographic coordinates or a location of the object tracking control unit 128 on a map that is displayed on the touch sensitive screen. The “Initialize” button 162 may be pressed to cancel an alert. For example, unbuckling a seat belt may cause an audible alert that is canceled by pressing the “INITIALIZE” push button 162.

In another embodiment, the touch sensitive screen may illustrate additional statuses. For example, in an embodiment that includes a vehicle in the form of a commercial airplane, the touch sensitive screen, on the SMCU 104, may display one or more statuses for each of the seats on the airplane. For example, the touch sensitive screen may display a first status indicating whether a particular seat is occupied or not occupied. Further, for example the touch sensitive screen may display a second status indicating whether the seat belt for a particular seat is occupied or not occupied.

FIGS. 2A-2 is a diagram illustrating a system monitor control unit 104, according to an embodiment. The SMCU 104 may include a processor, a system monitor module 170, that executes instructions utilizing the processor, and system monitor information storage 174 for storing information. The SMCU 104 may operate to communicate with other system units and to communicate with control component elements that are communicatively coupled to the SMCU 104. The component elements of the SMCU 104 may include a power management (e.g., battery) component element, a temperature sensor 172 for sensing temperature, a network interface device (e.g., transceiver (e.g., wireless, radio)) for communicating with other system units or devices, a universal serial bus (USB) port for communicating with other system units or devices, a “Find Object” push button 160, as previously described, an “INITIALIZE” push button 162, as previously described, a mode control, display LEDs, and a sound generator for generating sound that is audibly heard with a speaker. The system monitor information storage 174 may be used to store and retrieve tables and other software constructs.

The SMM 170 may communicate with system units including standard system units and optional system units. The standard system units may include one or more FOBCUs 110, one or more CSCUs 112, one or more PSCUs 114, and one or more BSCUs 116. The optional system units may include the VDCU 122, the CECU 124, the ERCU 126, one or more OTCUs 128, one or more OMCUs 130, and the PCCU 132, according to an embodiment.

### System Monitor Module Operation

The system monitor module (SMM) 170 periodically checks for receipt of an “occupant present” message (OPM) from an LLCU 118, BSCU 116 or PSCU 114. Responsive to identifying receipt of an OPM message, the SMM 170 exits a “Standby” mode to enter an “Up” mode. After receiving the OPM, the SMM 170 waits to receive a “belts buckled” message from the LLCU 118 (three belts including two of its own and one of the ULCU 120), BSCU 116 and/or PSCU 114, according to an embodiment. It will be appreciated that a particular system 100 may include various numbers of various types of standard system units or none at all. Accordingly, the architecture of the system 100 to safely transport passengers enables an independent and real-time scaling of multiple types of standard system units.

The SMM 170 may receive a “belts bucked” or “belts unbuckled” message from an LLCU 118 with an occupant, a BSCU 116 with an occupant or a PSCU 114 with an occupant. The SMM 170 may identify whether all occupied seats are associated with a status indicating a buckled seat belt.

A user may press the “INITIALIZE” button 162 to indicate a seat is being vacated. Responsive to receiving an indication of the “INITIALIZE” button 162 being pressed to indicate a seat is being vacated, the SMM 170 may initialize a timer with a predetermined period of time (e.g., five minutes), according to an embodiment. If the SMM 170 receives an “occupant vacated seat” message from a standard system unit for a seat before the “INITIALIZE” button 162 is pressed (indicating a seat vacate), the SMCU 104 may produce an audible alert until the “INITIALIZE” button 162 is pressed (indicating a seat vacate), according to an embodiment.

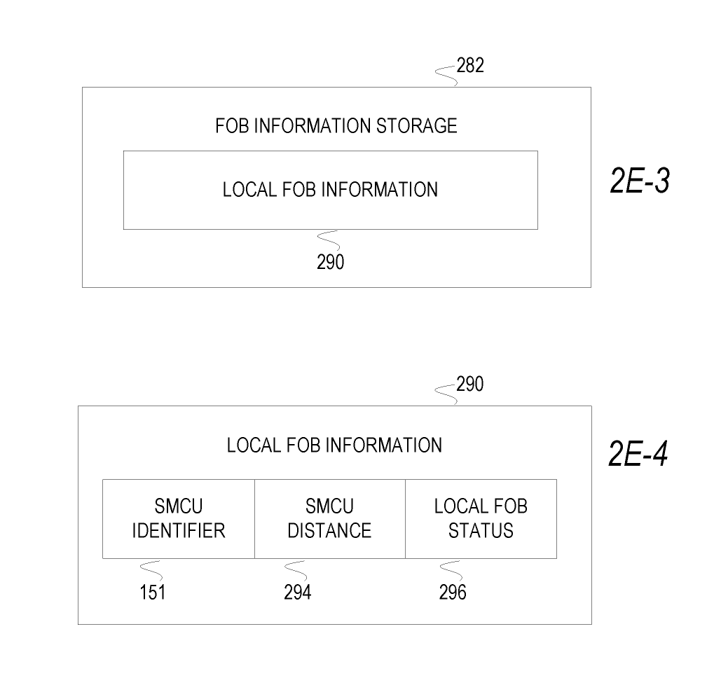

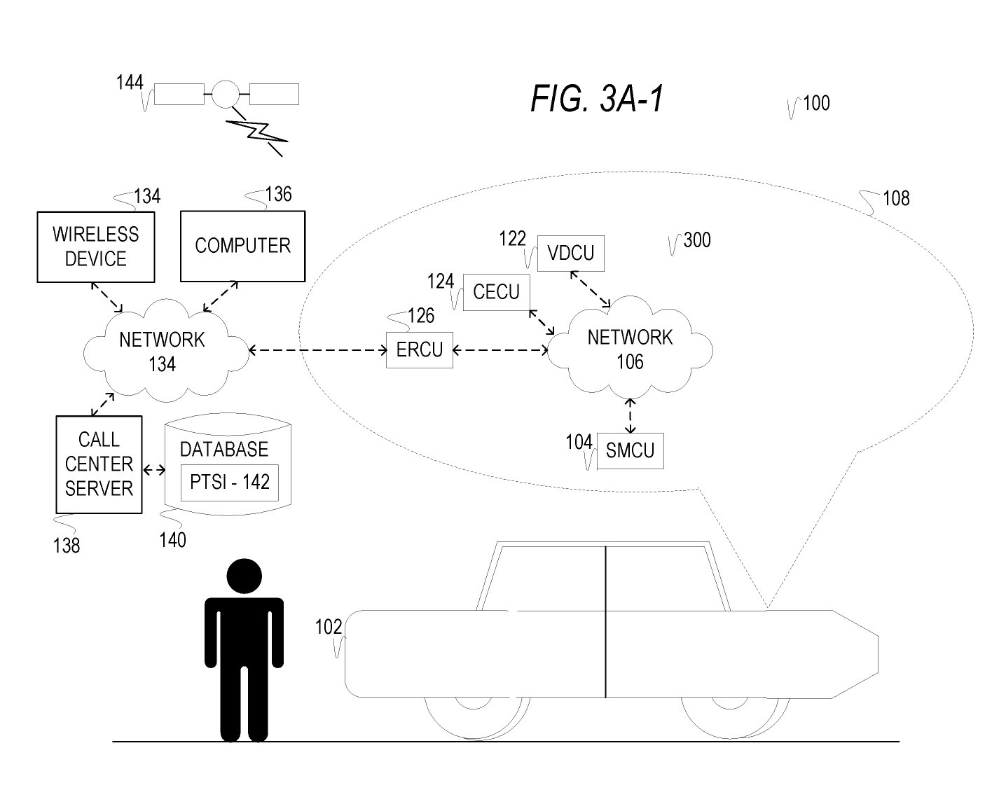

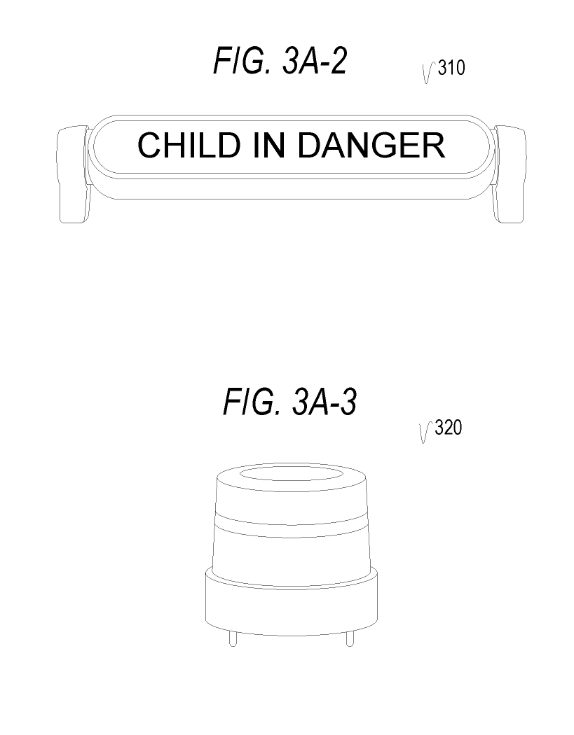

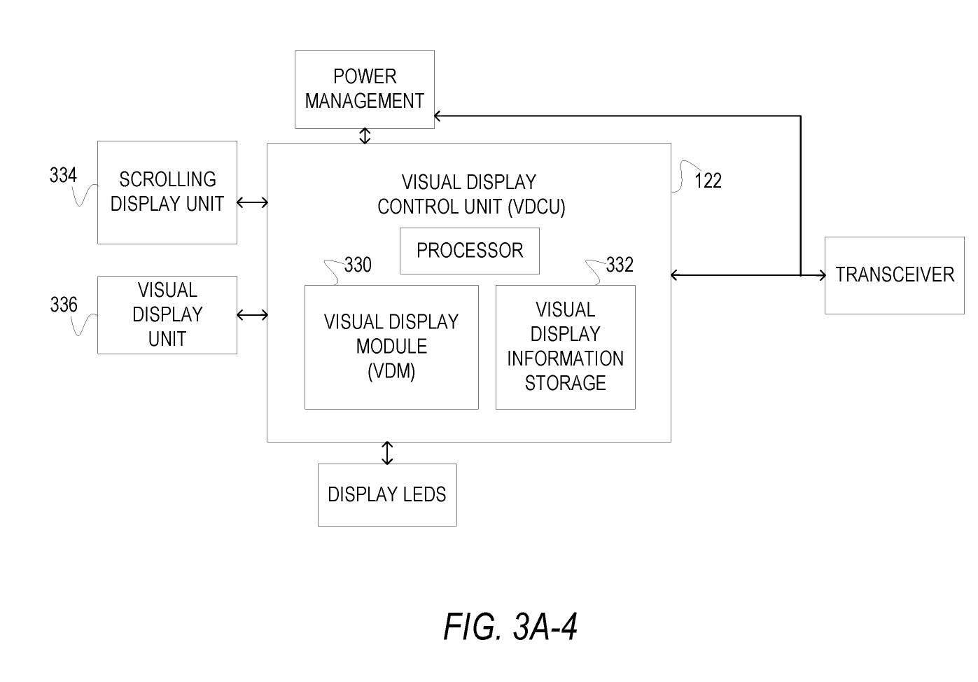

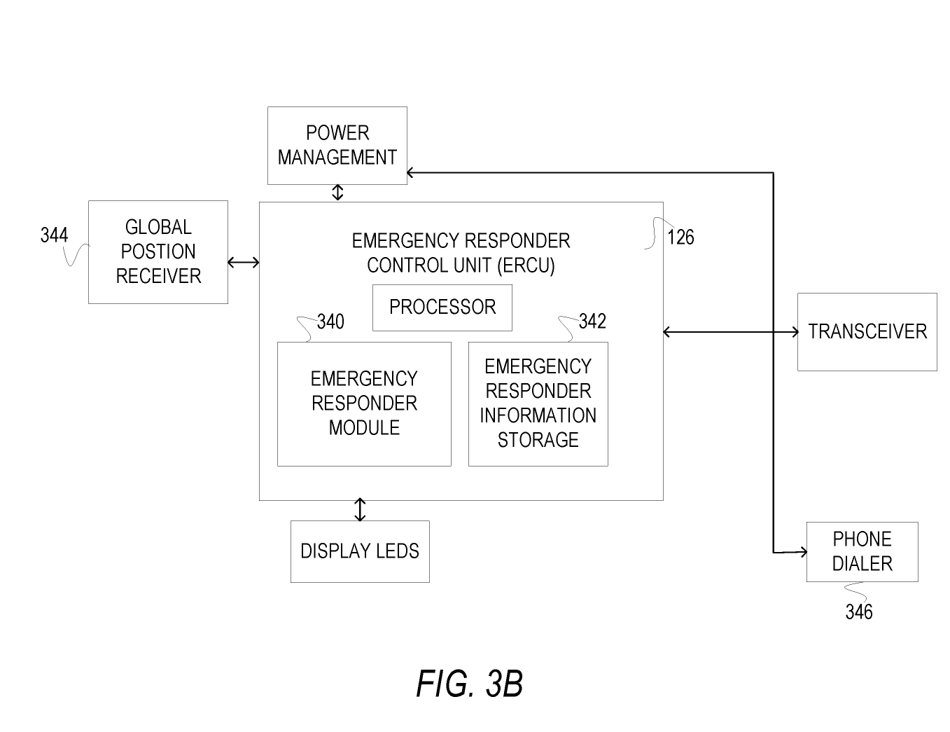

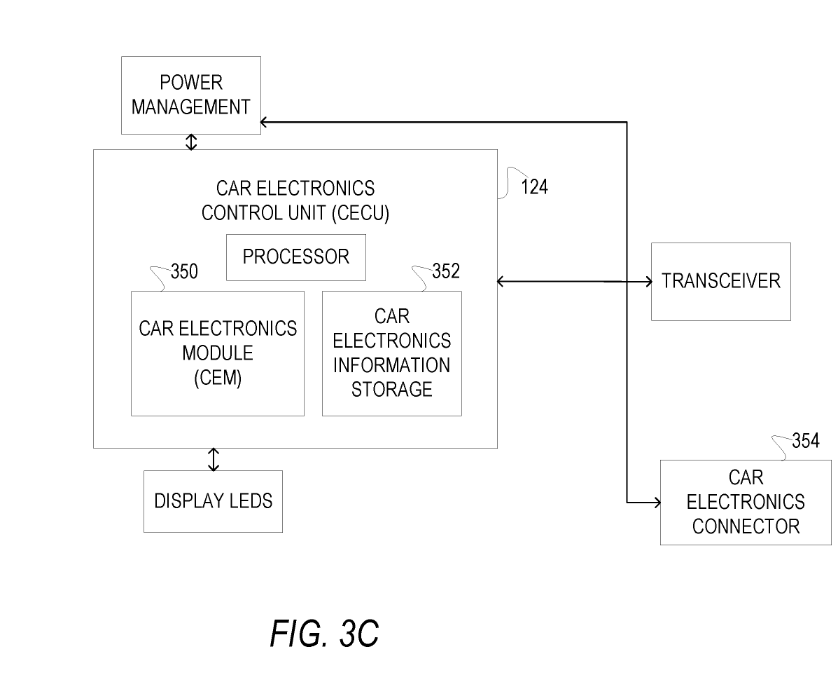

FIGS. 2A-3 is a diagram illustrating system monitor information storage 174, according to an embodiment. The system monitor information storage 174 is located on the SMCU 104 and may store session information 180, FOB information 182, and control unit information 152. The control unit information was previously described.

FIGS. 2A-4 is a diagram illustrating a session information 180, according to an embodiment. The session information 180 may store a row for each system unit (excluding the FOBCU 110) that is “linked” with the SMCU 104. Each row of the session information 180 may store the system unit identifier 150, a system unit type 188, and a system unit status 190.

### SMCU—Link Protocol

The system monitor module (SMM) 170 “links” to a system unit (SU) by broadcasting a “Request to link” message. The SUs located inside the network perimeter 108 may respond to the “Request to link” message with an acknowledgment including the system unit identifier 150 and the system unit type 188. SUs located outside the network perimeter 108 may not respond to the “Request to link” message as the SUs located outside the network perimeter 108 may not receive the “Request to link” message. Whether or not the SU responds to the “Request to link” message may be determined by a signal strength that is utilized by the SMM 170 to broadcast the “Request to link” message. In some instances, the SMM 170 may increase the radius of the network perimeter 108 by increasing the signal strength that is used to broadcast the “Request to link” message. The SU may respond to the “Request to link” message by communicating an acknowledgment message to the SMM 170 to acknowledge receipt of the “Request to link” message. The acknowledgment message may include the system unit identifier 150 and the system unit type 188. The system unit identifier 150 uniquely identifies the SU that is responding from other SUs. The system unit type 188 identifies the type of SU (e.g., CSCU 112, PSCU 114, BSCU 116, VDCU 122, CECU 124, ERCU 126, OTCU 128, OMCU 130, PCCU 132). The SMM 170 may update the system unit status 190 for the appropriate SU in the session information 180 to “LINKED” responsive to the SMM 170 receiving the message that acknowledges receipt of the “Request to link” message. The system unit status 190 “STANDBY” signifies the SU may communicate with the SMCU 104 but is not presently “LINKED.” The system unit status 190 “LINKED” signifies the SU is linked with the SMCU 104 and communicating with the SMCU 104. “Table B” describes system unit statuses (excluding FOBs).”

TABLE B

| SU Status No. | SU Status |
|---|---|
| 1. | STANDBY |
| 2. | LINKED and communicating |

### SMU—Handshake Protocol

The SMM 170 may periodically communicate an “Are you there?” message to an SU other than a FOBCU 110 and other than an OTCU 128 responsive to identifying the SU as being registered in the session information 180. The SUs may receive and respond to the “Are you there?” message by communicating an acknowledgment of receipt of the handshake message to the SMCU 104. Receipt of the acknowledgement by the SMCU 104 indicates the SU is LINKED and communicating.

FIGS. 2A-5 is a diagram illustrating FOB information 182, according to an embodiment. The FOB information 182 may include a row for each FOBCU 110 (FOB) that is “linked” with the SMCU 104. Accordingly, a FOB that is registered in the FOB information 182 is designated as “LINKED” with the SMCU 104.

### SMCU—Link Protocol—FOB

The SMM 170 may “link” to a FOBCU 110 by broadcasting a “Request to link” message. FOBCUs 110 located inside the network perimeter 108 may respond to the “Request to link” message with a FOB acknowledgment including a system unit identifier 150 in the form of a FOB identifier 192. FOBs located outside the network perimeter 108 may not respond to the “Request to link” message as the FOB may not receive the “Request to link” message. Whether or not the FOB responds to the “Request to link” message may be determined by a signal strength that is utilized by the SMCU 104 to broadcast the “Request to link” message. In some instances, the SMCU 104 may increase the radius of the network perimeter 108 by increasing the signal strength for communicating messages.

The SMM 170 may receive the FOB acknowledgement and adds a row to the FOB information 182 responsive to identifying the particular FOB as not being previously registered in the FOB information 182. Each row stores the FOB identifier 192, the FOB distance 194, and the FOB status 196. The FOB identifier 192 uniquely identifies the FOB from other system units. The FOB distance 194 is an estimate of the distance between the FOBCU 110 and the SMCU 104. The FOB distance 194 is estimated by the SMM 170 based on the signal strength of the FOB acknowledgment that is being received from the particular FOB. The SMCU 104 provides an indication of signal strength in conjunction with receipt of the FOB acknowledgement that is received by the SMM 170 to enable the system monitor module 170 to estimate the distance. For example, the transceiver that is coupled to the SMCU 104 may provide the indication of the signal strength to the SMCU 104 that, in turn, provides the indication of the signal strength to the SMM 170. A strong signal strength indicates a short distance between the SMCU 104 and the FOBCU 110 and a weak signal strength indicates a long distance. For example, a received signal strength of “100%” may correspond to a distance of twenty-five feet; a received signal strength of “50%” may correspond to a distance of fifty feet; and the received signal strength of “25%” may correspond to a distance of one hundred feet. Other embodiments may utilize other schemes to associate a received signal strength with a distance. The FOB status 196 may be identified by the SMM 170 based on the FOB distance 194.

“Table C” describes the FOB status 196 at the SMCU 104.

TABLE C

| FOB Status No. | FOB Status |
|---|---|
| 1. | STANDBY |
| 2. | LINKED and communicating |
| 3. | LINKED and beyond “first distance” |
| 4. | LINKED and beyond “second distance” |
| 5. | LINKED and went to standby |

The SMM 170 may register a “no FOB alert” responsive to the SMM 170 identifying at least one seat as being occupied with its associated seat belt being buckled and no FOBCUs 110 being registered in the FOB information 182. The SMM 170 maintains the “no FOB alert” until a FOBCU 110 responds to the “Request to link” message or the status of the seat changes.

### SMU—Handshake Protocol—FOB

The SMM 170 may periodically communicate an “Are you there?” message to a FOBCU 110 responsive to identifying the FOBCU 110 as being registered in the FOB information 182. The FOB may receive and respond to the “Are you there?” message by communicating a FOB acknowledgment of the “Are you there?” message to the SMCU 104. Receipt of the FOB acknowledgement indicates the FOB is linked and communicating. The SMM 170 further utilizes the strength of the FOB acknowledgment (e.g., “I am here” message) to update the FOB distance 194 in the FOB information 182, as described above.

FIGS. 2B-1 is a diagram illustrating a car seat 200, according to an embodiment. The car seat 200 includes the car seat control unit (CSCU) 112. The CSCU 112 includes a lower latch control unit (LLCU) 118 and an upper latch control unit 120 (ULCU). The LLCU 118 and the ULCU 120 are physical control units that are electronically paired to each other for communication with each other. The LLCU 118 and the ULCU 120 form the CSCU 112, a logical construct, to ensure a child is safely secured in a child car seat 200. The ULCU 120 may communicate a status, over the network 106, to the LLCU 118 and the LLCU 118 (acting as a proxy for the CSCU 112), in turn, communicates the status, over the network 106, to the SMCU 104. For example, responsive to the ULCU 120 detecting an unbuckled seat belt, the ULCU 120 may communicate a status to the LLCU 118 that (acting as a proxy for the CSCU 112), in turn, communicates the status (e.g., not buckled) to the SMCU 104 that, in turn, processes the alert. In addition, the ULCU 120 may include a second (e.g., redundant) temperature sensor that functions as a back-up temperature sensor to the temperature sensor 172 (e.g., first temperature sensor) in the SMCU 104 (shown in FIGS. 2A-2). Accordingly, the ULCU 120 may communicate a buckle status (e.g., buckled, not buckled) and/or temperature status to the LLCU 118 that, in turn (acting as a proxy for the CSCU 112), communicates the statuses that were received from the ULCU 120, and its own statuses, to the SMCU 104.

In another embodiment, the LLCU 118 may be included in a housing that is affixed to the housing of an existing lower seat belt receptacle of the child car seat 200. For example, the housing that includes the LLCU 118 may be affixed with a sticky adhesive to the housing of the existing lower seat belt receptacle. Further, according to the same embodiment, the ULCU 120 may be included in a housing that is affixed to the housing of an existing upper seat belt receptacle of the child car seat 200. For example, the housing that includes the ULCU 120 may be affixed with a sticky adhesive to the housing of the upper seat belt receptacle.

FIGS. 2B-2 is a diagram further an extender unit 202, according to an embodiment. The extender unit 202 may be utilized to retrofit an existing seat belt in the vehicle 102. The extender unit 202 may be utilized to identify whether a seat belt is buckled or unbuckled. For example, the extender unit 202 may be utilized in conjunction with the child car seat 200, a booster seat, or a passenger seat to identify whether a seat belt is buckled or unbuckled. The extender unit 202 may include a female buckle assembly 204 and a male buckle assembly 206. The female buckle assembly 204 may include a sensor that senses whether the female buckle is buckled/unbuckled. The male buckle assembly 206 may include a sensor that senses whether the male buckle is buckled/unbuckled.

FIGS. 2B-3 is a diagram illustrating an upper latch control unit (ULCU) 120, according to an embodiment. The ULCU 120 may include a processor, an upper latch module (ULM) 210, including instructions that are executable by the processor, and upper latch information storage that is utilized for the storage and retrieval of information. The ULCU 120 is communicatively coupled to upper latch component elements including a power management (e.g., battery) component element, a temperature sensor 212 for sensing the ambient temperature, a network interface device (e.g., transceiver (e.g., wireless, radio)) for communicating with other system units or devices, display LEDs, and a belt buckle sensor 214 for sensing the buckling/unbuckling of a seat belt. The LED may blink at different rates to indicate different conditions including whether the seat belt is buckled, the ULCU 120 is “linked” with SMCU 104, a first level warning for low battery and a second level warning for low battery.

The ULCU 120 may operate in “Standby” mode until the belt buckle sensor 214 registers a seat belt as buckled. The ULCU 120 may send “belt buckled” message to the LLCU 120 and transition to the “Up” mode responsive to the belt buckle sensor 214 sensing the seat belt being buckled. Further, the ULCU 120 may send “belt unbuckled” message to ULCU 120 and transition to the “Standby” mode responsive to the belt buckle sensor 214 sensing the seat belt being unbuckled. The ULCU 120 may further periodically read the temperature sensor 212 and communicate a message including temperature information to the LLCU 112 that, in turn, communicates a message to the SMCU 104. For example, the temperature information may include the ambient temperature.

FIGS. 2B-4 is a block diagram illustrating a lower latch control unit (LLCU) 118, according to an embodiment. The LLCU 118 may include a processor, a lower latch module (LLM) 220 including instructions that are executable by the processor and lower latch information storage that is utilized for the storage and retrieval of information. The LLCU 118 is communicatively coupled to lower latch component elements including a power management (e.g., battery) component element, a network interface device (e.g., transceiver (e.g., wireless, radio)) for communicating with other system units or devices, display LEDs, an occupant present sensor 222, a left belt buckle sensor 224 that monitors the status of a latch and buckle assembly (e.g., seat belt) that senses buckling/unbuckling of the seat belt and a right belt buckle sensor 226 that senses buckling/unbuckling of the seat belt. Other embodiments may include a single belt buckle sensor. The LED may blink at different rates to indicate different conditions including whether one or both of the seat belt are buckled, whether the LLCU 118 is “linked” or not “linked” with SMCU 104, a first level warning for low battery and a second level warning for low battery.

The LLCU 120 may operate in “Standby” mode until the left belt buckle sensor 224 senses the seat belt as buckled, the right belt buckle sensor 226 senses the seat belt as buckled, and a message is received from the ULCU 120 indicating a sensing of its seat belt as being buckled. Further, the LLCU 118 may send a “belt unbuckled” message to SMCU 104 and transition to the “Standby” mode responsive to the LLCU 118 identifying the left belt buckle sensor 224 sensing its seat belt unbuckled, the right belt buckle sensor 226 sensing its seat belt unbuckled, or receiving a message from the ULCU 120 indicating the belt buckle sensor 214 sensing its seat belt unbuckled.

FIGS. 2C-1 is a diagram illustrating a side view of a passenger seat 230, according to an embodiment. The passenger seat 230 includes a seat belt that includes a seat belt housing 232. Affixed to the seat belt housing 232 is a passenger seat housing 234 including the PSCU 114 and passenger seat component elements. The passenger seat housing 234 may be affixed to the seat belt housing 232 with an adhesive. Another embodiment may include a seat belt housing 232 that includes the PSCU 114 and passenger seat component elements.

FIGS. 2C-2 is a diagram illustrating a passenger seat control unit (PSCU) 114, according to an embodiment. The PSCU 114 may include a processor, a passenger seat module (PSM) 240 including instructions that are executable by the processor and passenger seat information storage that is utilized for the storage and retrieval of information. The PSCU 114 is communicatively coupled to passenger seat component elements including a power management (e.g., battery) component element, a network interface device (e.g., transceiver (e.g., wireless, radio)) for communicating with other system units or devices, display LEDs, an occupant present sensor 242, a belt buckle sensor 244 that monitors the status of a latch and buckle assembly (e.g., seat belt) that senses buckling/unbuckling. The LED may blink at different rates to indicate different conditions including whether the seat belt is buckled, whether the PSCU 114 is “linked” or not “linked” with SMCU 104, a first level warning for low battery and a second level warning for low battery.

The PSCU 114 may operate in “Standby” mode until the belt buckle sensor 244 registers a seat belt as buckled. The PSCU 114 may send the “belt buckled” message to the SMCU 104 and transition to the “Up” mode responsive to the belt buckle sensor 244 sensing the seat belt being buckled. Further, the PSCU 114 may send “belt unbuckled” message to SMCU 104 and transition to the “Standby” mode responsive to the belt buckle sensor 244 sensing the seat belt being unbuckled.

FIGS. 2D-1 is a diagram illustrating a booster seat 250, according to an embodiment. The booster seat 250 may be secured to the vehicle 102 with a seat belt that includes a seat belt housing 252 including the BSCU 116 and booster seat component elements. In another embodiment, the booster seat housing 254 may include the BSCU 116 and booster seat component elements and the booster seat housing 254 may be affixed, with an adhesive, to the seat belt housing 252.

FIGS. 2D-2 is a diagram illustrating the booster seat control unit 116, according to an embodiment. The BSCU 116 may include a processor, a booster seat module (BSM) 260 including instructions that are executable by the processor and booster seat information storage that is utilized for the storage and retrieval of information. The BSCU 116 is communicatively coupled to booster seat component elements including a power management (e.g., battery) component element, a network interface device (e.g., transceiver (e.g., wireless, radio)) for communicating with other system units or devices, display LEDs, an occupant present sensor 262, a belt buckle sensor 264 that monitors the status of a latch and buckle assembly (e.g., seat belt) that senses buckling/unbuckling. The LED may blink at different rates to indicate different conditions including whether the seat belt is buckled, whether the BSCU 116 is “linked” or not “linked” with SMCU 104, a first level warning for low battery and a second level warning for low battery.

The BSCU 116 may operate in “Standby” mode until the belt buckle sensor 264 registers a seat belt as buckled. The BSCU 116 may send “belt buckled” message to the SMCU 104 and transition to the “Up” mode responsive to the belt buckle sensor 264 sensing the seat belt being buckled. Further, the BSCU 116 may send “belt unbuckled” message to SMCU 104 and transition to the “Standby” mode responsive to the belt buckle sensor 264 sensing the seat belt being unbuckled.

FIGS. 2E-1 is a diagram illustrating a FOB 109, according to an embodiment. The FOB 109 includes a loop and a base. The loop may be used to attach a set of keys. Accordingly, the FOB 109 may function as a key chain unit remote to the SMCU 104, according to an embodiment. The base may include LEDs for communicating status, a “STANDBY” button 270, and a “SNOOZE” button 272. The “STANDBY” button 270 may be pressed to place the FOB 109 in the “STANDBY” mode. The “SNOOZE” button 272 may be pressed to temporarily dismiss a “first distance alert”, as previously described. The FOB 109 includes the FOBCU 110. The FOBCU 110 may be utilized by the SMCU 104 as the primary device for communicating alerts. For example, the FOBCU 110 may provide a FOB alert to a driver who carries the FOB beyond a “first distance” from the vehicle 102. Further for example, the FOBCU 110 may provide a FOB alert to a driver who carries the FOB beyond a “second distance” from the vehicle 102. The FOBCU 110 may further alert a driver responsive to the SMCU 104 detecting an unsafe temperature condition in the vehicle 102. The FOBCU 110 may communicate the alerts to the holder of the FOB 109 in the form different types of audible and/or haptic alerts to signify different types of alerts.

In another embodiment, the FOB 109 may communicate additional statuses. For example, in an embodiment that includes a vehicle in the form of a commercial airplane, the FOB 109 may emit a status that identifies a row of seats as the holder of the FOB 109 walks by the row of seats. Continuing with the example, the FOB 109 may emit a haptic alert responsive to the FOB 109 being carried by a row of seats that includes at least one seat that is registered as being occupied and with the seat belt being registered as unbuckled. For example, the SMCU 104 may utilize signal strength, as previously described, to identify whether the FOB 109 is being carried by the described row of seats and communicate the haptic alert to the FOBCU 110 that, in turn, causes the FOB 109 to emit a haptic alert in the form of a burst.

FIGS. 2E-2 is a diagram illustrating the FOBCU 110, according to an embodiment. The FOBCU 110 may include a processor, a FOB module 280 including instructions that are executable by the processor, and FOB information storage 282 that is utilized to store and retrieve information. The FOBCU 110 is communicatively coupled to FOBCU component elements including power management (e.g., battery), a network interface device (e.g., transceiver (e.g., wireless, radio) for communicating with other system units or devices, the standby button 270, the snooze button 272, a mode control, display LEDs, a sound generator for generating sound that is audibly mediated with a speaker, and a vibrator that provides haptic signals. The FOBCU 110 may enter the “Standby” mode, according to an embodiment, responsive to receiving a “go to standby” message from SMM 170 or responsive to identifying the standby button 270 as being pushed. The FOBCU 110 may temporarily cancel a “first distance alert” responsive to identifying the snooze button 272 as being pushed.

FIGS. 2E-3 is a diagram illustrating FOB information storage 282, according to an embodiment. The FOB information storage 282 may store local FOB information 290. The FOB information storage 282 may be generated and maintained/updated by the FOB module 280. For example, the FOB information storage 282 may be utilized by the FOB module 280 to maintain status for the FOBCU 110.

FIGS. 2E-4 is a diagram illustrating local FOB information 290, according to an embodiment. The local FOB information 290 may be used to store a system monitor control unit (SMCU) identifier 151, a SMCU distance 294, and a local FOB status 296. The local FOB information 290 may include an initialized row for the SMCU 104 that is linked with the FOBCU 110. The FOB module 280 may add the row to the local FOB information 290 responsive to identifying the particular SMCU identifier 151 as not registered in the local FOB information 290. To this end, the FOBCU 110 registers the row to include the SMCU identifier 151, the SMCU distance 294, and the local FOB status 296. The SMCU identifier 151 uniquely identifies the SMCU 104 and is received, as described above, in the “Request to link” message from the SMCU 104. The SMCU distance 294 is estimated by the FOBCU 110 based on the signal strength of the “Request to link” message that is being received at the FOBCU 110 from the SMCU 104. The transceiver that is coupled to the FOBCU 110 provides an indication of signal strength in conjunction with receipt of the “Request to link” message to enable the FOB module 280 to estimate the distance between the FOBCU 110 and the SMCU 104. For example, the transceiver that is coupled to the FOBCU 110 may provide the indication of the signal strength to the FOBCU 110 that, in turn, provides the indication of the signal strength to the FOB module 280. A strong signal strength indicates a short distance and a weak signal strength indicates a long distance, as was previously described with respect to the SMCU 104. The local FOB status 296 is written by the FOB module 280 into the local FOB information 290 and indicates the status of the FOBCU 110. Table D″ describes the local FOB status 296 at the FOBCU 110.

TABLE D

| FOB Status No. | FOB Status |
|---|---|
| 1. | linked and communicating |
| 2. | linked and beyond “first distance” |
| 3. | linked and beyond “second distance” |
| 4. | linked and went to Standby |

Each local FOB status 296 and corresponding SMCU distance 294 in the local FOB information 290 may be periodically updated by the FOB module 280. For example, the local FOB 296 status and the SMCU distance 294 may be updated by the FOB module 280 responsive to the FOB module 280 receiving an “Are you there?” message from an SMCU 104. That is, the SMCU 104 may periodically broadcast an “Are you there?” message to the FOBCU 110 that may be received by the FOBCU 110 and processed by the FOB module 280 which responds by communicating a FOB acknowledgment to the SMM 170 (e.g., handshake) and further by updating the SMCU distance 294 and the local FOB status 296 in the local FOB information 290, as described above. Accordingly, the FOB module 280 may utilize the local FOB information 290 in conjunction with periodic receipt of “Are you there?” messages to maintain an accurate SMCU distance 294 and local FOB status 296 for the FOBCU 110.

FIGS. 3A-1 is a diagram illustrating alerting system units 300, according to an embodiment. The alerting system units 300 are optional and may be utilized to enhance the communication of an alert. For example, the alerting system units 300 may be utilized to hale additional emergency responders responsive to the SMCU 104 identifying an alert. The alerting system units 300 may include the video display control unit VDCU 122, the car electronic control unit CECU 124 and the emergency control unit ERCU 126. The alerting system units 300 are located inside the vehicle 102. For example, the alerting system units 300 may be positioned in the trunk of the vehicle 102. The alerting system units 300 support bidirectional communication with the SMCU 104 and may be separately added and removed from the system 100.

FIGS. 3A-2 is a diagram illustrating a scrolling display unit 310, according to an embodiment. The scrolling display unit 310 may be mounted on the vehicle 102 or inside the vehicle 102 and operates by scrolling a message that may be read. The scrolling display unit 310 may be controlled by the VDCU 122. The scrolling display unit 310 may initiate the display of messages responsive to the SMCU 104 identifying a temperature—No FOB—alert or a temperature exposure alert.

FIGS. 3A-3 is a diagram illustrating a visual display unit 320, according to an embodiment. The visual display unit 320 may be mounted in a visible location inside the vehicle 102 or on the vehicle 102 and operates by illuminating an alert. The visual display unit 320 may be controlled by the VDCU 122. The visual display unit 320 may illuminate visual signals responsive to the SMCU 104 identifying a temperature—No FOB—alert or a temperature exposure alert.

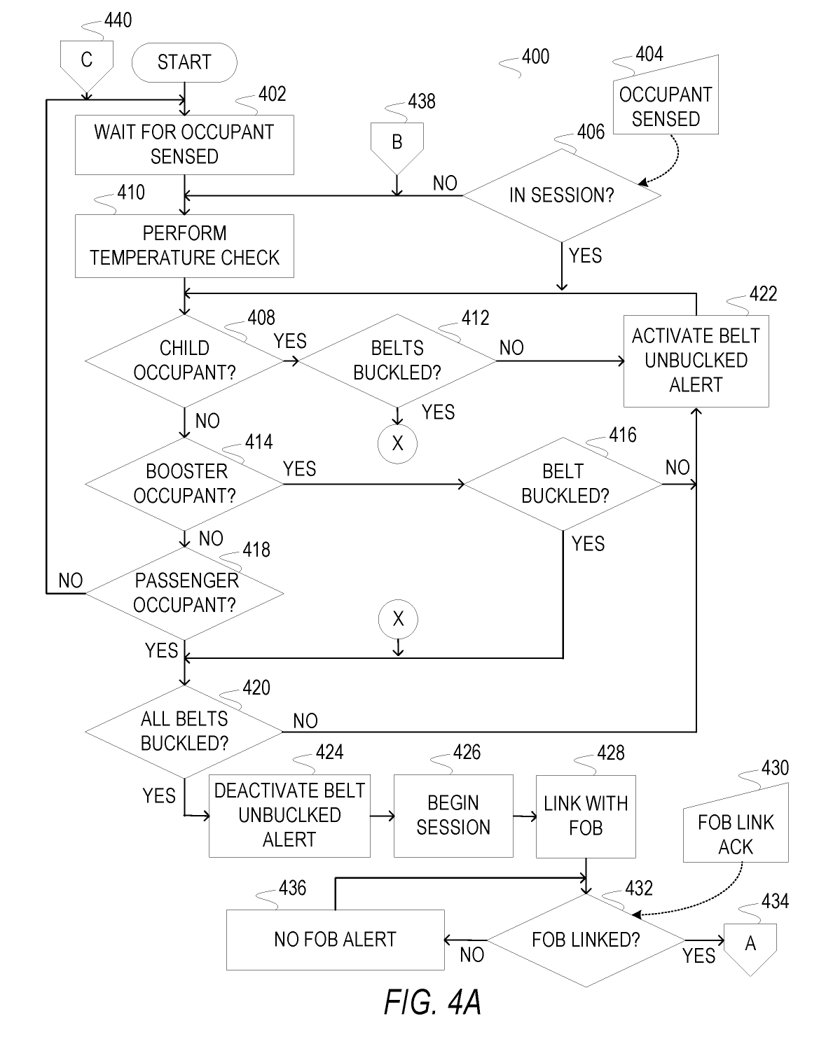

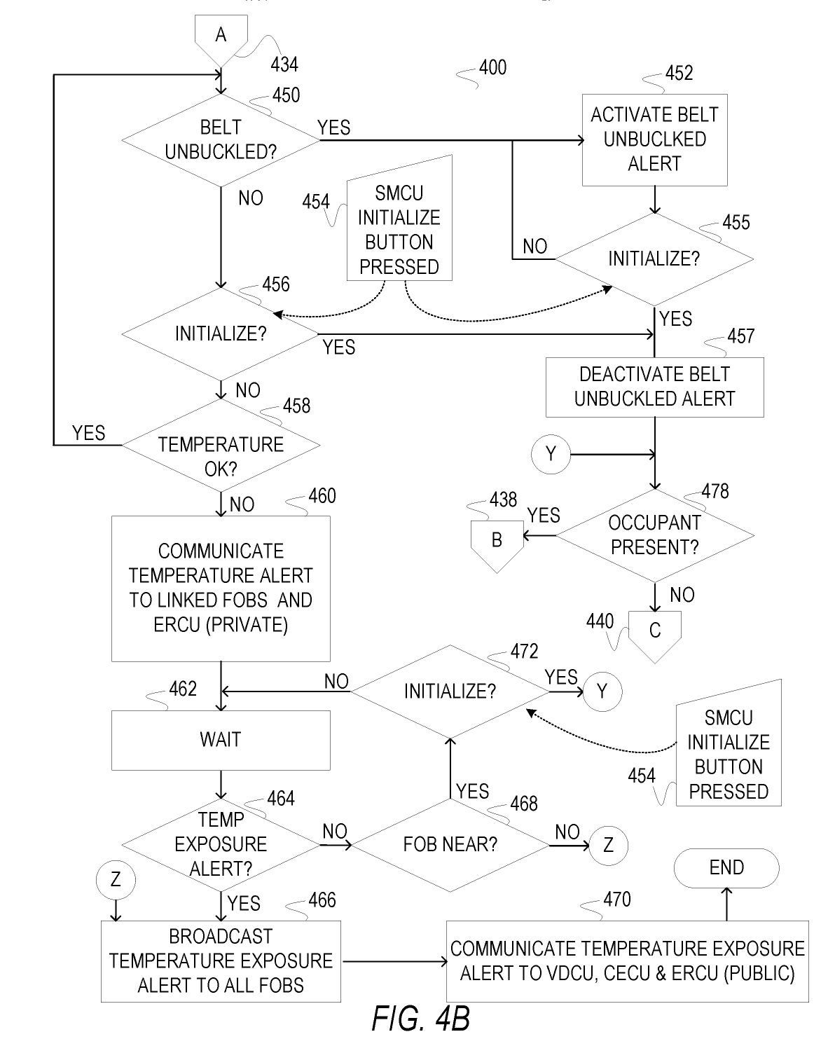

FIGS. 3A-4 is a diagram illustrating a visual display control unit VDCU 122, according to an embodiment. The VDCU 122 may include a processor, a visual display module (VDM) 330 including instructions that are executable by the processor, and visual display information storage 332 that is utilized to store and retrieve information including scrolling display messages and other messages. The VDCU 122 is communicatively coupled to visual display component elements including power management (e.g., battery), a network interface device (e.g., transceiver (e.g., wireless, radio) for communicating with other system units or devices, the scrolling display unit 334, the visual display unit 336 and display LEDs.

The visual display module 330 may receive a message indicating an alert from the SMCU 104 and respond to the alert by turning on or off the scrolling display unit 334 and/or the visual display unit 336. The alert may include the “Temperature—No FOB—Alert” and the “Temperature Exposure Alert.”

The visual display module 330 may control the displaying of scrolling display messages on the scrolling display unit 334. The scrolling display messages are stored as scrolling display message information 157 in the control unit information 152 in the database 140 that is coupled to the call center server 138. The call center server 138 may communicate the scrolling display message information 157 to the SMCU 104 that, in turn, communicates the scrolling display message information 157 to the VDCU 122. In another embodiment, the visual display module 330 may retrieve the scrolling display message information 157 directly from call center server 138 via the emergency responder control unit 126.

FIG. 3B is a diagram illustrating an emergency responder control unit (ERCU) 126, according to an embodiment. The ERCU 126 may include a processor, an emergency responder module (ERM) 340 including instructions that are executable by the processor, and emergency responder information storage 342 that is utilized to store and retrieve information. The ERCU 126 is communicatively coupled to emergency responder component elements including power management (e.g., battery), a network interface device (e.g., transceiver (e.g., wireless, radio) for communicating with other system units or devices over the network 106 and the network 134, an (optional) global position receiver 344, a phone dialer 346 and display LEDs. The global position receiver 344 may receive information from one or more global position system satellites 144 and utilize the information to calculate the location (e.g., geographic coordinates) of the ERCU 126.

The emergency responder module (ERM) 340 may receive, over the network 106, a message, indicating an alert, from the SMCU 104 and communicate the message, over the network 134, to the call center server 138 that, in turn, communicates the message to emergency responders. The ERM 340 may append the system unit identifier 150 of the SMCU 104 and geographic coordinates to the message. The call center server 138 may receive the message and communicate the message to emergency responders. The emergency responders may include public entities (e.g., “911 services,” fire, police, etc.) and private entities (e.g., family members). The call center server 138 may communicate the message to private entities by accessing the control unit information 152 in the database 140 that is coupled to the call center server 138 based on the system unit identifier 150. For example, the control unit information 152 may be accessed based on the system unit identifier 150 that is appended to the message. For example, the call center server 138 may retrieve telephone number information 153 (e.g., telephone numbers) and email address information 154 (e.g., email addresses) based on the system unit identifier 150 and communicate the message over the network 134 by utilizing the telephone numbers and email addresses. In one embodiment the ERM 340 may utilize the phone dialer 346 to place a telephone call over an Internet connection established over the network 134 (e.g., Internet). For example, the ERM 340 may utilize voice over Internet protocol. In another embodiment the ERM 340 may utilize the phone dialer 346 to place a telephone call using plain old telephone service (POTS).

FIG. 3C is a diagram illustrating car electronics control unit (CECU) 124, according to an embodiment. The CECU 124 may include a processor, a car electronics module (CEM) 350 including instructions that are executable by the processor, and car electronics information storage 352 that is utilized to store and retrieve information. The CECU 124 is communicatively coupled to car electronics component elements including power management (e.g., battery), a network interface device (e.g., transceiver (e.g., wireless, radio) for communicating with other system units or devices, a car electronics connector 354 and display LEDs. The car electronics connector 354 may be utilized to communicate with the electronic components in the vehicle 102 that control the horn, lights, radio, and the like. For example, the CEM 350 may receive a message indicating an alert from the SMCU 104 and respond to the alert by communicating car electronic commands via the car electronics connector to control the horn, lights, radio, and the like. The alert may include the “Temperature—No FOB—Alert” and the “Temperature Exposure Alert.”

FIG. 4A is a diagram illustrating a method 400, according to an embodiment, to safely transport passengers. The method 400 commences at operation 402, at the SMCU 104, with the system monitor module (SMM) 170 waiting for an “occupant present” message (OPM). For example, the SMM 170 may wait for the OPM from an LLCU 118, BSCU 116 or PSCU 114.

At operation 404, the SMM 170 receives, from over the network 106 (e.g., wireless network), an “occupant present” message from LLM(s), BSM(s), PSM(s) or a “Belt Clicked” message from LLM(s), BSM(s), PSM(s). The dashed line indicates external network input (e.g., message, push button, etc.).

At decision operation 406, the SMM 170 identifies whether a session is in progress. If the SMM 170 identifies a session is in progress, then processing continues at decision operation 408. Otherwise, processing continues at operation 410. At operation 410, the SMM 170 performs a temperature check.

At decision operation 408, the SMM 170 identifies whether the “occupant present” message received at operation 404 indicates a child is occupying a child car seat 200. For example, the “occupant present” message may indicate the occupant present sensor 222 on the LLCU 118 indicates the presence of an occupant in the child car seat 200. If the SMM 170 identifies the “occupant present” message indicates a child is occupying the child car seat 200, then processing continues at decision operation 412. Otherwise processing continues at operation 414.

At decision operation 414, the SMM 170 identifies whether the “occupant present” message received at operation 404 indicates a child is occupying a booster seat 250. For example, the occupant present message received at operation 404 message may indicate the occupant present sensor 262 on the BSCU 116 indicates the presence of an occupant in the booster seat 250. If the SMM 170 identifies the “occupant present” message indicates a child is occupying a booster seat 250, then processing continues at decision operation 416. Otherwise processing continues at decision operation 418.

At decision operation 418, the SMM 170 identifies whether the “occupant present” message indicates a child is occupying a passenger seat 230. For example, the occupant present message received at operation 404 may indicate the occupant present sensor 242 on the PSCU 114 indicates the presence of an occupant in the passenger seat 230. If the SMM 170 identifies the “occupant present” message indicates a child is occupying a passenger seat 230, then processing continues at decision operation 420. Otherwise processing continues at operation 402.

At decision operation 412, the SMM 170 identifies whether the seat belts at the child car seat 200 are buckled. For example, the SMM 170 may have previously received a “belts buckled” message from the LLCU 118 and stored a “belts buckled” status in the system monitor information storage 174. If the SMM 170 identifies the seat belts at the child car seat 200 are buckled based on the “belts buckled” status, then processing continues at decision operation 420 (via on-page connector “X”). Otherwise processing continues at operation 422.

At operation 422, the SMM 170 activates a “belt unbuckled alert.” For example, the SMM 170 may cause the SMCU 104 to emit an audible alert responsive to the activation of the “belt unbuckled alert.”

At decision operation 416, the SMM 170 identifies whether the seat belt at the booster seat 250 is buckled. For example, the SMM 170 may have previously received a “belts buckled” message from the BSCU 116 and stored a “belts buckled” status in the system monitor information storage 174. If the SMM 170 identifies the seat belt at the booster seat 250 is buckled based on the “belts buckled” status, then processing continues at decision operation 420. Otherwise processing continues at operation 422.

At decision operation 420, the SMM 170 identifies whether all seats that are registered as sensing an occupant present are also registered with seat belts buckled. If the SMM 170 identifies that all seats registered as occupied are further registered with seat belts buckled, then processing continues at operation 424. Otherwise, processing continues at operation 422.

At operation 424, the SMM 170 deactivates the “belt unbuckled alert.” For example, the SMM 170 may cause an audible alert to cease. At operation 426, the SMM 170 registers the beginning of a session. For example, the SMM may store an “in session” status in the system monitor information storage 174.

At operation 428, the SMM 170 periodically broadcasts a “Looking for FOBs” (e.g., Request to link) message. In addition, the SMM 170 periodically scans the FOB information 182 and communicates an “Are you there??” message to a FOBCU 110 responsive to identifying the FOBCU 110 as being registered in the FOB information 182. The SMM 170 repeats this operation for each FOBCU 110 that is identified as registered in the FOB information 182. The frequency of broadcasting the “looking for FOBs”/“Request to link” message and the frequency of communicating the “Are you there??” message may be the same or different. For example, the SMCU 104 may broadcast the “looking for FOBs”/“Request to link” message every second and communicate the “Are you there??” message every 500 milliseconds.

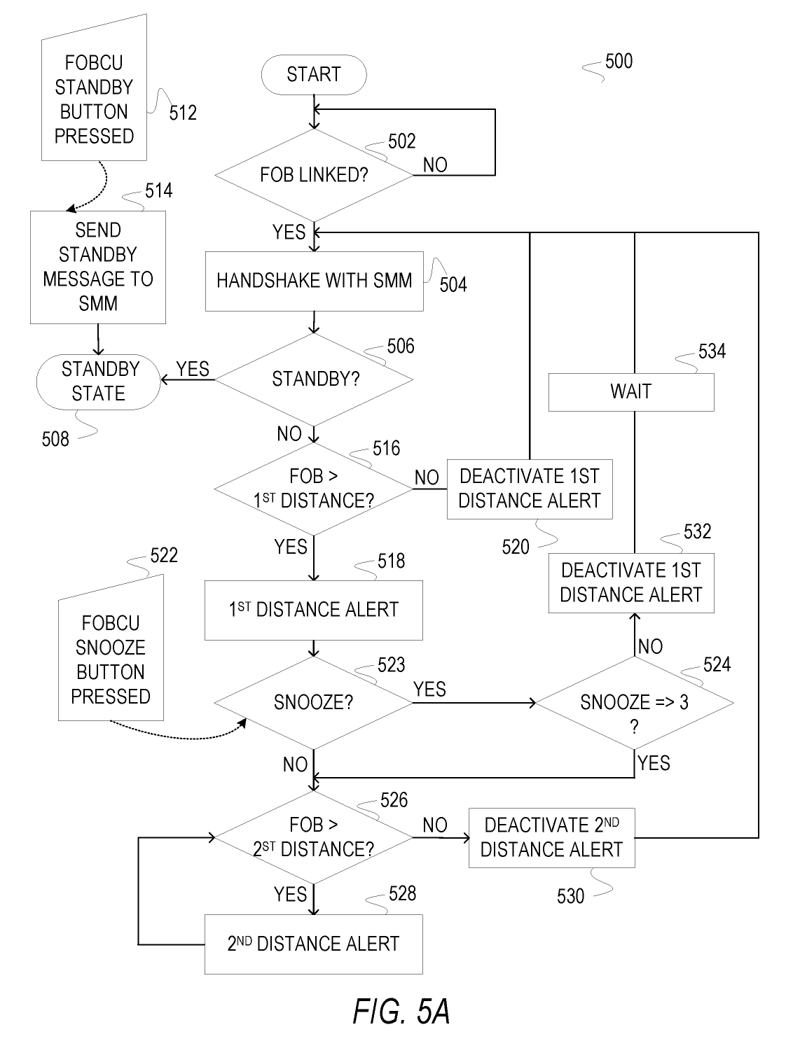

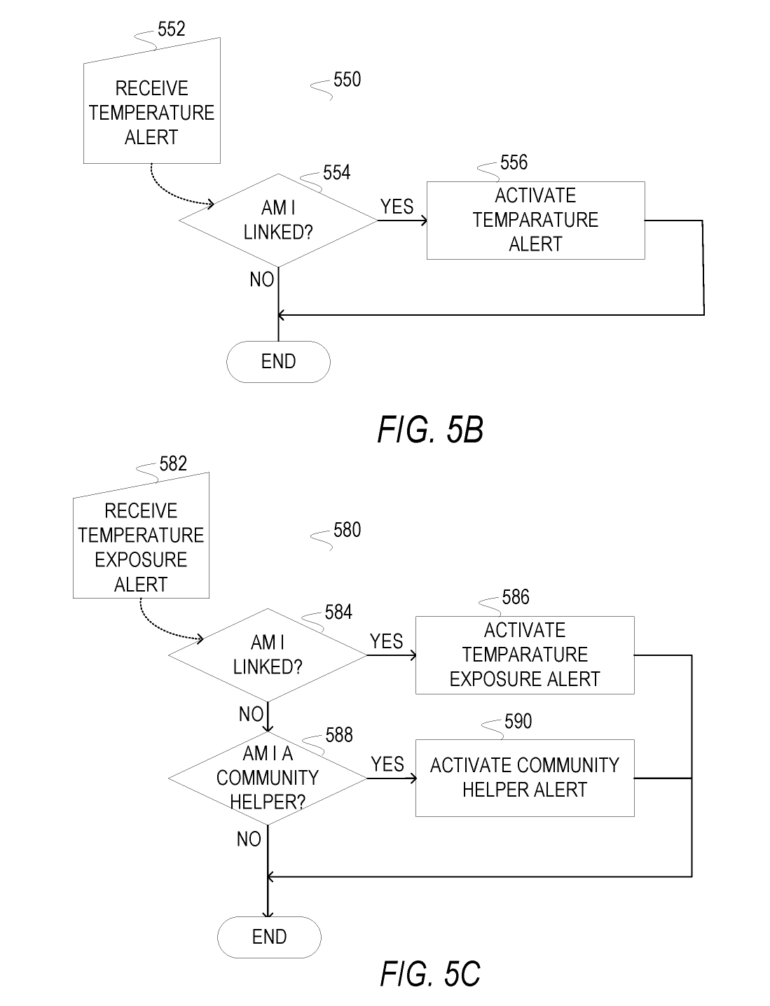

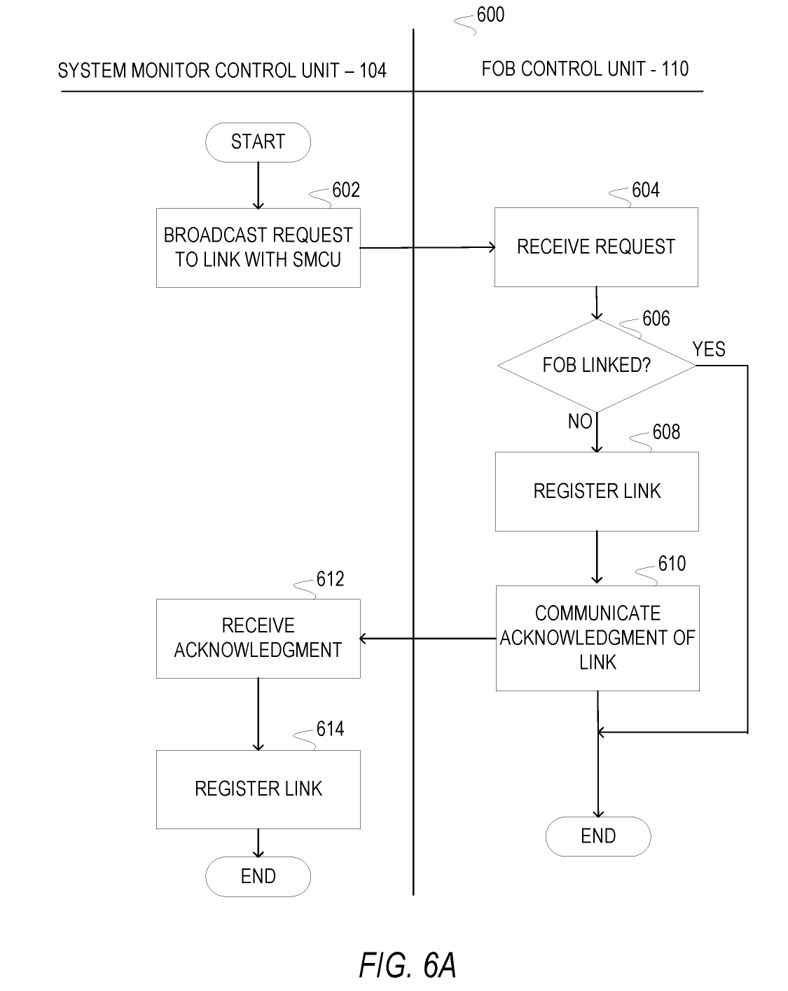

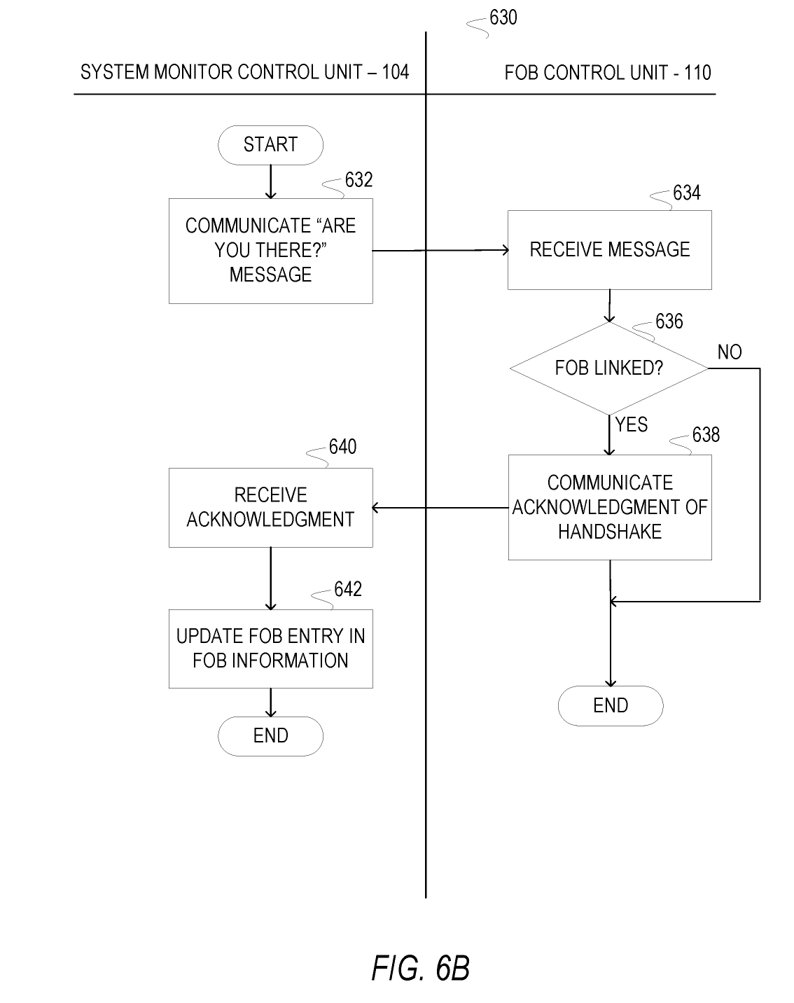

At operation 430, the SMM 170 may receive an “I am here” message from a FOBCU 110 that received the “Are you there?” (e.g., operation 504 on FIG. 5A) message. Receipt of the “I am here?” message causes the SMM 170 to update the row associated with the respective FOBCU 110 in the FOB information 182, as previously described. In addition, the SMM 170 may receive a “FOB Acknowledgement” message from a FOB that received the “Looking for FOBs” (e.g., Request to link) message (e.g., operation 502 on FIG. 5A). Receipt of the “FOB Acknowledgement” message causes the SMM 170 to link with the FOBCU 110. For example, the SMM 170 may register/link the FOB in the current session by populating a row for the FOBCU 110 in the FOB information 182, as previous described. Operations 428, 430 and 432 are described in greater detail in method 600, as illustrated in FIG. 6A and method 630, as illustrated in FIG. 6B.

Returning to FIG. 4A, at decision operation 432, the SMM scans the FOB information 182 to identify whether a FOB is “linked” with the SMCU 104. For example, the SMM 170 may identify whether one or more FOBCUs 110 are linked with the SMCU 104 by identifying whether at least one FOB is registered in the FOB information 182. Also for example, the SMM 170 may identify that no rows are registered in the FOB information 182. If no FOBs are registered in the FOB information 182 then the SMM 170 branches to operation 436 to cause a no FOB alert. Otherwise, processing continues via off-page connector 434 (“A”) that connects to off-page connector 434 (“A”) on FIG. 4B. At operation 436, the SMM 170 activates a no FOB alert. For example, the SMM 170 may produce an audible alert indicating no FOBs are linked.

Off page connectors are described. Entering the method 400 from off-page connector 438 (“B”), the SMM 170 continues processing at operation 410. The off-page connector 438 (“B”) on FIG. 4A is connected to off-page connector 438 (“B”) on FIG. 4B. Entering the method 400 from off-page connector 440 (“C”), the SMM 170 continues processing at operation 402. The off-page connector 440 (“C”) on FIG. 4A is connected to off-page connector 440 (“C”) on FIG. 4B.

FIG. 4B is a diagram illustrating the method 400, according to an embodiment. The method 400 illustrated on FIG. 4B is a continuation of the method 400 that is illustrated on FIG. 4A. The method 400 commences at off-page connector 434 on FIG. 4B which connects with off-page connector 434 on FIG. 4A.

At decision operation 450, the SMM 170 identifies whether any of the seats that are registered as occupied are also registered with a seat belt being unbuckled. If the SMM 170 identifies that any of the seats that are registered as occupied are also registered with a seat belt being unbuckled, then processing continues at operation 452. Otherwise, processing continues at operation 456.

At operation 454, the SMM 170 may receive an indication that the initialize button 162 on the SMCU 104 was pushed. For example, pressing the initialize button 162 on the SMCU 104 may cause an interrupt that is serviced by the SMM 170 that, in turn, stores a status indicating the initialize button 162 was pushed in the system monitor information storage 174.

At decision operation 456, the SMM 170 identifies whether the initialize button 162 was pushed. For example, the SMM 170 may identify whether the status in system monitor information storage 174 indicates the initialize button 162 was pushed. If the SMM 170 identifies the initialize button 162 was pushed then processing continues at operation 457, Otherwise, processing continues at decision operation 458.

At decision operation 458, the SMM 170 identifies whether the temperature is OK. For example, SMM 170 may compare the temperature being sensed by the temperature sensor 172 on the SMCU 104 with a predetermined threshold to identify whether the temperature exceeds a predetermined threshold. If the SMM 170 identifies the temperature as exceeding a threshold (e.g., temperature not OK), then processing continues at decision operation 460. Otherwise, processing continues at operation 450.

At operation 460, the SMM 170 communicates a “temperature alert” to all FOBs that are linked to the SMCU 104 (see method 550, FIG. 5B) and to private emergency responders. The SMM 170 may communicate the “temperature alert” to a FOBCU 110 responsive to identifying the FOB as being linked to the SMCU 104 in the FOB information 182. In addition, the SMM 170 communicates the “temperature alert” to the to the ERCU 126 that, in turn, communicates the “temperature alert to the call center server 138 that, in turn, communicates the “temperature alert to private emergency responders. For example, the call center server 138 may utilize the telephone number information 153 to communicate telephone calls/text messaging to private emergency responders. Further for example, the call center server 138 may utilize the email address information 154 to send emails including a request for an emergency response from private emergency responders. The request may include geographic coordinates identifying the location of the vehicle 102, an indication of the temperature alert, the temperature of the vehicle 102, and the type of seat(s) (e.g., child, booster, etc.) that are occupied.

At operation 462, the SMM 170 may wait for a predetermined period of time. For example, the SMM 170 may wait for 30 seconds.

At decision operation 464, the SMM 170 identifies whether a “temperature exposure alert” should be asserted. For example, the SMM 170 may 1) compute a rate of temperature change based on sensing the temperature during the wait period, and 2) compare the computed rate of temperature change with a predetermined threshold to identify whether a “temperature exposure alert” should be asserted. Further for example, the SMM 170 may compute whether an exposure to a range of temperatures during the wait time exceeds a predetermined threshold to identify whether a “temperature exposure alert” should be asserted. Other embodiments may utilize a time period that is different from the wait time. If the SMM 170 identifies a “temperature exposure alert” should be asserted, then a branch is made to operation 466. Otherwise, processing continues at decision operation 468.

At operation 466, the SMM 170 broadcasts a “temperature exposure alert” to linked and non-linked FOBCUs 110. For example, the SMM 170 broadcasts the “temperature exposure alert” to FOBCUs 110 that are linked to the SMCU 104 and to FOBCUs 110 that are not linked to the SMCU 104 (see method 580, FIG. 5C). In addition, the SMM 170 may broadcast the “temperature exposure alert” by utilizing a maximum power to reach additional FOBCUs 110.

At operation 470, the SMM 170 communicates the “temperature exposure alert” to the VDCU 122, CECU 124 and ERCU 126. The ERCU 126 communicates the “temperature exposure alert” to the call center server 138 that, in turn, communicates the “temperature exposure alert” to public emergency responders, including “911” services, other emergency responders, and the like. The CECU 124 may cause the horn to honk, the headlights to flash, and the like responsive to receiving the “temperature exposure alert.” The VDCU 122 may cause a scrolling display message (e.g., “Please rescue child in car seat from excessive temperature”) to be displayed on the scrolling display unit 334 responsive to receiving the “temperature exposure alert” and a strobing to commence on the visual display unit 336 responsive to receiving the “temperature exposure alert.” The SMM 170 may further send a message including a request to the ERCU 126 that, in turn, communicates the message to the call center server 138 that, in turn, communicates the message to public emergency services including“911” services, fire services, police servers, etc. The request may be an emergency responder to come to the vehicle 102. The request may further include geographic coordinates identifying the location of the vehicle 102, an indication of the temperature alert, the temperature of the vehicle 102, and the type of seat(s) (e.g., child, booster, etc.) that are occupied.

At decision operation 468, the SMM 170 identifies whether a FOBCU 110 is near. For example, the SMM 170 may compare FOB distances 194 in the FOB information 182 with a predetermined threshold and identifies a FOBCU 110 as being near if the FOB distance 194 for at least one FOBCU 110 is less than a “second distance” (e.g., associated with the “second distance alert”). If the SMM 170 identifies a FOBCU 110 is near, then a branch is made to decision operation 472. Otherwise processing continues at operation 466 via the on-page connector (“Z”).

At decision operation 472, the SMM 170 identifies whether the initialize button 162 was pushed. If the SMM 170 identifies the initialize button 162 was pushed then processing continues, via on-page connecter (“Y”) at decision operation 478. Otherwise, processing continues at operation 462.

At operation 452, the SMM 170 activates the “belt unbuckled alert.” For example, the SMM 170 may cause the SMCU 104 to emit an audible alert responsive that signals a “belt unbuckled alert.”

At decision operation 455, the SMM 170 identifies whether the initialize button 162 was pushed. If the SMM 170 identifies the initialize button 162 was pushed, then processing continues at operation 457. Otherwise, processing continues at operation 452.

At operation 457, the SMM 170 deactivates the “belt unbuckled alert.” For example, the SMM 170 may cause the deactivation of an audible alert that signifies the “belt unbuckled alert.”

At decision operation 478, the SMM 170 identifies whether at least one occupant is sensed. For example, the SMM 170 may identify whether at least one BSCU 116, PSCU 114, or CSCU 112, that is linked with the SMCU 104, is reporting an occupant as being present. If the SMM 170 identifies at least one occupant is sensed then a branch is made, via off-page connecter 438 (“B”), to operation 410. Otherwise, processing continues, via off-page connecter 440 (“C”), to operation 402.

FIG. 5A is a diagram illustrating a method 500, according to an embodiment, to safely transport passengers. The method 500 commences at decision operation 502, at a FOBCU 110, with the FOB module 280 waiting to receive a “Request to link” message from an SMM 170 (e.g., operation 428, FIG. 4A). If the FOB module 280 receives a “Request to link” message from an SMM 170, then the FOB module 280 updates the local FOB information 290 in the FOB information storage 282 of the FOBCU 110 based on the information in the message and branches to operation 504. Otherwise, the FOBCU 110 waits at decision operation 502 for a “Request to link” message. Operation 502 is described further in method on FIG. 6A.

At operation 504, the FOB module 280 performs a handshake with the SMCU 104. The FOB module 280 performs the handshake by waiting for an “Are you there?” message from the SMM 170. Responsive to receiving the “Are you there?” message, the FOB module 280 sends a FOB acknowledgement to the SMCU 104, as described further in method 630 of FIG. 6B.

At decision operation 506, the FOB module 280 identifies whether the FOBCU 110 is being placed in the standby mode by the SMM 170. If the FOB module 280 is being placed in the standby mode by the SMM 170 then a branch is made to “standby” state 508. Otherwise, processing continues at decision operation 516.

At decision operation 516, the FOB module 280 identifies whether its distance from the SMCU 104 is greater than a “first distance” that is predetermined (e.g., distance information 155). For example, the FOB module 280 may compare the SMCU distance 294 in the local FOB information 290 with a “first distance” that is predetermined (e.g., distance information 155). If the SMCU distance 294 is greater than a predetermined “first distance”, a branch is made to operation 518. Otherwise, processing continues at operation 520.

At operation 518, the FOB module 280 asserts a “first distance alert.” For example, FOB module 280 may cause the FOBCU 110 to generate a haptic alert that signals the “first distance alert.”

At operation 522, the FOB module 280 may receive an indication that the snooze button 272 on the FOBCU 110 was pushed. For example, pressing the snooze button 272 on the FOBCU 110 may cause an interrupt that is serviced by the FOB module 280 that, in turn, stores a status in the FOB information storage 282 indicating that the snooze button 272 was pushed.

At decision operation 523, the FOB module 280 may identify whether the snooze button 272 on the FOBCU 110 was pushed. For example, the FOB module 280 may read a status in the FOB information storage 282 indicating whether the snooze button 272 was pushed. If the FOB module 280 identifies the snooze button 272 on the FOBCU 110 was pushed, then a branch is made to decision operation 524. Otherwise, a branch is made to decision operation 526.

At decision operation 526, the FOB module 280 identifies whether its distance from the SMCU 104 is greater than a “second distance” that is predetermined (e.g., distance information 155). For example, the FOB module 280 may compare the SMCU distance 294 in the local FOB information 290 with a “second distance” that is predetermined. If the SMCU distance 294 is greater than the “second distance” that is predetermined, a branch is made to operation 528. Otherwise, processing continues at operation 530.

At operation 528, the FOB module 280 asserts a “second distance alert.” For example, FOB module 280 may cause the FOBCU 110 to generate a haptic alert that signals the “second distance alert.”

At operation 512, the FOB module 280 may receive an indication that the standby button 270 on the FOBCU 110 was pushed. For example, pressing the standby button 270 on the FOBCU 110 may cause an interrupt that is serviced by the FOB module 280 that, in turn, stores a status in the FOB information storage 282 indicating that the standby button 270 was pushed. At operation 514, the FOB module 280 sends a “going to standby” message to the SMM 170 indicating that the FOBCU 110 is going to the “standby” state and, at operation 508, the FOB enters the standby state.

At operation 530, the FOB module 280 deactivates the “second distance alert.” For example, the FOB module 280 may cause a haptic alert that signifies the “second distance alert” to cease. At decision operation 524, the FOB module 280 identifies whether the snooze button 272 on the FOBCU 110 was pressed three or more times. If the snooze button 272 was pressed three or more times, then a branch is made to decision operation 526. Otherwise, a branch is made operation 532. At operation 532, the FOB module 280 deactivates the “first distance alert.” For example, the FOB module 280 may cause the FOBCU 110 to cease generating a haptic alert signifying a “first distance alert.” At operation 534, the FOB module 280 waits for a predetermined period of time. For example, the FOB module 280 may wait for 500 milliseconds.

FIG. 5B is a diagram illustrating a method 550, according to an embodiment, to process a temperature alert. The method commences at operation 552, at the FOBCU 110, with the FOB module 280 receiving a message from the SMM 170 indicating a “temperature alert” was asserted by the SMM 170.

At decision operation 554, the FOB module 280 identifies whether it is linked to the SMCU 104 that communicated the message indicating the “temperature alert.” For example, the FOB module 280 may compare the SMCU identifier 151 in the message with the SMCU identifier 151 in the local FOB information 290 to identify a match, signifying the FOBCU 110 is linked to the SMCU 104. If the FOB module 280 identifies it is linked to the SMCU 104 then a branch is made to operation 556. Otherwise, processing ends.

At operation 556, the FOB module 280 asserts a “temperature alert.” For example, FOB module 280 may cause the FOBCU 110 to generate a haptic alert that signals the “temperature alert.”

FIG. 5C is a diagram illustrating a method 580, according to an embodiment, to process a “temperature exposure alert.” The method commences at operation 582, at the FOBCU 110, with the FOB module 280 receiving a message from the SMM 170 indicating a “temperature exposure alert” was asserted by the SMM 170.

At decision operation 584, the FOB module 280 identifies whether it is linked to the SMCU 104. For example, the FOB module 280 may compare the SMCU identifier 151 in the message indicating the “temperature exposure alert” with the SMCU identifier 151 in the local FOB information 290 to identify a match, signifying the FOBCU 110 is linked to the SMCU 104. If the FOB module 280 identifies it is linked to the SMCU 104, then a branch is made to operation 586. Otherwise, processing continues at decision operation 588.

At operation 586, the FOB module 280 asserts a “temperature exposure alert.” For example, FOB module 280 may cause the FOBCU 110 to generate a haptic alert that signals the “temperature exposure alert.”

At decision operation 588, the FOB module 280 identifies whether it is held by a community helper. For example, a user may designate themselves as a community helper by indicating “YES” to a prompt for “COMMUNITY HELPER” in the user interface 159. If the FOB module 280 identifies it is held by a community helper, then a branch is made to operation 590. Otherwise, processing ends.

At operation 590, the FOB module 280 asserts a community helper alert. For example, FOB module 280 may cause the FOBCU 110 to generate a haptic alert that signals a “community helper alert.”

FIG. 6A is a swim flow diagram illustrating a method 600 to link a FOB, according to an embodiment. The method 600 describes a system monitor control unit (SMCU) 104 linking with a FOBCU 110. Illustrated on the left are operations performed by an SMM 170 and illustrated on the right are operations performed by a FOB module 280. The method 600 commences on the left, at operation 602, with the SMM 170 broadcasting a “Request to link” message over the network 106 (e.g., wireless).

At operation 604, at a FOBCU 110, the FOB module 280 receives the message and at decision operation 606 the FOB module 280 identifies whether it is linked with the SMCU 104 that broadcasted the “request for link” message. For example, the FOB module 280 may identify whether an SMCU identifier 151 in the “Request to link” message matches an SMCU identifier 151 in the local FOB information 290 in the FOB information storage 282. If the FOB module 280 identifies a match, then processing ends. Otherwise, processing continues at operation 608.

At operation 608, the FOB module 280 registers the link with the SMCU 104 in the local FOB information 290 at the FOBCU 110 by populating the local FOB information 290. For example, the FOB module 280 may write an SMCU identifier 151, an SMCU distance 294, and a local FOB status 296 in the local fob information 290, as previously described.

At operation 610, the FOB module 280 communicates a “FOB Acknowledgment” message to the SMCU 104 that communicated the “Request to link” message.

At operation 616, at the SMCU 104, the SMM 170 receives the “FOB Acknowledgment.” At operation 614, the SMM 170 registers a link with the FOBCU 110 in the FOB information 182 by populating a row in the FOB information 182. For example, the SMM 170 may write an FOB identifier 192, a FOB distance 194, and a FOB status 196 in the row, as previously described.

FIG. 6B is a diagram illustrating a method 630, according to an embodiment, to handshake with a FOBCU 110. The method 630 describes a communication handshake between an SMM 170 and a FOB module 280. The system monitor control unit (SMCU) 104 is illustrated on the left and the FOBCU 110 is illustrated on the right. The method 630 commences on the left, at the FOBCU 110, at operation 632, with the SMM 170 communicating an “Are you there?” message over a network (e.g., wireless) to a FOBCU 110. The “Are you there?” message includes an SMCU identifier 151 that identifies the SMCU 104 that is communicating the message. The SMM 170 may communicate an “Are you there?” message to a particular FOBCU 110 responsive to identifying the FOBCU 110 in the FOB information 182 on the SMCU 104.

At operation 634, at the FOBCU 110, the FOB module 280 receives the “Are you there?” message and at decision operation 636 the FOB module 280 identifies whether the FOBCU 110 is linked with the SMCU 104 that communicated the message. For example, the FOB module 280 may read the local FOB information 290 in the FOB information storage 282 at the FOBCU 110 to identify the SMCU identifier 151 matches the SMCU identifier 151 in the message. If the FOB identifies a matching SMCU identifier 151 then a branch is made to operation 638. Otherwise processing ends.

At operation 638, the FOB communicates an “I am here” message to the SMCU 104. The “I am here” message includes a FOB identifier 192 that uniquely identifies the FOB that communicates the message.

At operation 640, at the SMCU 104, the SMM 170 receives the “I am here” message and at operation 642, the SMM 170 updates the row corresponding to the FOBCU 110 in the FOB information 182 in the system monitor information storage 174 on the SMCU 104. For example, the SMM 170 may write the FOB identifier 192, a FOB distance 194 and a FOB status 196 into the identified row, as previously described.

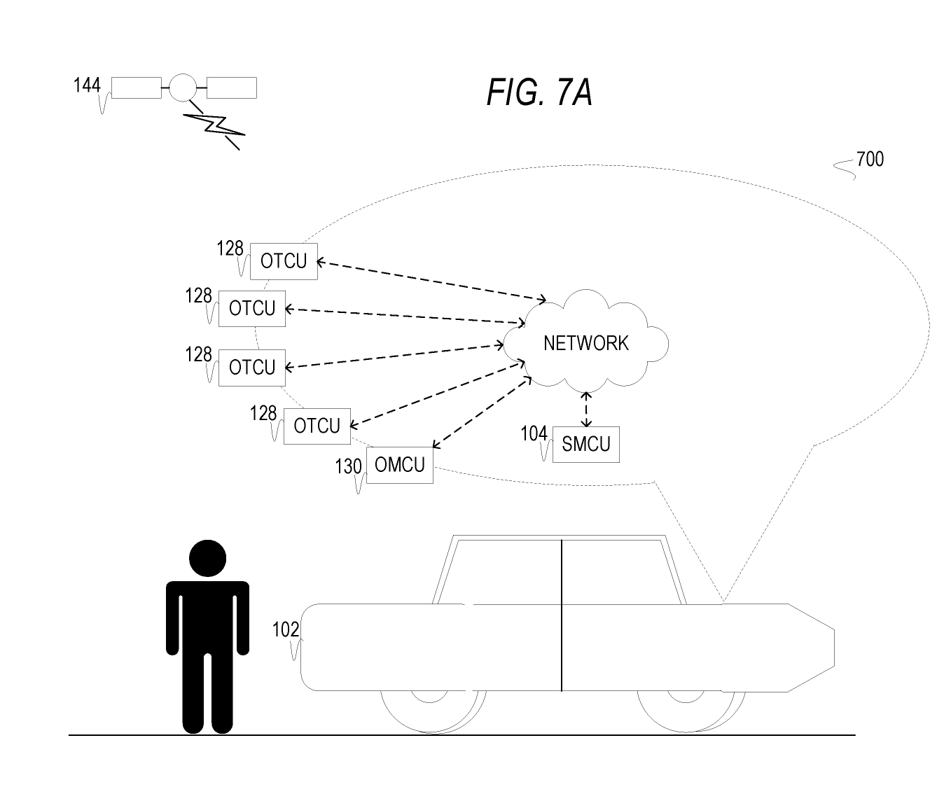

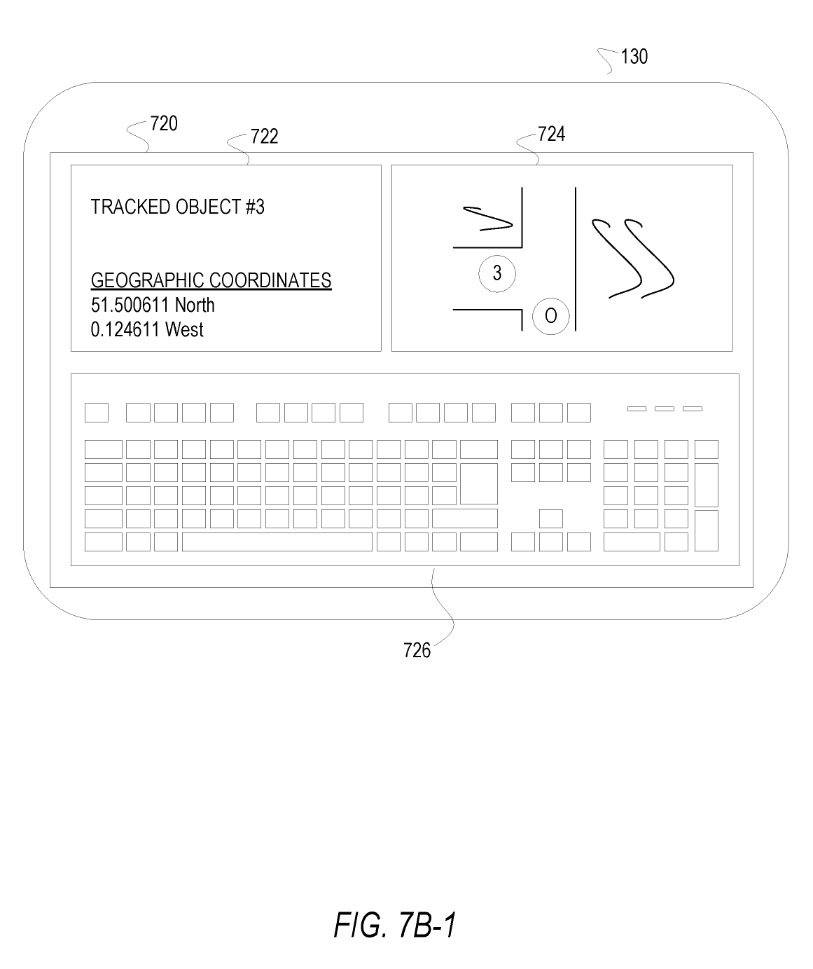

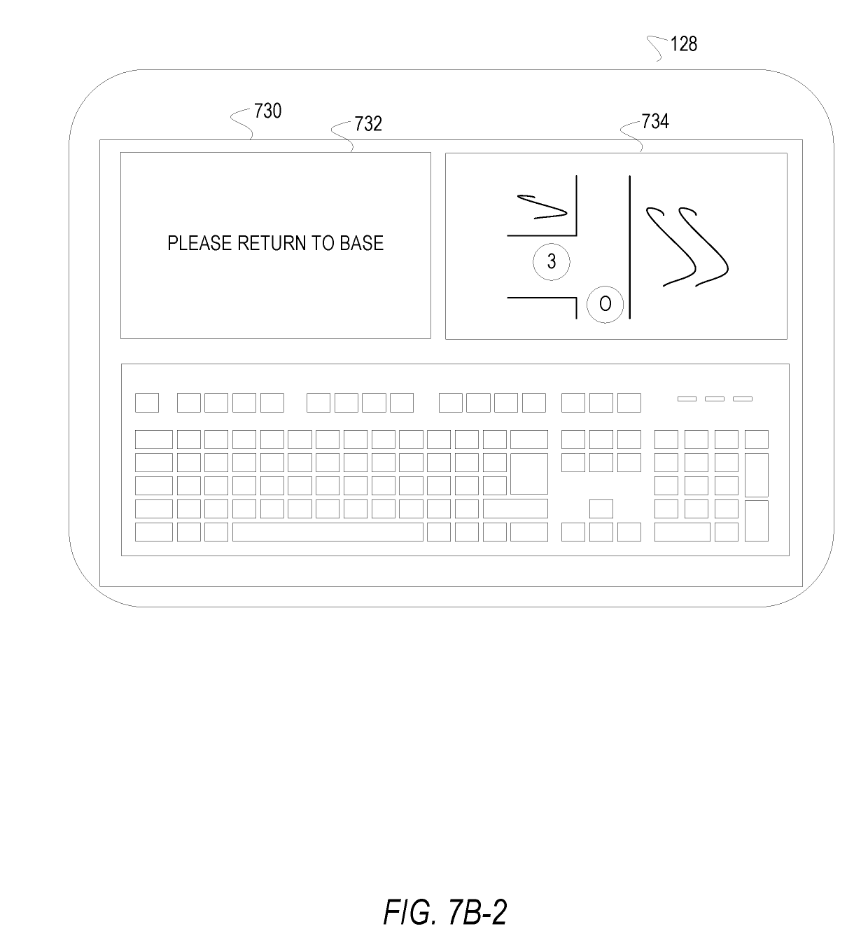

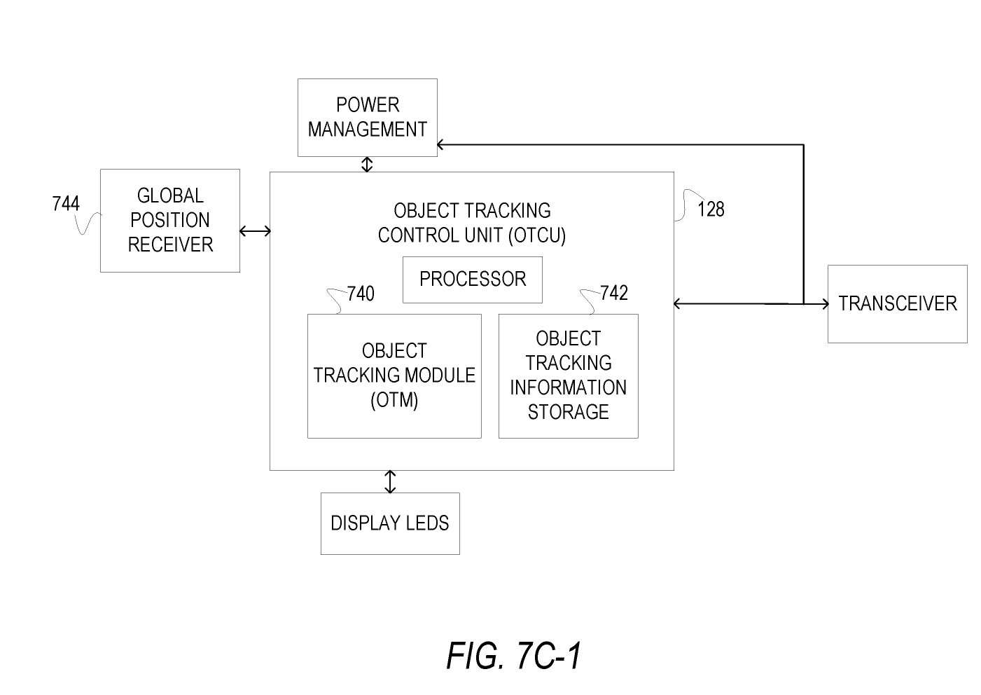

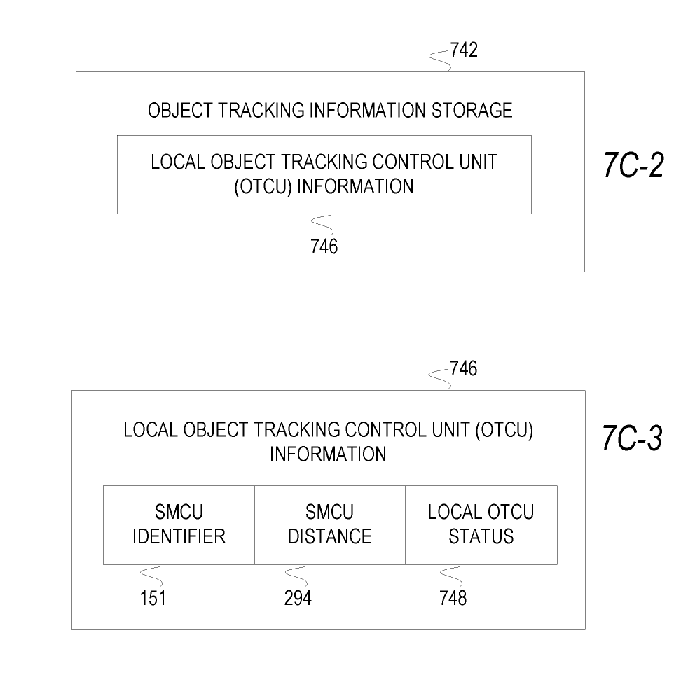

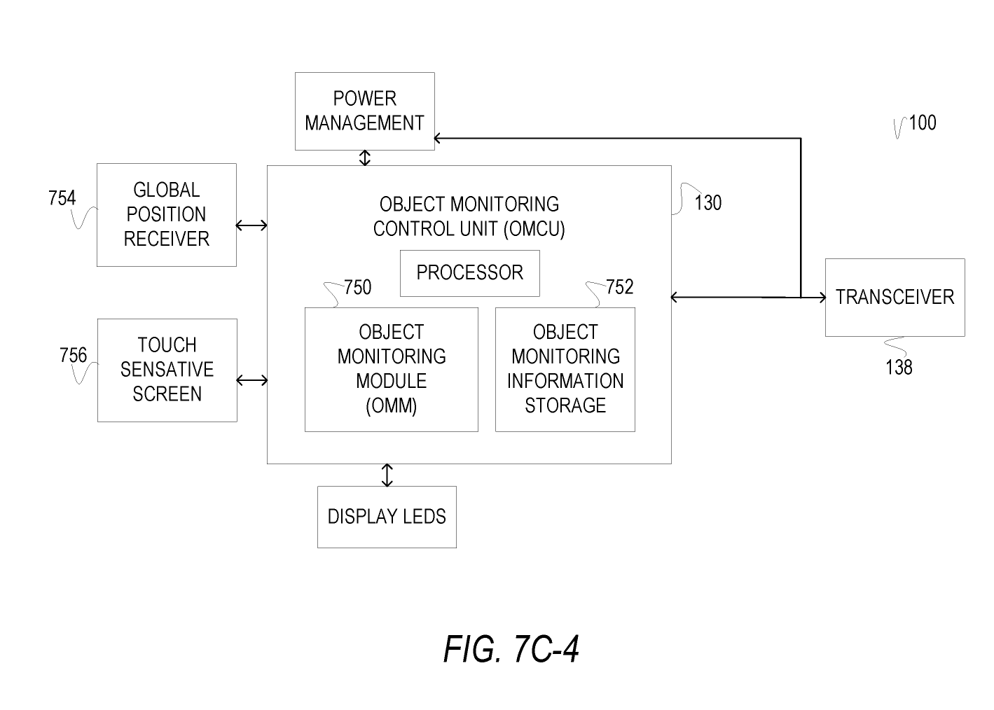

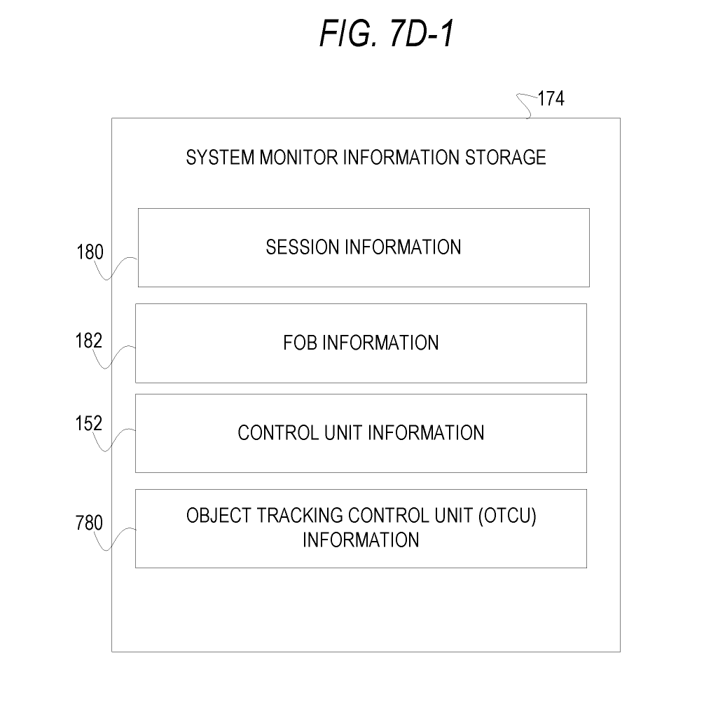

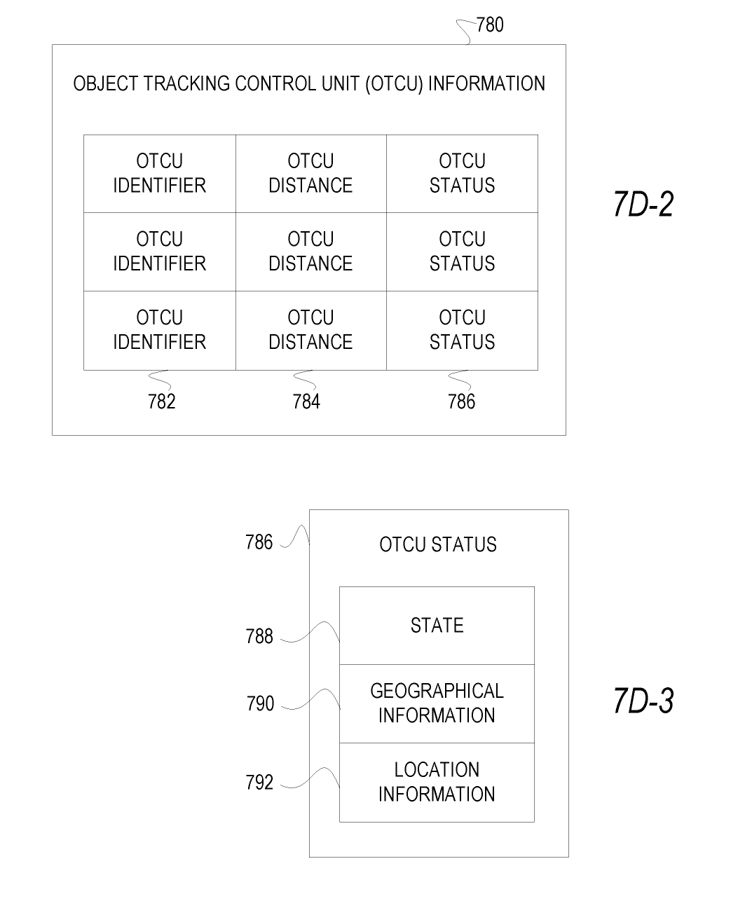

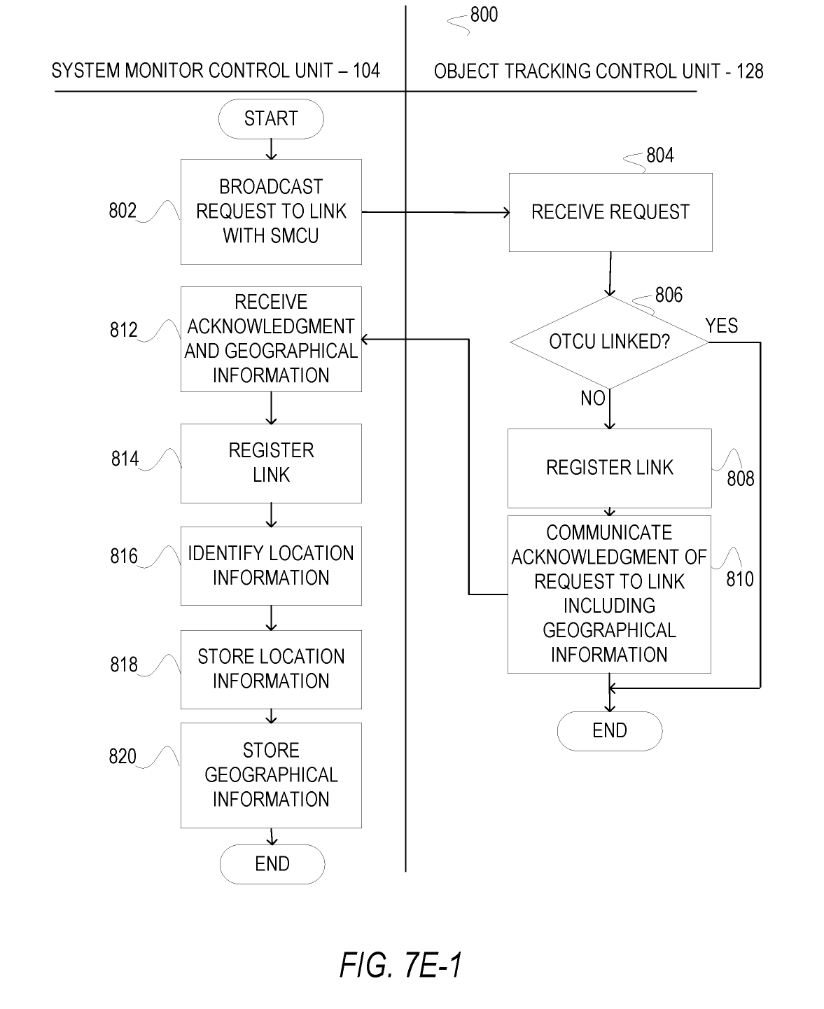

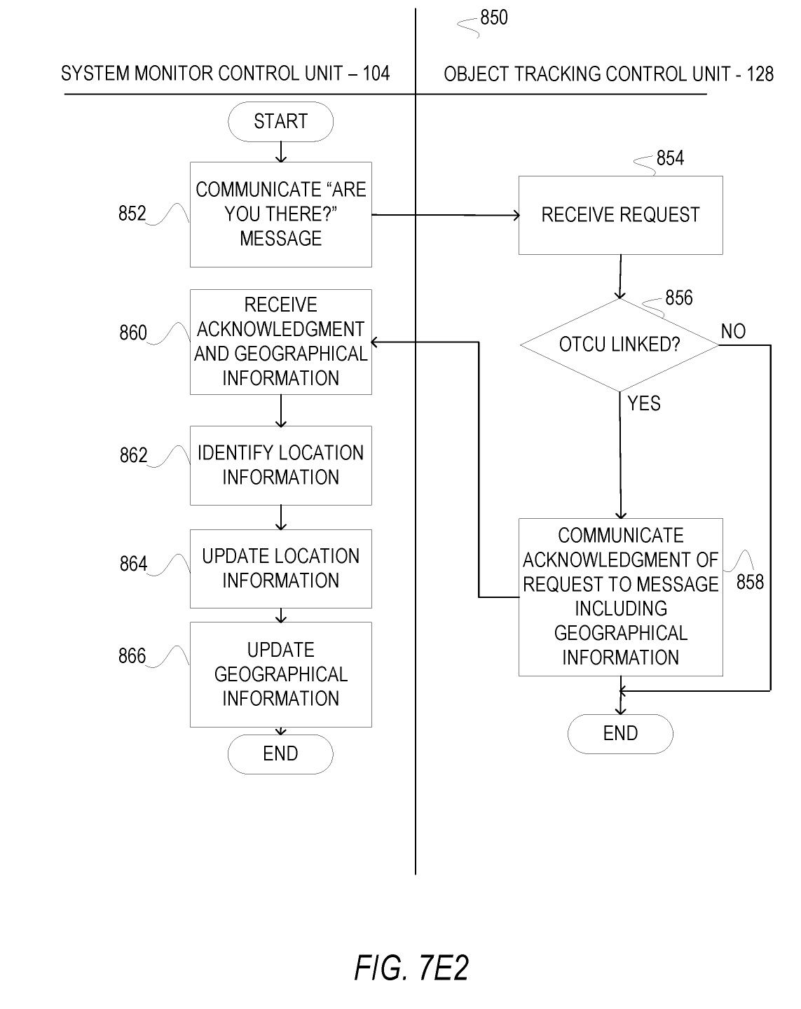

FIG. 7A is a diagram illustrating an object tracking system 700, according to an embodiment. The object tracking system 700 may be included in the system 100 to safely transport passengers. The object tracking system 700 includes object tracking control units (OTCU) 128 that may be associated with objects that move. To this end, the OTCU 128 may communicate, over the network 106 (e.g., wireless), with the system monitoring control unit (SMCU) 104 that, in turn, communicates the respective locations of the OTCU 128 (and other information), over the wireless network 106, to the object monitoring control unit (OMCU) 130. Each of the OTCUs 128 may be carried, attached, affixed, embedded, etc. to the object that is being tracked. For example, an OTCU 128 may be carried by an object that is self-propelled such as a person, a pet, a drone, etc. Further, for example, an OTCU 128 may be embedded in an object that may be moved such as a container (e.g., box) or the like. According to a first embodiment, the SMCU 104 may approximate the distance between the SMCU 104 and the OTCU 128 based on a signal strength that is measured by the SMCU 104. Further, the SMCU 104 may approximate whether the OTCU 128 is moving closer to the SMCU 104 or away from the SMCU 104 based on current signal strength that is being measured by the SMCU 104 and a previous signal strength that was measured by the SMCU 104. According to this embodiment, the OTCU 128 does not include a global position receiver. Accordingly, the first embodiment may be used to minimize a cost of the OTCU 128 thereby enabling ubiquitous implementation of the OTCU 128. According to a second embodiment, the OTCU 128 may include a global position receiver 744 that receives satellite information from one or more global position system satellites 144 and transmits the satellite information to the OTCU 128 that, in turn, communicates geographical information including the satellite information and other information to the SMCU 104. In one embodiment, the global position receiver 744 may further calculate its geographical location (e.g., geographic coordinates) based on the satellite information, and communicate the geographical location, as geographical information, to the OTCU 128. Further, the SMCU 104 supports messaging between the OTCUs 128 and the OMCU 130. For example, the operator of the OMCU 130 may broadcast a message such as, “Please return to base,” that is displayed on each of the displays of the OTCUs 128 or communicate a message to a particular OTCU 128. Conversely, an OTCU 128 may communicate messages to the OMCU 130. The SMCU 104 may operate in the capacity of the OMCU 130. For example, the SMCU 104 may support messaging with one or more OTCUs 128 and monitor the location of one or more OTCUs 128.

FIGS. 7B-1 is a diagram illustrating an object monitoring control unit (OMCU) 130, according to an embodiment. The OMCU 130 may include a touch sensitive screen 720 for displaying and receiving information. The touch sensitive screen 720 may include a left panel 722, a right panel 724 and a keyboard 726. The left panel 722 and the right panel 724 may display information describing an OTCU 128 (e.g., “tracked object”) that is being tracked (e.g., #3). For example, the left panel 722 may display a title of the “tracked object” and geographic coordinates describing the location of the “tracked object.” The right panel 724 may display a map that presents the location of the “tracked object” (e.g., “3” indicating the tracked object #3) and the location of the OMCU 130 (e.g., “O” indicating the OMCU 130). The keyboard 726 may be used to receive input. In another example, the touch sensitive screen 720 may track all OTCUs 128 that are linked with the SMCU 104. FIGS. 2A-1 illustrates an example of the SMCU 104 operating in the capacity of the OMCU 130. For example, the SMCU 104 is shown as displaying location information received from an OTCU 128 (e.g., “TRACKED OBJECT #3”).

FIGS. 7B-2 is a diagram illustrating an object tracking control unit (OTCU) 128, according to an embodiment. The OTCU 128 may be carried in a pocket, clipped to a surface, placed in a box, etc. The OTCU 128 may include a touch sensitive screen 730 for displaying and receiving information. For example, the touch sensitive screen 730 is illustrated as displaying a left panel 732 and a right panel 734. The left panel 732 may include a message that was broadcasted by the OMCU 130 (e.g., “RETURN TO BASE”) to the OTCUs 128. The right panel 734 may include a map that presents the location of the “tracked object” (e.g., “3” indicating the tracked object #3) and the location of the OMCU 130 (e.g., “O” indicating the OMCU 130). Other embodiments may not include the touch sensitive screen 730 or other components utilized for communication with a holder of OTCU 128.

FIGS. 7C-1 is a diagram illustrating an object tracking control unit (OTCU) 128, according to an embodiment. The OTCU 128 may include a processor, an object tracking module (OTM) 740, that executes instructions utilizing the processor, and object tracking information storage 742 that is utilized by the OTM 740 to store and retrieving information. The OTCU 128 may operate to communicate with other system units (e.g., SMCU 104) and to communicate with component elements that are communicatively coupled to the OTCU 128. The component elements that are coupled to the OTCU 128 may include a power management (e.g., battery) component element, a network interface device (e.g., transceiver (e.g., wireless, radio)) for communicating with other system units or devices, display LEDs, and a global position receiver 744 that is optional. The object tracking information storage 742 may be used by the OTM 740 to store and retrieve tables and other software constructs. The global position receiver 744 may receive satellite information from one or more global position system satellites 144 and transmit the satellite information and other information to the OTCU 128. In one embodiment, the global position receiver 744 may calculate its geographical location (e.g., geographic coordinates) based on the satellite information, and further communicate the geographical location to the OTCU 128.

FIGS. 7C-2 is a diagram illustrating object tracking information storage 742, according to an embodiment. The object tracking information storage 742 may store local object tracking control unit (OTCU) information 746. The object tracking information storage 742 may be generated and maintained/updated by the object tracking module (OTM) 740. For example, object tracking information storage 742 may be utilized by the object tracking module 740 to maintain status for the OTCU 128.

FIGS. 7C-3 is a diagram illustrating local object tracking control unit (OTCU) information 746, according to an embodiment. The OTCU 128 may utilize the local object tracking control unit (OTCU) information 746 to store a system monitor control unit (SMCU) identifier 151, a SMCU distance 294, and a local object tracking control unit (OTCU) status 748. The SMCU identifier 151 uniquely identifies the SMCU 104 and is received, as described above, in the “Request to link” message from the SMCU 104. The SMCU distance 294 is an estimate of the distance between the OTCU 128 and the SMCU 104. The SMCU distance 294 is estimated by the OTCU 128 based on the signal strength of the “Request to link” message that is being received at the OTCU 128. The transceiver that is coupled to the OTCU 128 may provide an indication of signal strength in conjunction with receipt of the “Request to link” message to enable the object tacking module (OTM) 740 to estimate the distance. For example, the transceiver that is coupled to the OTCU 128 may provide the indication of the signal strength to the OTCU 128 that, in turn, provides the indication of the signal strength to the OTM 740. A strong signal strength indicates a short distance between the SMCU 104 and the OTCU 128 and a weak signal strength indicates a long distance, as previously described. The local OTCU status 748 may be written by the OTCU 128 into the local OTCU information 746 and indicates the status of the OTCU 128. “Table E” describes the local OTCU status 748 at the OTCU 128.

TABLE E

| Status No. | Local OTCU Status |
|---|---|
| 1. | linked and communicating |
| 2. | linked and went to Standby |

Each local OTCU status 748 and corresponding SMCU distance 294 in the local object tracking control unit information 746 may be periodically updated by the object tracking module 740. For example, the local OTCU status 748 and an SMCU distance 294 for a row may be updated by the object tracking module 740 responsive to the object tracking module 740 receiving an “Are you there?” message from an SMCU 104. That is, an SMCU 104 may periodically broadcast an “Are you there?” message to the OTCU 128 that may be received by the OTCU 128 and processed by the object tracking module 740 which responds by communicating a OTCU acknowledgment to the SMM 170 (e.g., handshake) and further by updating the SMCU distance 294 and the local OTCU status 748 in the local object tracking control unit information 746, as described above. Accordingly, the object tracking module 740 may utilize the local object tracking control unit information 746 in conjunction with periodic receipt of “Are you there?” messages to maintain an accurate SMCU distance 294 and local OTCU status 748 for the OTCU 128 that is linked/registered in the local object tracking control unit information 746.

FIGS. 7C-4 is a diagram illustrating an object monitoring control unit (OMCU 130), according to an embodiment. The OMCU 130 may include a processor, an object monitoring module (OMM) 750, that executes instructions utilizing the processor, and object monitoring information storage 752 for storing and retrieving information. The OMCU 130 may communicate with other system units (e.g., SMCU 104) and with component elements that are communicatively coupled to the OMCU 130. The component elements coupled to the OMCU 130 may include a power management (e.g., battery) component element, a network interface device (e.g., transceiver (e.g., wireless, radio)) for communicating with other system units or devices, display LEDs, a global position receiver 754, that is optional, and a touch sensitive screen 756 for receiving input. According to a second embodiment, the global position receiver 754 may receive satellite information from one or more global position system satellites 144 and transmit the satellite information and other information to the OMCU 130. In one embodiment, the global position receiver 754 may calculate its geographical location (e.g., geographic coordinates) based on the satellite information and further communicate the geographical location to the OMCU 130.

FIGS. 7D-1 is a diagram illustrating system monitor information storage 174, according to an embodiment. The system monitor information storage 174 is stored at the SMCU 104. The system monitor information storage 174 may include the session information 180, the FOB information 182, the control unit information 152, and object tracking control unit (OTCU) information 780. The session information 180, the FOB information 182, and the control unit information 152 were previously described. The object tracking control unit information 780 is described below.

FIGS. 7D-2 is a diagram illustrating object tracking control unit (OTCU) information 780, according to an embodiment. The object tracking control unit information 780 is maintained by the system monitor module (SMM) 170 and stored at the system monitor control unit (SMCU) 104 in the system monitor information storage 174. The OTCU information 780 may include a row for each OTCU 128 that is “linked” with the SMCU 104. Accordingly, an OTCU 128 that is registered in the OTCU information 780 is designated as “linked” with the SMCU 104. Each row of the OTCU information 780 may include an OTCU identifier 782, an OTCU distance 784, and an OTCU status 786, as described below.

### SMCU—Link Protocol—Object Tracking Control Unit

The SMM 170 may “link” to an OTCU 128 by broadcasting a “Request to link” message. OTCUs 128 located inside the network perimeter 108 may respond to the “Request to link” message with a OTCU acknowledgment including a system unit identifier 150 in the form of a OTCU identifier 782. OTCUs 128 located outside the network perimeter 108 may not respond to the “Request to link” message as the OTCU 128 may not receive the “Request to link” message. Whether or not the OTCU 128 responds to the “Request to link” message may be determined by a signal strength that is utilized by the SMCU 104 to broadcast the “Request to link” message. In some instances, the SMCU 104 may increase the radius of the network perimeter 108 by increasing the signal strength for communicating messages.

The SMM 170 may receive the OTCU acknowledgement and update the row in the object tracking control unit (OTCU) information 780 responsive to identifying the particular OTCU 128 as not being previously registered in the OTCU information 780. The SMM 170 may store the OTCU identifier 782, the OTCU distance 784, and the OTCU status 786. The OTCU identifier 782 is included in the OTCU acknowledgement and uniquely identifies the OTCU 128 from other system units. The OTCU distance 784 is an estimate of the distance between the SMCU 104 and the OTCU 128. The OTCU distance 784 may be estimated by the SMM 170 based on the signal strength of the OTCU acknowledgment that is being received from the particular OTCU 128. The SMCU 104 provides an indication of signal strength in conjunction with receipt of the OTCU acknowledgement that is received by the SMM 170 to enable the system monitor module 170 to estimate the distance. For example, the transceiver that is coupled to the SMCU 104 may provide the indication of the signal strength to the SMCU 104 that, in turn, provides the indication of the signal strength to the SMM 170. A strong signal strength indicates a short distance between the SMCU 104 and the OTCU 128 and a weak signal strength indicates a long distance, as was previously described. The OTCU status 786 is described below.

FIGS. 7D-3 is a diagram illustrating an object tracking control unit status 786, according to an embodiment. The object tracking control unit status 786 may include a state 788, geographical information 790, and location information 792. The state 788 describes the state of the OTCU 128. “Table F” describes the OTCU states 788 at the SMCU 104.

TABLE F

| Status No. | LOCAL OTCU STATUS 748 |
|---|---|
| 1. | STANDBY |
| 2. | LINKED and communicating |

The geographical information 790 may be used to store geographical coordinates and/or other information describing the location of the OTCU 128. The geographical information 790 be appended by the OTCU 128 to the OTCU acknowledgment to the “Request to link” message. Responsive to receipt of the OTCU acknowledgment to the “Request to link” message at the SMCU 104, the SMM 170 copies the geographical information 790 from the OTCU acknowledgment into the geographical information 790 in the OTCU status 786 of the appropriate row in the OTCU information 780.

The location information 792 may store a distance between the OTCU 128 and the SMCU 104, an indication whether the OTCU 128 is moving towards the SMCU or away from the SMCU 104, a current signal strength measurement, and a previous signal strength measurement (e.g., signal strength information). For example, the signal strength information may be obtained from the transceiver on the SMCU 104 in association with the receipt of a particular message.

### SMU—Handshake Protocol—OTCU 128

The SMM 170 may periodically communicate an “Are you there?” message to an OTCU 128 responsive to the SMM identifying the OTCU 128 as being registered in the OTCU information 780. At the OTCU 128, the OTCU 128 receives and responds to the “Are you there?” message by communicating an OTCU acknowledgment to the SMCU 104. Receipt of the OTCU acknowledgement, at the SMCU 104, indicates the OTCU 128 is “linked” and communicating. The SMM 170 further utilizes the strength of the OTCU acknowledgment (e.g., “I am here” message) to update the OTCU distance 784 in the OTCU information 780, as described above. The geographical information 790 may be appended by the OTCU 128 to the OTCU acknowledgment to the “Are you there?” message. Responsive to receipt of the OTCU acknowledgment to the “Are you there?” message, the SMM 170 updates the geographical information by copying the geographical information 790 from the OTCU acknowledgment into the geographical information 790 in the OTCU status 786 of the appropriate row in the OTCU information 780 at the SMCU 104.

FIGS. 7E-1 is a swim flow diagram illustrating a method 800 to link to an object tracking control unit 128, according to an embodiment. The method 800 describes a system monitor control unit (SMCU) 104 linking with an OTCU 128. Illustrated on the left are operations performed by an SMM 170 and illustrated on the right are operations performed by an object tracking module (OTM) 740. The method 800 commences on the left, at operation 802, with the SMM 170 broadcasting a “Request to link” message over the network 106 (e.g., wireless network).

At operation 804, at a OTCU 128, the OTM 740 receives the “Request to link” message and at decision operation 806 the OTM 740 identifies whether it is “linked” with the SMCU 104. For example, the OTM 740 may identify whether an SMCU identifier 151 in the “Request to link” message matches the SMCU identifier 151 in the local OTCU information 746 in the object tracking information storage 742 at the OTCU 128. If the OTM 740 identifies a match, then processing ends. Otherwise, processing continues at operation 808.

At operation 808, the OTM 740 registers the “link” with the SMCU 104 in the local OTCU information 746 at the OTCU 128 by populating the row in the local OTCU information 746. For example, the OTM 740 may write an SMCU identifier 151, an SMCU distance 294, and a local OTCU status 748 in the row, as previously described.

At operation 810, the OTM 740 communicates an OTCU acknowledgment message to the SMCU 104. The OTM 740 may append geographical information to the OTCU acknowledgment message responsive to identifying a global position receiver 744 on the OTCU 128 and retrieving geographical information from the global position receiver 744. For example, the geographical information may include geographic coordinates identifying the location of the OTCU 128 and other information.

At operation 812, at the SMCU 104, the SMM 170 receives the OTCU Acknowledgment message including the geographical information. At operation 814, the SMM 170 registers a “link” with the OTCU 128 in the object tracking control unit information 780 by populating a row in the object tracking control unit information 780. For example, the SMM 170 may write an OTCU identifier 782 that identifies the OTCU 128 that communicated the OTCU Acknowledgment message.

At operation 816 the SMM 170 identifies location information. For example, the SMM 170 may identify location information by obtaining a signal strength that is associated with the receipt of the OTCU acknowledgement message. For example, the transceiver that is coupled to the SMCU 104 may provide the indication of the signal strength to the SMCU 104 that, in turn, provides the indication of the signal strength to the SMM 170. A strong signal strength indicates a small distance between the SMCU 104 and the OTCU 128 and a weak signal strength indicates a long distance. For example, a received signal strength of “100%” may correspond to a distance of twenty-five feet; a received signal strength of “50%” may correspond to a distance of fifty feet; and the received signal strength of “25%” may correspond to a distance of one hundred feet. Other embodiments may utilize other schemes to associate a received signal strength with a distance. Further, the SMM 170 may compare the most recently obtained signal strength with the previously obtained signal strength to identify whether the object is moving closer to the SMCU 104 (signal strength increase) or away from the SMCU 104 (signal strength decrease). Accordingly, the location information may include a distance between the OTCU 128 and the SMCU 104, an indication whether the object is moving towards the SMCU 104 or away from the SMCU 104, a current signal strength measurement, and a previous signal strength measurement.

At operation 818, the SMM 170 stores the location information in the appropriate row of the object tracking control unit information 780. For example, the SMM 170 stores the distance between the OTCU 128 and the SMCU 104 in the OTCU distance 784 field. Further, for example, the SMM 170 stores an indication whether the object is moving towards the SMCU 104 or away from the SMCU 104, a current signal strength measurement, and a previous signal strength measurement in the location information 792 field of the object tracking control unit status 786 of the object tracking control unit information 780.

At operation 820, the SMM 170 copies the geographical information that is appended to the end of the OTCU acknowledgement message from the OTCU acknowledgement message into the geographical information 790 field of the object tracking control unit status 786 of the object tracking control unit information 780.

FIGS. 7E-2 is a diagram illustrating a method 850, according to an embodiment, to handshake with an OTCU 128. The method 850 describes a communication handshake between an SMM 170 and object tracking control unit (OTCU) 128. The system monitor control unit (SMCU) 104 is illustrated on the left and the OTCU 128 is illustrated on the right. The method 850 commences on the left, at the OTCU 128, at operation 852, with the SMM 170 communicating an “Are you there?” message over the network 106 (e.g., wireless) to an OTCU 128. The “Are you there?” message includes an SMCU 104 identifier 151 that identifies the SMCU 104 that is communicating the message. The SMM 170 communicates an “Are you there?” message responsive to identifying the OTCU 128 in the object tracking control unit information (OTCU) 746 on the SMCU 104.

At operation 854, at the OTCU 128, the object tracking module (OTM) 740 receives the “Are you there?” message and at decision operation 856 the OTM 740 identifies whether the OTCU 128 is “linked” with the SMCU 104 that communicated the message. For example, the OTM 740 may compare the SMCU identifier 151 in the local object tracking control unit information 746 in the object tracking information storage 742 at the OTCU 128 with the SMCU identifier 151 in the message to identify whether the two match. If the OTCU 128 identifies a matching SMCU identifier 151 then processing continues at operation 858. Otherwise processing ends.

At operation 858, the OTM 740 communicates the OTCU acknowledgment message to the SMCU 104. For example, the OTM 740 may communicate an “I am here” acknowledgment message to the SMCU 104. The “I am here” acknowledgment message includes an OTCU identifier 782 that uniquely identifies the OTCU 128 that communicates the message. Further, the OTM 740 may append geographical information to the OTCU acknowledgment message as described in operation 810 on FIGS. 7E-1.

At operation 860, the SMM 170 receives the “I am here” acknowledgment message from the OTCU 128. At operation 862, the SMM 170 identifies location information, as described in operation 816 on FIGS. 7E-1. Accordingly, the SMM 170 identifies location information in the form of a distance between the OTCU 128 and the SMCU 104, an indication whether the object is moving towards the SMCU or away from the SMCU 104, a current signal strength measurement, and a previous signal strength measurement responsive to the receipt of the acknowledgment to the “I am here” message. At operation 864, the SMM 170 updates the location information in the appropriate row of the object tracking control unit information 780, as described in operation 818 on FIGS. 7E-1. At operation 866, the SMM 170 updates the geographical information. For example, the SMM 170 may copy the geographical information that is appended to the end of the OTCU acknowledgement message to the “Are you there?” message into the geographical information 790 field of the object tracking control unit status 786 of the object tracking control unit information 780.

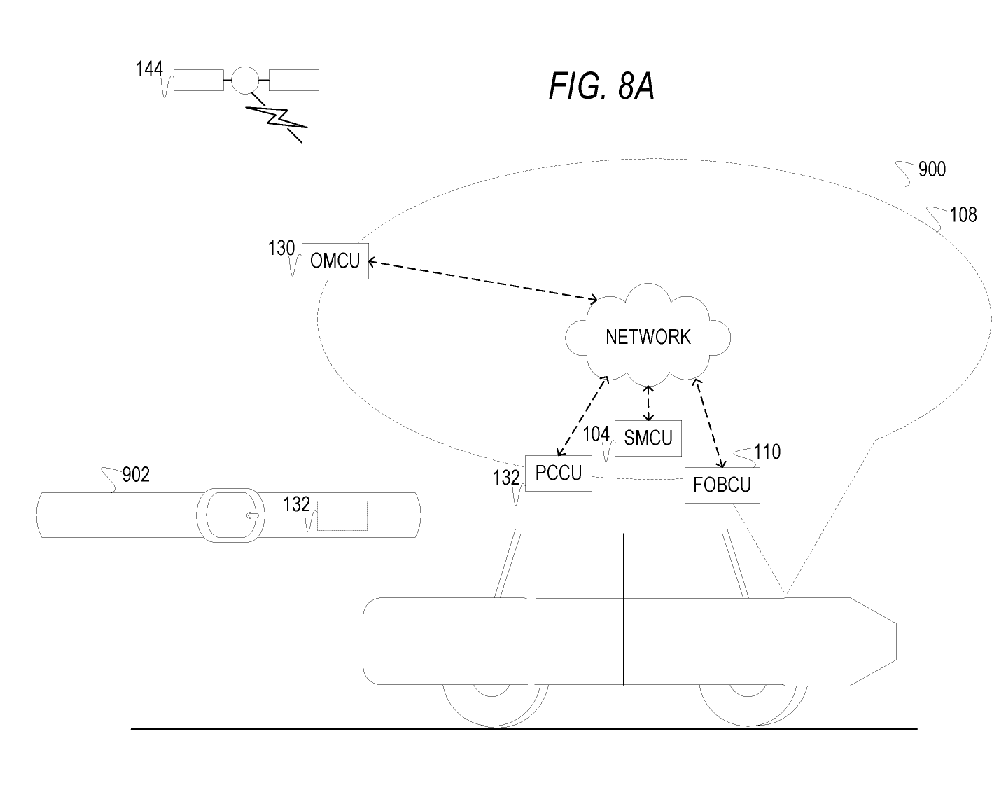

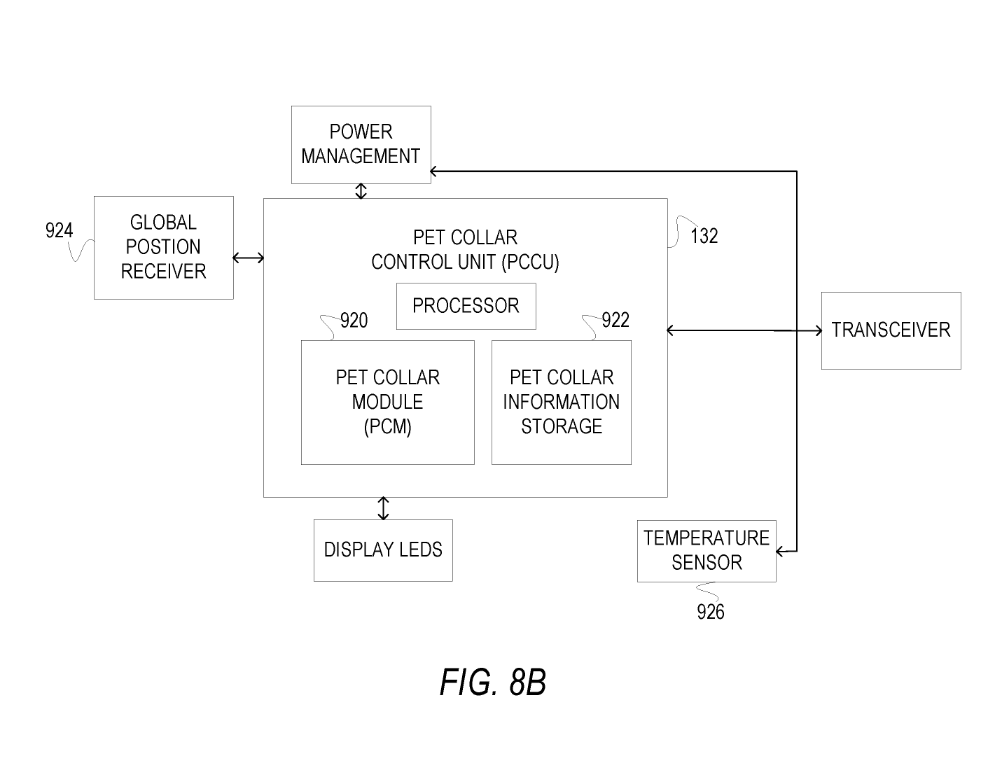

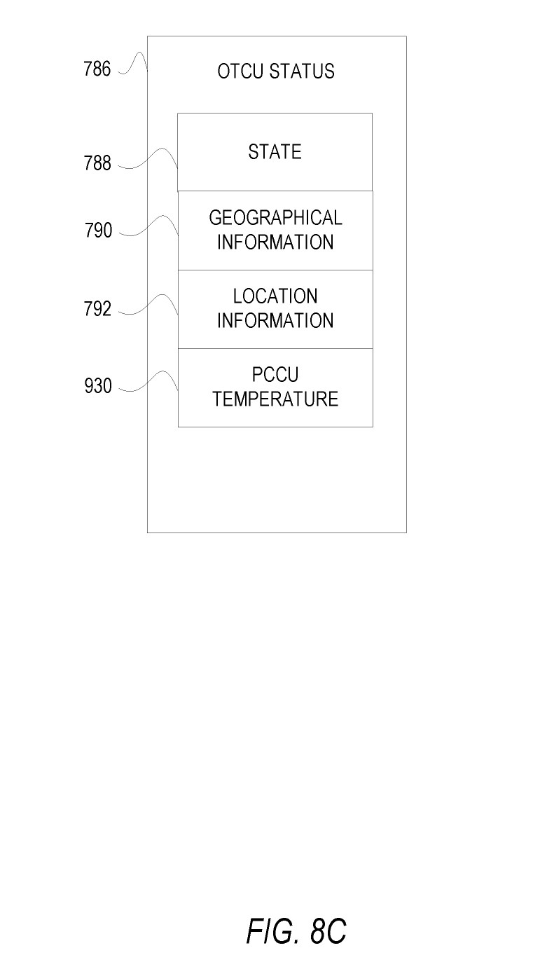

FIG. 8A is a diagram illustrating a pet collar system 900, according to an embodiment. The pet collar system 900 may be included in the object tracking system 700 that is further included in the system 100 to safely transport passengers. The pet collar system 900 includes a pet collar control unit 132 that is included in a pet collar 902 that is worn by a pet (e.g., dog, cat, etc.). The pet collar control unit 132 may be recognized by the object tracking system 700 as a type of object tracking control unit (OTCU) 128. Accordingly, the object tracking system 700 may track the location of the pet in the same manner as any other OTCU 128. To this end, the PCCU 132 may communicate, over the wireless network 106, with the system monitoring control unit (SMCU) 104 that, in turn, communicates the respective locations of the OTCU 128 (and other information), over the wireless network 106, to the object monitoring control unit (OMCU) 130. The PCCU 132 further includes a temperature sensor. The temperature sensor may be used to monitor the ambient temperature in the immediate location of the pet. The SMM 170 may receive the ambient temperature and assert pet temperature alert responsive to the identification of an unsafe temperature condition. For example, a temperature that exceeds a predetermined low or high threshold may cause a pet temperature alert. Further, a temperature rate of change that exceeds a predetermined threshold may cause a pet temperature alert. Further, a pet that is exposed to a temperature rate of change or a temperature for a period of time that exceeds a duration predetermined threshold may cause a pet temperature exposure alert. The alerts may be displayed and audibly alarmed on an OMCU 130. Further, responsive to detecting pet temperature alert, the SMCU 104 may communicate the alert to the FOBCU(s) 110 to prompt the holder of the FOB to return to the vehicle 102. Accordingly, the pet collar system 900 provides for the tracking of a pet based on a communication hub (e.g., SMCU 104) that is mobile and that reaches to the network perimeter 108 and for monitoring and alerting an unsafe temperature condition in the immediate location of the pet.

FIG. 8B is a diagram illustrating pet collar control unit (PCCU) 132, according to an embodiment. The PCCU 132 may include a processor, a pet collar module (PCM) 920, that executes instructions utilizing the processor, and pet collar information storage 922 that is utilized by the PCM 920 to store and retrieve information. The PCCU 132 may operate to communicate with other system units (e.g., SMCU 104) and to communicate with component elements that are communicatively coupled to the PCCU 132. The component elements that are coupled to the PCCU 132 may include a power management (e.g., battery) component element, a network interface device (e.g., transceiver (e.g., wireless, radio)) for communicating with other system units or devices, display LEDs, and a global position receiver 924 that is optional, and a temperature sensor 926. The pet collar information storage 922 may be used by the PCM 920 to store and retrieve tables and other software constructs. The global position receiver 744 may receive satellite information, as previously described in the context of other OTCUs 128. The temperature sensor 926 measures and reports the ambient temperature. The temperature sensor 926 is read by the PCM 920 responsive to the PCM 920 receiving a “Request to link” message or an “Are you there?” message.

At the PCCU 132, the PCM 920 may read an ambient temperature from the temperature sensor 926, append that ambient temperature to an acknowledgment to the “Request to link” message, and communicate the acknowledgment message to the SMCU 104 responsive to receipt of a “Request to link” message. In addition, the PCM 920 may read an ambient temperature from the temperature sensor 926, append that ambient temperature to an acknowledgment to the “I am here” message, and communicate the acknowledgment message to the SMCU 104 responsive to receipt of a “Are you there?” message.

FIG. 8C is a diagram illustrating an object tracking control unit status 786, according to an embodiment. The object tracking control unit status 786 may include the state 788, the geographical information 790, and the location information 792, and a pet collar control unit (PCCU) temperature 930. The SMM 170 may receive an PCCU temperature from the PCCU 132 responsive to communicating an “Request to link” message or an “Are you there?” message to the PCCU 132. The SMM 170 may receive the PCCU temperature in a “Request to link” acknowledgment message or in an “Are you there?” acknowledgement message. The SMM 170 stores the PCCU temperature that was received in the acknowledgment messages, as PCCU temperature, in the OTCU, status 786 responsive to receipt of the acknowledgment message to an “Request to link” message from the PCCU 132. In addition, the SMM 170 stores the ambient temperature, as PCCU temperature 930, in the OTCU status 786 responsive to receipt of the acknowledgment message to a “Request to link” message from the PCCU 132.

### Software Architecture

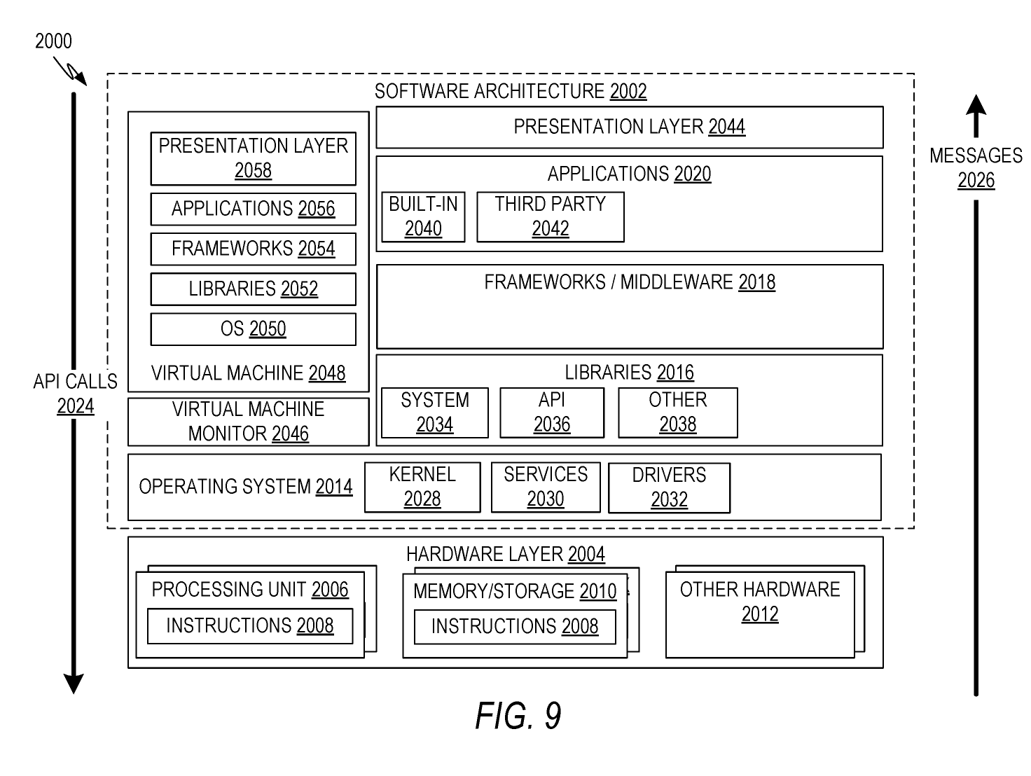

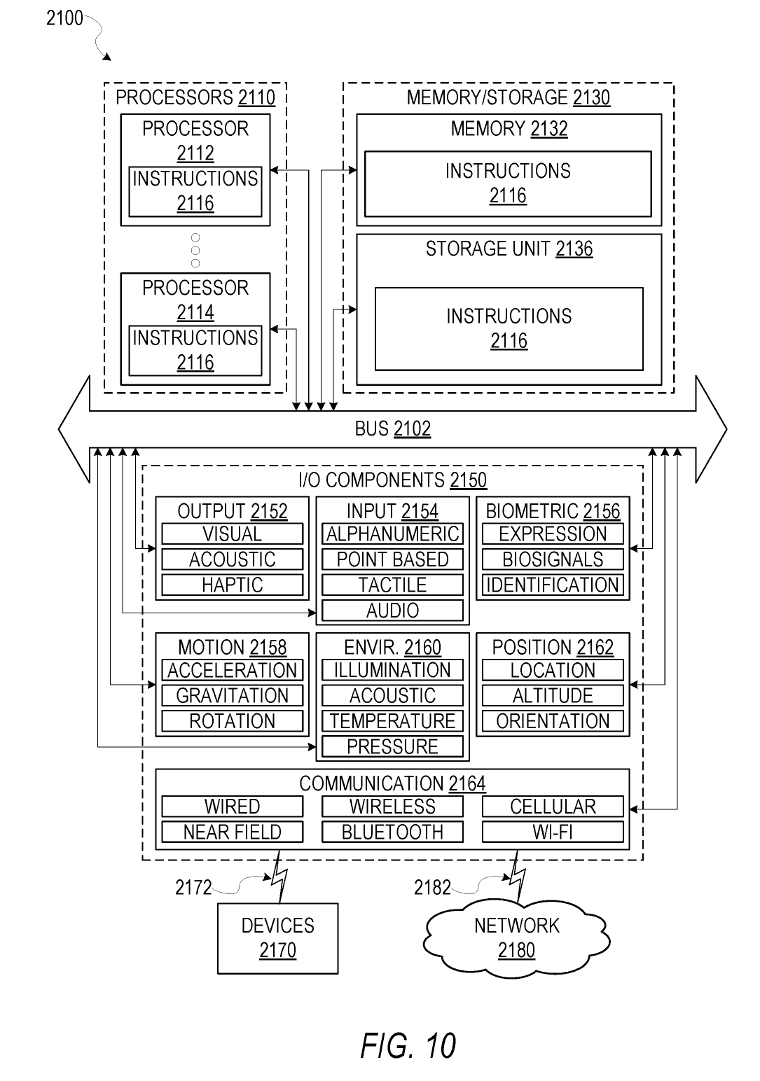

FIG. 9 is a block diagram 2000 illustrating a representative software architecture 2002, which may be used in conjunction with various hardware architectures herein described. FIG. 9 is merely a non-limiting example of a software architecture 2002 and it will be appreciated that many other architectures may be implemented to facilitate the functionality described herein. The software architecture 2002 may be executing on hardware such as machine 2100 of FIG. 10 that includes, among other things, processors 2110, memory 2130, and I/O components 2150. Returning to FIG. 9, a representative hardware layer 2004 is illustrated and can represent, for example, the machine 2100 of FIG. 10. The representative hardware layer 2004 comprises one or more processing units 2006 having associated executable instructions 2008. Executable instructions 2008 represent the executable instructions of the software architecture 2002, including implementation of the methods, engines, modules. and so forth of FIGS. 1A-8C. Hardware layer 2004 also includes memory and/or storage modules 2010, which also have executable instructions 2008. Hardware layer 2004 may also comprise other hardware, as indicated by 2012, which represents any other hardware of the hardware layer 2004, such as the other hardware 2012 illustrated as part of machine 2100.

In the example architecture of FIG. 9, the software 2002 may be conceptualized as a stack of layers where each layer provides particular functionality. For example, the software architecture 2002 may include layers such as an operating system 2014, libraries 2016, frameworks/middleware 2018, applications 2020 and presentation layer 2044. Operationally, the applications 2020 and/or other components within the layers may invoke application programming interface (API) calls 2024 through the software stack and receive a response, returned values, and so forth, illustrated as messages 2026 in response to the API calls 2024. The layers illustrated are representative in nature and not all software architectures have all layers. For example, some mobile or special purpose operating systems 2014 may not provide a frameworks/middleware layer 2018, while others may provide such a layer. Other software architectures may include additional or different layers.

The operating system 2014 may manage hardware resources and provide common services. The operating system 2014 may include, for example, a kernel 2028, services 2030, and drivers 2032. The kernel 2028 may act as an abstraction layer between the hardware and the other software layers. For example, the kernel 2028 may be responsible for memory management, processor management (e.g., scheduling), component management, networking, security settings, and so on. The services 2030 may provide other common services for the other software layers. The drivers 2032 may be responsible for controlling or interfacing with the underlying hardware. For instance, the drivers 2032 may include display drivers, camera drivers, Bluetooth® drivers, flash memory drivers, serial communication drivers (e.g., Universal Serial Bus (USB) drivers), Wi-Fi® drivers, audio drivers, power management drivers, and so forth depending on the hardware configuration.

The libraries 2016 may provide a common infrastructure that may be utilized by the applications 2020 and/or other components and/or layers. The libraries 2016 typically provide functionality that allows other software modules to perform tasks in an easier fashion than to interface directly with the underlying operating system 2014 functionality (e.g., kernel 2028, services 2030 and/or drivers 2032). The libraries 2016 may include system 2034 libraries (e.g., C standard library) that may provide functions such as memory allocation functions, string manipulation functions, mathematic functions, and the like. In addition, the libraries 2016 may include API libraries 2036 such as media libraries (e.g., libraries to support presentation and manipulation of various media format such as moving picture experts group (MPEG) 4, H.264, MPEG-1 or MPEG-2 Audio Layer (MP3), AAC, AMR, joint photography experts group (JPG), portable network graphics (PNG)), graphics libraries (e.g., an Open Graphics Library (OpenGL) framework that may be used to render 2D and 3D in a graphic content on a display), database libraries (e.g., Structured Query Language (SQL) SQLite that may provide various relational database functions), web libraries (e.g., WebKit that may provide web browsing functionality), and the like. The libraries 2016 may also include a wide variety of other libraries 2038 to provide many other APIs 2036 to the applications 2020 and other software components/modules.

The frameworks 2018 (also sometimes referred to as middleware) may provide a higher-level common infrastructure that may be utilized by the applications 2020 and/or other software components/modules. For example, the frameworks 2018 may provide various graphic user interface (GUI) functions, high-level resource management, high-level location services, and so forth. The frameworks 2018 may provide a broad spectrum of other APIs 2036 that may be utilized by the applications 2020 and/or other software components/modules, some of which may be specific to a particular operating system 2014 or platform.

The applications 2020 include built-in applications 2040 and/or third party applications 2042. Examples of representative built-in applications 2040 may include, but are not limited to, a contacts application, a browser application, a book reader application, a location application, a media application, a messaging application, and/or a game application. Third party applications 2042 may include any of the built in applications as well as a broad assortment of other applications 2020. In a specific example, the third party application 2042 (e.g., an application developed using the Android™ or iOS™ software development kit (SDK) by an entity other than the vendor of the particular platform) may be mobile software running on a mobile operating system 2014 such as iOS™, Android™, Windows® Phone, or other mobile operating systems 2014. In this example, the third party application 2042 may invoke the API calls 2024 provided by the mobile operating system such as operating system 2014 to facilitate functionality described herein.

The applications 2020 may utilize built in operating system functions (e.g., kernel 2028, services 2030 and/or drivers 2032), libraries (e.g., system 2034, APIs 2036, and other libraries 2038), frameworks/middleware 2018 to create user interfaces to interact with users of the system. Alternatively, or additionally, in some systems, interactions with a user may occur through a presentation layer, such as presentation layer 2044. In these systems, the application/module “logic” can be separated from the aspects of the application/module that interact with a user.

Some software architectures 2002 utilize virtual machines. In the example of FIG. 10, this is illustrated by virtual machine 2048. A virtual machine 2048 creates a software environment where applications/modules can execute as if they were executing on a hardware machine (such as the machine 2100 of FIG. 10, for example). A virtual machine 2048 is hosted by a host operating system (operating system 2014 in FIG. 10) and typically, although not always, has a virtual machine monitor 2046, which manages the operation of the virtual machine 2048 as well as the interface with the host operating system (i.e., operating system 2014). A software architecture 2002 executes within the virtual machine 2048 such as an operating system 2050, libraries 2052, frameworks/middleware 2054, applications 2056 and/or presentation layer 2058. These layers of software architecture 2002 executing within the virtual machine 2048 can be the same as corresponding layers previously described or may be different.

### Example Machine Architecture and Machine-Readable Medium

FIG. 10 is a block diagram illustrating components of a machine 2100, according to some example embodiments, able to read instructions from a machine-readable medium (e.g., a machine-readable storage medium) and perform any one or more of the methodologies discussed herein. Specifically, FIG. 10 shows a diagrammatic representation of the machine 2100 in the example form of a computer system, within which instructions 2116 (e.g., software, a program, an application, an applet, an app, or other executable code) for causing the machine 2100 to perform any one or more of the methodologies discussed herein may be executed. For example, the instructions 2116 may cause the machine 2100 to execute the flow diagrams of FIGS. 4A-6B and 7E1-7E2. Additionally, or alternatively, the instructions 2116 may implement the system monitor module 170 of FIGS. 2A-2; the upper latch module 210 of FIGS. 2B-3; the lower latch module 220 of FIGS. 2B-4; the passenger seat module 240 of FIGS. 2C-2; the booster seat module 260 of FIGS. 2D-2; the FOB module 280 of FIGS. 2E-2; the visual display module 330 of FIGS. 3A-4; the emergency responder module 340 of FIG. 3B, the car electronics module 350 of FIG. 3C; the object tracking module 740 of FIGS. 7C-1; the object monitoring module 750 of FIGS. 7C-4; the pet collar module 920 of FIG. 8B and so forth, including the modules, engines, and applications represented by FIG. 10. The instructions 2116 transform the general, non-programmed machine 2100 into a particular machine 2100 programmed to carry out the described and illustrated functions in the manner described. In alternative embodiments, the machine 2100 operates as a standalone device or may be coupled (e.g., networked) to other machines 2100. In a networked deployment, the machine 2100 may operate in the capacity of a server machine or a client machine in a server-client network environment, or as a peer machine in a peer-to-peer (or distributed) network environment. The machine 2100 may comprise, but not be limited to, a server computer, a client computer, a personal computer (PC), a tablet computer, a laptop computer, a netbook, a set-top box (STB), a personal digital assistant (PDA), an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine 2100 capable of executing the instructions 2116, sequentially or otherwise, that specify actions to be taken by machine 2100. Further, while only a single machine 2100 is illustrated, the term “machine” shall also be taken to include a collection of machines 2100 that individually or jointly execute the instructions 2116 to perform any one or more of the methodologies discussed herein.

The machine 2100 may include processors 2110, memory 2130, and I/O components 2150, which may be configured to communicate with each other such as via a bus 2102. In an example embodiment, the processors 2110 (e.g., a central processing unit (CPU), a reduced instruction set computing (RISC) processor, a complex instruction set computing (CISC) processor, a graphics processing unit (GPU), a digital signal processor (DSP), an application specific integrated circuit (ASIC), a radio-frequency integrated circuit (RFIC), another processor, or any suitable combination thereof) may include, for example, processor 2112 and processor 2114 that may execute instructions 2116. The term “processor” is intended to include multi-core processors 2112 that may comprise two or more independent processors 2112 (sometimes referred to as “cores”) that may execute instructions 2116 contemporaneously. Although FIG. 10 shows multiple processors 2112, the machine 2100 may include a single processor 2112 with a single core, a single processor 2112 with multiple cores (e.g., a multi-core process), multiple processors 2112 with a single core, multiple processors 2112 with multiples cores, or any combination thereof.

The memory/storage 2130 may include a memory 2132, such as a main memory, or other memory storage, and a storage unit 2136, both accessible to the processors 2110 such as via the bus 2102. The storage unit 2136 and memory 2132 store the instructions 2116, embodying any one or more of the methodologies or functions described herein. The instructions 2116 may also reside, completely or partially, within the memory 2132, within the storage unit 2136, within at least one of the processors 2110 (e.g., within the processor's cache memory), or any suitable combination thereof, during execution thereof by the machine 2100. Accordingly, the memory 2132, the storage unit 2136, and the memory of processors 2110 are examples of machine-readable media.

As used herein, “machine-readable medium” means a device able to store instructions 2116 and data temporarily or permanently and may include, but is not be limited to, random-access memory (RAM), read-only memory (ROM), buffer memory, flash memory, optical media, magnetic media, cache memory, other types of storage (e.g., erasable programmable read-only memory (EEPROM)) and/or any suitable combination thereof. The term “machine-readable medium” should be taken to include a single medium or multiple media (e.g., a centralized or distributed database, or associated caches and servers) able to store instructions 2116. The term “machine-readable medium” shall also be taken to include any medium, or combination of multiple media, that is capable of storing instructions (e.g., instructions 2116) for execution by a machine (e.g., machine 2100), such that the instructions 2116, when executed by one or more processors of the machine 2100 (e.g., processors 2110), cause the machine 2100 to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” excludes signals per se.

The I/O components 2150 may include a wide variety of components to receive input, provide output, produce output, transmit information, exchange information, capture measurements, and so on. The specific I/O components 2150 that are included in a particular machine 2100 will depend on the type of machine. For example, portable machines 2100 such as mobile phones will likely include a touch input device or other such input mechanisms, while a headless server machine will likely not include such a touch input device. It will be appreciated that the I/O components 2150 may include many other components that are not shown in FIG. 10. The I/O components 2150 are grouped according to functionality merely for simplifying the following discussion and the grouping is in no way limiting. In various example embodiments, the I/O components 2150 may include output components 2152 and input components 2154. The output components 2152 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 2154 may include alphanumeric input components (e.g., a keyboard, a touch screen configured to receive alphanumeric input, a photo-optical keyboard, or other alphanumeric input components), point based input components (e.g., a mouse, a touchpad, a trackball, a joystick, a motion sensor, or other pointing instrument), tactile input components (e.g., a physical button, a touch screen that provides location and/or force of touches or touch gestures, or other tactile input components), audio input components (e.g., a microphone), and the like.

In further example embodiments, the I/O components 2150 may include biometric components 2156, motion components 2158, environmental components 2160, or position components 2162 among a wide array of other components. For example, the biometric components 2156 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram based identification), and the like. The motion components 2158 may include acceleration sensor components (e.g., accelerometer), gravitation sensor components, rotation sensor components (e.g., gyroscope), and so forth. The environmental components 2160 may include, for example, illumination sensor components (e.g., photometer), temperature sensor components (e.g., one or more thermometer that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detect concentrations of hazardous gases for safety or to measure pollutants in the atmosphere), or other components that may provide indications, measurements, or signals corresponding to a surrounding physical environment. The position components 2162 may include location sensor components (e.g., a Global Position System (GPS) receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 2150 may include communication components 2164 operable to couple the machine 2100 to a network 2180 or devices 2170 via coupling 2182 and coupling 2172 respectively. For example, the communication components 2164 may include a network interface component or other suitable device to interface with the network 2180. In further examples, communication components 2164 may include wired communication components, wireless communication components, cellular communication components, near field communication (NFC) components, Bluetooth® components (e.g., Bluetooth® Low Energy), Wi-Fi® components, and other communication components to provide communication via other modalities. The devices 2170 may be another machine 2100 or any of a wide variety of peripheral devices (e.g., a peripheral device coupled via a Universal Serial Bus (USB)).

Moreover, the communication components 2164 may detect identifiers or include components operable to detect identifiers. For example, the communication components 2164 may include radio frequency identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 2164, such as, location via Internet Protocol (IP) geo-location, location via Wi-Fi® signal triangulation, location via detecting a NFC beacon signal that may indicate a particular location, and so forth.

### Transmission Medium

In various example embodiments, one or more portions of the network 2180 may be an ad hoc network, an intranet, an extranet, a virtual private network (VPN), a local area network (LAN), a wireless LAN (WLAN), a wide area network (WAN), a wireless WAN (WWAN), a metropolitan area network (MAN), the Internet 80, a portion of the Internet 80, a portion of the public switched telephone network (PSTN), a plain old telephone service (POTS) network, a cellular telephone network, a wireless network, a Wi-Fi® network, another type of network, or a combination of two or more such networks. For example, the network 2180 or a portion of the network 2180 may include a wireless or cellular network and the coupling 2182 may be a Code Division Multiple Access (CDMA) connection, a Global System for Mobile communications (GSM) connection, or other type of cellular or wireless coupling. In this example, the coupling 2182 may implement any of a variety of types of data transfer technology, such as Single Carrier Radio Transmission Technology (1xRTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard setting organizations, other long range protocols, or other data transfer technology.

The instructions 2116 may be transmitted or received over the network 2180 using a transmission medium via a network interface device (e.g., a network interface component included in the communication components 2164) and utilizing any one of a number of well-known transfer protocols (e.g., hypertext transfer protocol (HTTP)) Similarly, the instructions 2116 may be transmitted or received using a transmission medium via the coupling 2172 (e.g., a peer-to-peer coupling) to devices 2170. The term “transmission medium” shall be taken to include any intangible medium that is capable of storing, encoding, or carrying instructions 2116 for execution by the machine 2100, and includes digital or analog communications signals or other intangible medium to facilitate communication of such software.

### Language

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Although an overview of the inventive subject matter has been described with reference to specific example embodiments, various modifications and changes may be made to these embodiments without departing from the broader scope of embodiments of the present disclosure. Such embodiments of the inventive subject matter may be referred to herein, individually or collectively, by the term “disclosure ” merely for convenience and without intending to voluntarily limit the scope of this application to any single disclosure or inventive concept if more than one is, in fact, disclosed.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled. As used herein, the term “or” may be construed in either an inclusive or exclusive sense. Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

1. A system to transport passengers in a vehicle that travels on land, the system comprising at least one processor and executable instructions accessible on a computer-readable medium that, when executed, cause the at least one processor to perform operations comprising:
broadcasting, over a wireless network and from a system monitor control unit, to at least one forward operating base (FOB), a request for linkage to the system monitor control unit, the system monitor control unit being located in the vehicle that travels on land and being utilized for bidirectional communication, over the wireless network, with a plurality of system unit types including a first system unit type for detecting the presence of a passenger in the vehicle and a second system unit type for communicating a plurality of alert types to a holder of the second system unit type, the first system unit type including a first child seat control unit, the second system unit type including the at least one FOB including a first FOB;
receiving an acknowledgement for linkage from the first FOB and registering the first FOB on the system control unit as being linked to the system control unit, the receiving the acknowledgment and the registering the first FOB being responsive to receiving the acknowledgement for linkage;
receiving an occupant present message from the first child seat that signifies the first child seat as being occupied;
identifying a temperature inside the vehicle as exceeding a predetermined threshold; and
communicating a temperature alert message to the first FOB responsive to the identifying the temperatures as exceeding the predetermined threshold and identifying the first FOB as being linked to the system monitor control unit, the temperature message causing the first FOB to communicate a temperature alert to the holder of the first FOB.

2. The system of claim 1, wherein the registering the first FOB includes storing a distance between the first FOB and the system monitor control unit.

3. The system of claim 1, wherein the plurality of system unit types includes a third system unit type including an emergency responder control unit for communicating the temperature alert to an emergency responder and further comprising:
identifying the first FOB is not located within a predetermined distance from the system monitor control unit; and further comprising:
communicating the temperature alert, via the emergency responder system unit, to an emergency responder responsive to identifying the first FOB as not being located within the predetermined distance from the system control unit, and wherein the emergency responder includes a “911” service.

4. The system of claim 3, wherein the plurality of system unit types includes a fourth system unit type including a car electronics control unit for communicating alerts to the vehicle and further comprising communicating the temperature alert, via the car electronics control unit, to the vehicle causing the vehicle to communicate a visual alert and an audible alert.

5. The system of claim 3, wherein the plurality of system unit types includes a fifth system unit type including video display control unit for communicating alerts to a video display unit located inside the vehicle and further comprising communicating the temperature alert, via the video display control unit, to the video display unit causing the video display unit to communicate a visual alert.

6. The system of claim 1, further comprising broadcasting the temperature message, over a wireless network, for receipt by the second unity type, the broadcasting being performed at maximum signal strength, the broadcasting being communicated with the maximum signal strength to communicate the temperature alert to all reachable FOB s.

7. The system of claim 1, further comprising receiving an acknowledgement for linkage from a second FOB and registering the second FOB in the system control unit as being linked to the system control unit, the receiving the acknowledgment and the registering the second FOB being responsive to the second FOB receiving the request for linkage to the system monitor control unit.

8. The system of claim 1, further comprising:
identifying the second FOB in the FOB table;
communicating a request, over the wireless network, to the second FOB, the request being for the second FOB to acknowledge being present, the request being communicated responsive to the identifying the second FOB in the FOB table; and
receiving acknowledgement that the second FOB is present, over the wireless network, from the second FOB.

9. The system of claim 8, further comprising:
updating a distance in the FOB control unit, the distance being between the second FOB and the system control unit, the updating being responsive to receiving the acknowledgement from the second FOB that the second FOB is present.

10. A method to safely transport passengers in a vehicle that travels on land, the method comprising:
broadcasting, over a wireless network and from a system monitor control unit, to at least one forward operating base (FOB), a request for linkage to the system monitor control unit, the system monitor control unit being located in the vehicle that travels on land and being utilized for bidirectional communication, over the wireless network, with a plurality of system unit types including a first system unit type for detecting the presence of a passenger in the vehicle and a second system unit type for communicating a plurality of alert types to a holder of the second system unit type, the first system unit type including a first child seat control unit, the second system unit type including the at least one FOB including a first FOB;
receiving an acknowledgement for linkage from the first FOB and registering the first FOB on the system control unit as being linked to the system control unit, the receiving the acknowledgment and the registering the first FOB being responsive to receiving the acknowledgement for linkage;
receiving an occupant present message from the first child seat that signifies the first child seat as being occupied;
identifying a temperature inside the vehicle as exceeding a predetermined threshold; and
communicating a temperature alert message to the first FOB responsive to the identifying the temperatures as exceeding the predetermined threshold and identifying the first FOB as being linked to the system monitor control unit, the temperature message causing the first FOB to communicate a temperature alert to the holder of the first FOB.

11. The method of claim 10, wherein the registering the first FOB includes storing a distance between the first FOB and the system monitor control unit on the system monitor control unit.

12. The method of claim 10, wherein the plurality of system unit types includes a third system unit type including an emergency responder control unit for communicating the temperature alert to an emergency responder and further comprising:
identifying the first FOB is not located within a predetermined distance from the system monitor control unit; and further comprising:
communicating the temperature alert, via the emergency responder system unit, to an emergency responder responsive to identifying the first FOB as not being located within the predetermined distance from the system control unit, and wherein the emergency responder includes a “911” service.

13. The method of claim 12, wherein the plurality of system unit types includes a fourth system unit type including a car electronics control unit for communicating alerts to the vehicle and further comprising communicating the temperature alert, via the car electronics control unit, to the vehicle causing the vehicle to communicate a visual alert and an audible alert.

14. The method of claim 12, wherein the plurality of system unit types includes a fifth system unit type including video display control unit for communicating alerts to a video display unit located inside the vehicle and further comprising communicating the temperature alert, via the video display control unit, to the video display unit causing the video display unit to communicate a visual alert.

15. The method of claim 10, further comprising broadcasting the temperature message, over a wireless network, for receipt by the second unity type, the broadcasting being performed at maximum signal strength, the broadcasting being communicated with the maximum signal strength to communicate the temperature alert to all reachable FOB s.

16. The method of claim 10, further comprising receiving an acknowledgement for linkage from a second FOB and registering the second FOB in the system control unit as being linked to the system control unit, the receiving the acknowledgment and the registering the second FOB being responsive to the second FOB receiving the request for linkage to the system monitor control unit.

17. The method of claim 10, further comprising:
identifying the second FOB in the FOB table;
communicating a request, over the wireless network, to the second FOB, the request being for the second FOB to acknowledge being present, the request being communicated responsive to the identifying the second FOB in the FOB table; and
receiving acknowledgement that the second FOB is present, over the wireless network, from the second FOB.

18. The method of claim 17, further comprising:
updating a distance in the FOB control unit, the distance being between the second FOB and the system control unit, the updating being responsive to receiving the acknowledgement from the second FOB that the second FOB is present.

19. A computer readable medium having no transitory signals and comprising instructions that, when executed on a processor, cause the processor to perform operations comprising:
broadcasting, over a wireless network and from a system monitor control unit, to at least one forward operating base (FOB), a request for linkage to the system monitor control unit, the system monitor control unit being located in the vehicle that travels on land and being utilized for bidirectional communication, over the wireless network, with a plurality of system unit types including a first system unit type for detecting the presence of a passenger in the vehicle and a second system unit type for communicating a plurality of alert types to a holder of the second system unit type, the first system unit type including a first child seat control unit, the second system unit type including the at least one FOB including a first FOB;
receiving an acknowledgement for linkage from the first FOB and registering the first FOB on the system control unit as being linked to the system control unit, the receiving the acknowledgment and the registering the first FOB being responsive to receiving the acknowledgement for linkage;
receiving an occupant present message from the first child seat that signifies the first child seat as being occupied;
identifying a temperature inside the vehicle as exceeding a predetermined threshold; and
communicating a temperature alert message to the first FOB responsive to the identifying the temperatures as exceeding the predetermined threshold and identifying the first FOB as being linked to the system monitor control unit, the temperature message causing the first FOB to communicate a temperature alert to the holder of the first FOB.

20. The method of claim 19, wherein the registering the first FOB includes storing a distance between the first FOB and the system monitor control unit on the system monitor control unit.
